(19) United States
(12) Patent Application Publication
(10) Pub. No.: US 2021/0200847 A1
(43) Pub. Date: Jul. 1, 2021

(54) SYSTEMS AND METHODS OF PROVIDING SEAMLESS AND SECURE OPERATIONS OF AUTHENTICATING AND ADVERTISING ON MOBILE COMMUNICATION TERMINALS

(71) Applicants: Jaelark JUNG, Goyang-si (KR); Jaekyu LEE, Siheung-si (KR); Youngtack SHIM, Seoul (KR)

(72) Inventors: Jaelark JUNG, Goyang-si (KR); Jaekyu LEE, Siheung-si (KR); Youngtack SHIM, Seoul (KR)

(21) Appl. No.: 17/196,663

(22) Filed: Mar. 9, 2021

Related U.S. Application Data
(63) Continuation of application No. 16/092,688, filed on Oct. 10, 2018.
(60) Provisional application No. 62/323,239, filed on Apr. 15, 2016.

(51) Int. Cl. G06F 21/32; H04M 1/67

(52) U.S. Cl. CPC G06F 21/32; H04M 1/67

(57) ABSTRACT

Various mobile communication terminals, their operational sequences, and related methods of using such terminals for providing a user with seamless operations in environments with an enhanced security. More particularly, such terminals, sequences, and methods authenticate a user as well as display at least one advertisement screen or content screen on display units, all in response to a single authentication (user) sub-input. Further mobile communication terminals, their operational sequences, and related methods are disclosed where such terminals employ multiple authentication operations but authenticate a user while displaying such screens, all in response to the same number of authentication (user) sub-inputs, thereby ensuring both seamless and secure operations for the user.

### CROSS-REFERENCE TO RELATED APPLICATIONS

This is a continuation application of U.S. patent application Ser. No. 16/092,688, filed Oct. 10, 2018, which is a national stage of International Application No. PCT/KR2017/004054, filed Apr. 14, 2017, which claims priority from U.S. Provisional Patent Application No. 62/323,239, filed Apr. 15, 2016 and which is incorporated herein by reference in its entirety. It is to be understood that, in case of any discrepancy between the contents provided in the above Provisional Application and the contents of this disclosure, the contents of this disclosure prevail over those of the above Provisional Application.

### FIELD OF THE INVENTION

The disclosure illustrates various mobile communication terminals and related methods for providing a user with seamless operations in environments with an enhanced security. More particularly, such terminals and methods authenticate a user as well as display at least one advertisement or content, all in response to a single authentication (user) sub-input. This disclosure also relates to various methods of providing seamless operations and secure operations of authenticating and advertising on such terminals, all in response to a single authentication (user) sub-input.

### BACKGROUND OF THE INVENTION

Mobile phones have finally emerged as bare necessities of this century. As computing speeds of the mobile phones increase along with their storage capacities, users store more personal information in their mobile phones. Accordingly, an economic and private value of the mobile phone has been increasing ever more, commensurate with an amount and a quality of personal but precious data stored therein. Therefore, losing the mobile phone has become a nightmare which may amount to or may be more formidable than a natural disaster such as an earthquake, a tornado or a Hurricane.

A widespread use of the mobile phone as well as an increased personal dependency thereon has brought up another issue, i.e., security. A user does not want others to unlock his or her mobile phone and to sneak up on a vast amount of data stored therein. In addition, in case of a lost-but-not-found, the user does not want a finder to freely access his or her data either. Coping with such concerns, many mobile phone manufacturers began to equip their mobile phones with various security measures such as, e.g., a password protection, a fingerprint authentication protection, and the like.

As we all know, third time's a charm. But no third charm can ever beat the first one, for the first impression is by far the most lasting.

As we all have, everything has a face. And a face of a mobile phone is the first screen. It therefore goes without saying that the most lasting impression from a mobile phone is the first screen which a user cannot help seeing whenever he or she wakes up the mobile phone. Therefore, it is not surprising that an immense economic value of such a first screen of the mobile phone has long been recognized, as manifest in U.S. Pat. No. 8,831,557.

Swarming onto the bandwagon, many advertisers began to post their advertisements on a lock screen of a mobile phone. For example, advertisers distributed software applications which users downloaded to their mobile phones and receive advertisements on their lock screens. Some advertisers went further to reward those users whenever they reacted to the advertisement displayed on the first screen, e.g., by touching or sliding an advertisement displayed on a touch screen of the mobile phone.

With an advent of fingerprint scanning technology, a fingerprint authentication has become the standard measure of security in most mobile phones. With enhanced security, users have obtained the peace of mind whenever they store their personal information as well as private data in the mobile phones. However, the fingerprint scanning technology found itself standing in the way of advertising on the mobile phone screen, for the user has to provide his or her fingerprint to wake up their mobile phones on one hand, but the user also has to touch a touch screen of the mobile phone to react to the advertisement and to move on to the next step of operation. In other words, a mobile phone requires a user to authenticate himself or herself to wake up, the user reacts to an advertisement by touching a screen of the mobile phone, the mobile phone does not remember a fingerprint of the user and, therefore, the user has to authenticate himself or herself once more. Such a fingerprint authentication sequence severely restricts optimal commercialization of the most valuable real estate of the mobile phone, i.e., utilizing a first screen or a lock screen of a mobile phone for posting advertisements, contents, and the like. As a result, mobile phone manufacturers and advertisers have been puzzled in balancing the user benefits from seamless operations of posting advertisement versus the benefits from seamless authentication operations.

Accordingly, there is an impending need to regain many benefits from seamless authentication operations of the mobile phone as well as benefits of posting advertisement under secured environments. In other words, an immense economic value of the first screen of the mobile phone has to be exploited, while guaranteeing an environment in an enhanced security concurrently therewith.

### SUMMARY OF THE INVENTION

This disclosure relates to various mobile communication terminals capable of providing a user with seamless operations in environments of enhanced security, and also relates to various methods of manufacturing and using such terminals. More particularly, each terminal of this disclosure may authenticate a current user and display an advertisement screen or a content screen, all in response to a single authentication (user) sub-input. Thus, one exemplary mobile communication terminal of this disclosure receives a single authentication (user) sub-input, displays at least one screen (e.g., an advertisement screen or a content screen) in its lock state, requires a user to react to such a screen by providing an additional auxiliary (user) sub-input or by performing an active task or a passive task, and then switches to its unlock state after running at least one authentication operation, all based upon a single authentication (user) sub-input. In other words, the terminal can execute all of such operations (or steps) in response to a single authentication (user) sub-input, without requiring a user to provide an additional authentication sub-input. Other exemplary mobile communication terminals of this disclosure also accomplish all such operations (or steps) based on a single authentication (user) sub-input, but according to different sequences of operations (or steps), different arrangements thereof, and the like.

Advantages and benefits of various mobile communication terminals of this disclosure and methods of using such terminals will be described below, after introducing definitions and meanings of terms and phrases to be used throughout this disclosure.

As used herein, a “mobile communication terminal” or simply a “terminal” refers to a communication device which enables wired or wireless communication and includes therein at least one display unit. The “terminal” may include at least one processor which can execute its operating system (O/S) and (software) application, and may also include at least one volatile or non-volatile memory which may be used as a (main) memory or as a (main) library. The “terminal” is also equipped with at least one input unit with which a user provides at least one user input (i.e., UI) along with one or multiple (user) sub-inputs (e.g., UI_{ACT}, UI_{THEN} or UI_{AUX}) each of which is to be defined below. Examples of such a “terminal” of this disclosure may include, but not limited to, a mobile phone, a smart-phone, a hand phone, a web pad, a PDA, a personal computer (including a desk-top computer and a notebook computer), a work station, a navigation system, an e-book, and any other electronic equipment which may incorporate thereinto the above wired or wireless communication function, display unit, input unit, processor, and the like.

As used herein, a “display unit” of a terminal may define thereon at least one “display surface” on which the display unit may display at least one color image, at least one black-and-white image or other images. Examples of such images may include or relate to, but not limited to, a character, a text, a drawing, a picture, a video clip, a video game, a still image of another object or person, a video clip of another object or person, and the like. In other words, the “display surface” refers to a hardware element of the display unit of the terminal, where different types of such display units will be explained below.

As used herein, a “screen” refers to at least one image which may be displayable on a “display surface” of a display unit, where the “screen” may be in black-and-white, in color, in two-dimensional (i.e., “2-D”), in three-dimensional (i.e., “3-D”), and the like. In operation, a “screen” becomes available on a “display surface” of a display unit and a user can view such a “screen” when (including “as” or “after”) the display unit “switches” (including “starts to switch”) from its OFF state to its ON state (i.e., “turned ON”). In this context, a “screen” may be any image of whatever may be displayed on a “display surface,” where examples of such a “screen” may be identical to those examples of the “image” or only a portion thereof, an advertisement, a content, a warning, an instruction, and the like. In addition, a “screen” may include a prior art lock screen or unlock (or home) screen, a prior art instruction or warning including such an image or a character, and the like.

It is appreciated that a display unit displaying an image or a video clip of “routine data” on at least a portion of its “display surface” may be deemed to be in its OFF state. In other words, a display unit displaying such “routine data” is not deemed to be in its ON state, where examples of such “routine data” may include, but not limited to, a clock, a time, a stopwatch, an alarm, a notice for informing an arrival of new emails or new messages, a notice for informing an upcoming event, a notice for an incoming telephone call, an image for displaying a level of remaining battery power, an availability of wireless communication, a weather, and the like. In other words, these “routine data” generally refer to such data of which exposure is irrelevant to the security of user's data or privacy and, therefore, may be displayed on a portion of a display unit of a terminal or on a separate, auxiliary or extra display unit which may not be a part of a main display unit. In this context, certain data or contents may be classified as the “routine data” when a user does not mind disclosing such data or contents to a 3^{rd} party regardless of whether or not the user stores such in the terminal, when a user does not regard such data or contents as his or her own personal information, when a user does not regard such data or contents to have an economic value for not being disclosed to others, and the like.

As used herein, an “advertisement” refers to an announcement, a notice, and the like, each of which aims to promote a product, a person, a company, a service, an event, and the like. Accordingly, an “advertisement screen” refers to a “screen” at least a portion of which may include the “advertisement,” at least a portion of which may correspond to the “advertisement” or at least a portion of which may be the “advertisement.” When a display unit displays an “advertisement screen” on a “display surface,” a terminal may require a user to react to the “advertisement screen,” e.g., by providing at least one (user) sub-input to the “advertisement screen” or to another part of a terminal or by performing at least one active task or passive task, in order for the user to proceed to a next step of operating the terminal. Of course, an “advertisement screen” may not require the user to provide any additional sub-input or to perform either of the active task or passive task. The term “advertisement” is used synonymously with the phrase “advertisement screen” for simplicity of illustration, unless otherwise specified.

When desirable, an “advertisement screen” may include thereon at least one optional “tab” with which a user may provide at least one (user) sub-input or perform at least one active or passive task, e.g., by manipulating at least a portion of the tab. The “advertisement screen” or its optional “tab” may include at least one optional “part” with which a user can provide an authentication (user) sub-input (or other user sub-inputs), where this “part” may then correspond to an authentication sensor (or sensing element) as will be described below.

The “advertisement” may have a sponsor who may be a non-user, a manufacturer, a service provider, or a 3^{rd} party. The sponsor may also give a reward to a user when he or she reacts to the “advertisement,” e.g., by supplying at least one user input which includes therein at least one (user) sub-input, by performing at least one active task or passive task, and the like. The term “advertisement” may also be abbreviated as “ad” or “ad-” for simplicity of illustration.

As used herein, a “content” refers to a drawing, a picture, a character, a text, a video clip, a video game, a still image of another object or person, a video clip of another object or person, and the like, each of which is displayed on a “display surface” of a display unit. The “content” may include or relate to, e.g., illustration of a fact, illustration of an opinion, an artistic expression, an aesthetic expression, any of the above images, and the like. Therefore, a “content screen” refers to a “screen” at least a portion of which may include a “content,” at least a portion of which may correspond to a “content” or at least a portion of which may be the “content” itself. When a display unit displays a “content” on a “display surface,” a terminal may require a user to react to the “content,” e.g., by providing at least one (user) sub-input to a “content screen” or to another part of a terminal or by performing at least one active task or passive task, in order to proceed to a next step of operating the terminal. A “content screen” may not require a user to provide any additional (user) sub-input or to perform any active or passive task either. For simplicity of illustration, the term “content” is used synonymously with the term “content screen” unless otherwise specified.

When desirable, a “content screen” may include thereon at least one optional “tab” with which a user may provide at least one (user) sub-input or may perform at least one active or passive task, e.g., by manipulating at least a portion of the tab. The “content screen” or its optional “tab” may also include at least one optional “part” with which a user may provide an authentication (user) sub-input (or other user sub-inputs), where this “part” may then correspond to an authentication sensor (or sensing element), an auxiliary sensor (or sensing element), and the like, as will be described below.

The “content” may include an “ad-related content” or a “non-ad-related content.” In the case of the former, the “content” may have a sponsor who may be a non-user, a manufacturer, a service provider, or a 3^{rd} party. In addition, the sponsor may give a reward to a user when he or she reacts to the “content screen,” e.g., by supplying at least one (user) sub-input, by performing at least one active or passive task, and the like.

As used herein, running multiple operations “concurrently” means that at least one hardware element (e.g., a CPU) or at least one software element (e.g., an operating system or an application) of a terminal is running at least two operations in such a way that the hardware or software element executes at least one step of each of such operations simultaneously or in the same clock cycle of the CPU. Accordingly, a terminal runs Operation A and Operation B “concurrently” when Operation A is started at a clock cycle 101 and completed at a clock cycle 800 (i.e., a total duration of 700 clock cycles), and when Operation B is started at a clock cycle 701 and completed at a clock cycle 2,000,000 (i.e., a total duration of 1,999,300 clock cycles), where the hardware or software element of the terminal runs both Operations A and B from the clock cycle 701 to the clock cycle 800. When the terminal includes multiple CPUs or multiple O/A's, a terminal is regarded to run Operation A and Operation B “concurrently” when the terminal runs both of Operation A and Operation B at a certain instance. Accordingly, regardless of the number of CPUs or O/A's included in a certain terminal, such a terminal is deemed to run Operation A and Operation B “concurrently” when there exists a temporal overlap between Operations A and B. Conversely, when there exists no temporal gap in running Operations A and B, the terminal is regarded to “sequentially” run such Operations A and B.

As used herein, “immediate” is not “concurrent” but rather similar to “sequential” in general. More particularly, “immediate” is defined not in terms of an absolute temporal period but rather in terms of a user perspective. Therefore, two operations, two steps, or two events are deemed to be “immediate” to each other, when one of such operations, steps, or events follows the other thereof close enough in time such that an average user feels they may occur or happen one right the other. For example, one of such operations, steps, or events may occur or happen immediately after (or before) the other thereof when a temporal gap between those two operations, steps, or events may be less than 1.0 sec., 100.0 msec., 50.0 msec., or 10 msec., and the like. It is appreciated, between two immediate operations, steps, or events, that a user may provide a terminal with an additional user input (or sub-input), that a terminal may acquire an additional user input (or sub-input) with or without any action by a user, or that a terminal may run another operation or perform another step.

As used herein, “upon” and “in response to” are synonymous to each other and both “upon” and “in response to” generally connote causal relationships. More particularly, “upon verb-Sing” (therefore, “in response to a noun of such verb”) means a causal relationship between the above verb and an operation, a step, or an event which is run, executed, or performed by a terminal as a result of the above verb. For example, “upon receiving a single UI” (or “in response to a single UI”) means that a terminal runs an operation or executes a step as a result of receiving the single UI. Accordingly, a terminal may receive the UI and run an operation (or execute a step) concurrently with each other or sequentially. In addition, while or after receiving the UI and before completing to run the above operation (or performing the above step), a terminal may acquire an additional user input (or sub-input) with or without any action by a user, or that a terminal may run another operation or perform another step.

As used herein, a “user input” refers to an input provided to a mobile communication terminal by a user, e.g., by directly or indirectly manipulating at least a portion of at least one input unit of such a terminal “only once,” where the “user input” is abbreviated as “UI” hereinafter for illustration purposes. In this respect, a “user input” is synonymous with a “single user input” in such a manner that both of “UI” and a single “UI” mean an input provided to a terminal by a certain manipulation of a user such that, e.g., [A] a user does not move his or her finger, hand, eye or another body part with respect to an input unit while providing the single UI, [B] a user does not detach his or her finger(s), hand or body part from an input unit while providing the single UI, [C] a user does not stop talking to an input unit while providing the single UI, [D] a user does not change a direction in which he or she stares while providing the single UI, and the like. Therefore, each of the following may all qualify as UI or the single UI, [A] when a user touches or presses an input unit only once, [B] when a user keeps touching or pressing an input unit without moving his finger, hand or another body part, [C] when a user maintains a contact with an input unit while moving his finger or hand, [D] when a user stares an input unit only once or keeps staring such, [E] when a user talks to an input unit once or continues to talk thereto, and the like, where the brackets “[ ]” represent that various operations (or steps) following such brackets are alternatives to each other.

A user may provide a “user input” or a “single user input” by manipulating at least a portion of an input unit in various modes. In one example, a user may directly manipulate a designated portion of the input unit e.g., by pressing or touching the portion, sliding his or her finger over the portion, sliding or swiveling the portion or otherwise manipulating such a portion. In another example, a user may keep doing or continue to do one of the above manipulations. In another example, a user may provide the above user input while manipulating a length or duration of one of such manipulations. In yet another example, a user may indirectly manipulate at least a portion of the input unit, e.g., by sending electromagnetic waves or acoustic waves to an input unit, by sending (or showing) an image thereto, by sending mechanical energy thereto, and the like.

A “user input (UI)” causes an operating system (O/S) or at least one (software) application (i.e., application software or simply “application” hereinafter) of a terminal to start execution of one or more steps such that the O/S and/or application may start to execute one or more unexecuted or remaining steps of running at least one (predetermined) operation in response to UI. Accordingly, the “user input” also causes an O/S or at least one (software) application of a terminal to start execution of one or more unexecuted or remaining steps of performing at least one (predetermined) function.

It is appreciated that a single user input (UI) includes therein at least one piece of information such as, e.g., one or multiple “(user) sub-inputs” or “sub-inputs,” where examples of such (user) sub-inputs may include, but not limited to, an “authentication (user) sub-input (UI_{THEN}),” an “activation (user) sub-input (UI_{ACT}),” an “auxiliary (user) sub-input (UI_{AUX}),” a combination of at least two such (user) sub-inputs, and the like. That is, the term “information” is defined to include therein at least one of at least one UI_{ACT}, UI_{TJEN}, and UI_{AUX}, and to optionally include another signal which may relate to any of such (user) sub-inputs or which may not relate to such sub-units but may be relevant to operate such a terminal. Accordingly, unless otherwise specified, a “user input” or “UI” refers to a “single user input” which includes therein or may accompanies therewith at least one (user) sub-input (e.g., UI_{THEN}, UI_{ACT}, and/or UI_{AUX}) and other optional signals.

A “(single) user input (UI)” may cause a mobile communication terminal to run a single (predetermined) operation or may cause the terminal to run multiple identical, similar or different (predetermined) operations either sequentially, concurrently or in a combination thereof.

Alternatively, a “(single) user input” may cause a terminal to perform a single (predetermined) function or may cause a terminal to perform multiple identical, similar or different (predetermined) functions either sequentially, concurrently or in a combination thereof. A terminal may also receive (i.e., acquire) multiple user inputs sequentially, concurrently or in a combination thereof or may receive (i.e., acquire) multiple (user) sub-inputs of a single user input (or multiple user inputs) either sequentially, concurrently or in a combination thereof.

A “(single) user input” and at least one (user) sub-input included in the user input may be classified based upon their natures. One example is a mechanical user input (and sub-input) such as, e.g., pressing, touching, sliding, rotating, translating or otherwise manipulating at least a portion of an input unit(s). Another example is a mechanical user input (and sub-input) such as, e.g., an acceleration (a scalar or a vector), a velocity (a scalar or a vector), a force (a scalar or a vector), a displacement (a scalar or a vector), and the like. Another example is an electromagnetic user input (and sub-input) of which relevant properties may include, but not limited to, a magnitude, a frequency, a wave length, a flux, a phase angle or a phase lag, where each of such properties may be a scalar or a vector. Another example is an electrical user input (and sub-input) of which relevant properties may include, but not limited to, an electric current or voltage, their magnitudes, frequencies, wave lengths, phase angles, phase lags or directions, where each of such properties may be a scalar or a vector. Another example may be a magnetic user input (and sub-input) of which relevant properties may include, but not limited to, a magnitude, a polarity, a flux, a direction, a frequency, a wave length, a phase angle or a phase lag, where each of such properties may be a scalar or a vector. Another example may include an acoustic (or vocal) user input (and sub-input) of which relevant properties may include, but not limited to, a magnitude, a frequency, a wave length, a phase angle or a phase lag, where each of such properties may be a scalar or a vector. A similar example may be an ultrasonic user input (and sub-input) of which properties include those of the acoustic user input (and sub-input). Another example may include a visual user input (and sub-input) of which relevant properties may include, but not limited to, a size, a shape, a configuration, a color, a brightness, a contrast or an orientation, where each of such properties may be a scalar or a vector. Another example may include an optical user input (and sub-input) of which relevant properties may include, but not limited to those of the electromagnetic user input (and sub-input). When desirable, a user input or its user sub-input may include a combination of any of the above.

As used herein, an “application” may be synonymous with a “software application” or “application software,” where each refers to a set of computer instructions or a computer program which is designed, when run by a terminal or its O/S, to perform a (specific) function. It is noted that it is the mobile communication terminal which “executes or runs an application” throughout this disclosure. Therefore, similar to a dictionary definition thereof, an “application” as used herein includes an operating system (O/S) as well as a non-OS application. A terminal may incorporate an “application” in many different ways. In one example, at least one “application” may be pre-stored or pre-downloaded into a terminal (e.g., in a volatile or non-volatile memory, including a BIOS) by a manufacturer or a distributor before a user purchases (or begins to operate) a terminal. A user may purchase a terminal and then download at least one “application” to the terminal as well.

As defined above, the phrase “run an operation” is synonymous with the phrases such as, e.g., “run at least one operation,” “run a (predetermined) operation,” “run at least one (predetermined) operation,” and the like. It is noted throughout this disclosure that it is the mobile communication terminal which “runs an operation” or, more particularly, that it is the O/S or at least one application of a terminal which “runs an operation.” For this reason, “an O/S or at least one application of a terminal” will be abbreviated as a “terminal” when such a term refers to a software portion of a terminal, execution of the software portion, and the like. Accordingly, “a terminal” may carry a different meaning when the term refers to its hardware portion, not the software portion.

In reality, an operation which is run by a terminal includes a series of steps, such as e.g., a step of retrieving pre-stored data, a step of retrieving a setting or user-supplied data, a step of making its hardware element ready, a step of supplying electrical power to such an element, a step of executing instructions to perform a specific function, a step of utilizing results from such executing, and the like. Various terminals may employ different arrangements of such steps to run an operation so that, e.g., a terminal retrieves data before such executing, a terminal supplies the power and makes a hardware element ready, a terminal divides such instructions into multiple sections and executes such sections sequentially or concurrently.

Regardless of such differences in detailed arrangements, however, a certain “operation” is deemed to be “on hold” or to have been “on hold” while (or as long as) a terminal does not proceed to execute unexecuted or remaining steps of a certain application for “running the operation.” Accordingly, the phrase “run an operation” in response to a user input (UI) means a definition in the level of executing a set of computer instructions or program. For example, when a terminal receives (i.e., acquires) UI, UI (and sub-input) causes an O/S or at least one (software) application of a terminal to start to execute one or more unexecuted or remaining steps of a certain application for running a certain operation which was (or has been) “on hold,” where “an O/S or at least one (software) application of a terminal” is abbreviated as a “terminal” as defined above, while “start to execute one or more unexecuted or remaining steps of a certain application for running a certain operation which was (or has been) on hold” is abbreviated as “run at least one predetermined operation,” “run at least one operation,” “run a predetermined operation” or “run an operation” in response to a single UI. Therefore, the phrase “run an operation” refers to “executing a certain number of unexecuted or remaining steps of an O/S or at least one application of a terminal, and the like,” where the unexecuted or remaining steps of the O/S or the application have been “on hold” (or which was “on hold”) until a user provides UI (and sub-input) to a terminal. Alternatively, the phrase “run an operation” may mean an occurrence of a certain event where “unexecuted or remaining steps of the O/S or application start to be executed in response to UI (and sub-input), e.g., after a terminal receives (i.e., acquires) UI (and sub-input), after a terminal extracts at least a piece of information from UI (and sub-input), and the like. As a result, executing such steps of the O/S or application may lead to performing at least one specific function which is assigned to the above operation.

For example, a terminal may run at least a portion of an O/S in response to UI (and sub-input) to perform a specific function, where the “run” corresponds to “run an operation.” That is, the “run” results directly from UI (and sub-input), and the portion of the O/S cannot be run unless a user supplies UI (and sub-input). In the alternative, the portion of O/S may be “run” automatically (or on its own), i.e., based on a setting pre-selected by a user, a manufacturer or a distributor. Therefore, the portion of the O/S may be run even if the terminal did not require a user to provide UI (and sub-input).

In another alternative, a terminal may run an application to perform a specific function, where the application may have been pre-stored in a terminal before user's purchase or may be downloaded to a terminal later, e.g., after the purchase by a user. In this case, the “run” corresponds to “run an application.” For example, as at least one application is “run” in response to UI (and sub-input), the application cannot be run unless a user supplies UI (and sub-input) to the terminal. In another example, an application may be “run” in response to UI (and sub-input), where the application may not be run unless a user supplies UI (and sub-input). In another example, an application may “run” automatically (or on its own), i.e., based on a setting or command selected by a user, a manufacturer, and the like, where the application may be run even without requiring a user to provide UI (and sub-input).

In summary, the phrase “run an operation” refers to “start to execute at least one unexecuted or remaining step of an O/S and/or a (software) application to perform a specific function.” Accordingly, the phrase “run an operation” also refers to “run at least one unexecuted or remaining portion of an O/S” and/or “run at least one unexecuted or remaining portion of at least one application” to perform a specific function. The phrase “run an operation” also refers to “incorporate requires” incorporating into a terminal an O/S and/or at least one (software) application for performing a specific function which is related to or results from “running an operation.” In addition, an O/S of a terminal may download thereonto at least one another application which can “run an operation” or may allow a user to download such an application to the terminal.

Thus, a developer of a terminal may configure an O/S or an application to run various operations for allowing a terminal or user to perform various specific functions. In this context, any set of computer instructions or programs for performing a certain function may be referred to as an “application” throughout this disclosure. In addition, examples of such “operations” which can be run by such O/S or (software) applications may include, but not limited to, an operation of displaying a screen of an image or a video clip on a display unit, an operation of taking pictures (or recording video clips), an operation of displaying (or storing, transmitting) pictures, an operation of playing (or storing, transmitting) video clips, an operation of playing (or transmitting, storing) audio files or sounds, an operation of assessing emergency situations, an operation of accessing (or calling) emergency services, an operation of storing (or transmitting) information regarding emergencies, an operation of assessing (or storing, transmitting) a geographic location, an operation of monitoring (or storing, transmitting) a health condition, an operation of authenticating a user, an operation of making (or receiving) a phone call, an operation of connecting to an internet (or bluetooth, messenger), an operation of executing a clock (or a timer), an operation of executing a navigator (or a scheduler, dictionary), an operation of creating (or processing, storing, transmitting) a document (or a file), an operation of changing a mode of operation of a terminal, an operation of providing an access to selected information stored in a terminal, an operation of displaying the last screen which had been displayed by a display unit before a terminal was inactivated (or before a display unit was turned OFF), an operation of providing an access to the last (software) application which had been run by a terminal before a terminal was inactivated (or before a display unit was turned OFF), an operation of connecting to a network of internet-of-things (or to electric or electro-mechanical appliances which are linked to a network of internet of things), an operation of unlocking (or locking) a door (or a window) of a vehicle (or a building, a room, an automobile, a motor cycle), an operation of setting (or adjusting) a control panel, and the like.

Related to the phrase “perform a (specific) function” as defined above, it is noted that the terminal “performs a (specific) function.” More particularly, the “(specific) function” results from “running an operation” which corresponds to executing at least a portion of the O/S or at least a portion of application. It is also noted that the “specific function” obtained by “running an operation” may require the software application as well as at least one hardware element of the terminal.

The phrase “perform at least one task” is synonymous with “perform a task,” where the task includes at least one “active task,” at least one “passive task,” and the like. The “active task” may include, e.g., providing at least one UI (and sub-input), manipulating at least a portion of at least one input unit (e.g., including a display surface), performing such providing or manipulating for a certain number of times or for a certain period, keeping or continuing any of the above performing for a certain period, manipulating the portion of the input unit in order to acquire a non-user input, and a combination of the above. In contrary, the “passive task” may include, e.g., a “non-action” which means that a user does not take any action, waiting for a certain period without performing any of the above active task, and the like. It is noted that it is the person (e.g., the user) who “performs a task.”

It is appreciated that the phrase “cause an operating system (O/S) or at least one (software) application of a terminal” is to be abbreviated as “cause a terminal” in this disclosure. In addition, the phrase “start execution of one or more steps such that the O/S and/or the application may start to execute one or more unexecuted or remaining steps of running at least one (predetermined) operation” is abbreviated as “run at least one predetermined operation,” “run a predetermined operation” or “run an operation” throughout this disclosure. Moreover, the phrase “start execution of one or more steps such that the O/S and/or (software) application may start to execute one or more unexecuted or remaining steps of performing at least one (predetermined) function” is to be abbreviated as “perform at least one predetermined specific function,” “perform at least one specific function,” “perform a specific function” or “perform a function” throughout this disclosure.

As used herein, an “authentication operation” refers to an operation through which a terminal determines or checks whether or not a current user is an authorized user, whether or not a current user can run a certain operation, and the like. A typical “authentication operation” may include multiple steps such as, e.g., storing a value required for such an operation, getting an authentication sensor ready, receiving UI_{THEN} or another (user) sub-inputs, extracting at least one authentication information from UI_{THEN} (when desirable or required), comparing UI_{THEN} with a pre-stored value, determining (or checking) whether UI_{THEN} passes or fails an “authentication operation,” storing UI_{THEN} (when desirable or required), a “pass,” a “fail,” and any other authentication information (collectively referred to as “Result”) temporarily or permanently. Various terminals may utilize different arrangements of such steps for the “authentication operation” such that, e.g., a terminal may render an authentication sensor ready as (or when) a terminal switches (including starts to switch) a display unit to its ON state (i.e., a display unit is turned ON) or, alternatively, a terminal may render (including starts to render) an authentication sensor ready while a display unit has been (or remains) in its OFF state. In another alternative, a terminal may render an authentication sensor ready upon acquiring UI_{THEN} (or another user sub-input) or only after acquiring UI_{THEN} (or another user sub-input). It is noted in the above examples that the authentication operation may use the acquired UI_{THEN} itself (or another sub-input) or may instead use information extracted from UI_{THEN} (or another sub-input).

Regardless of the differences in detailed arrangements, however, an “authentication operation” is deemed to be “on hold” (or to have been “on hold”) until a terminal receives UI_{THEN} (or another sub-input) or as long as a display unit is (or has been) in its OFF state. In other words, one or more unexecuted or remaining steps of the authentication operation are not being executed until a terminal receives UI_{THEN} (or another sub-input), or while a display unit has been (or remains) in its OFF state. Therefore, until a terminal acquires (i.e., receives) UI_{THEN} (or another sub-input) or while a display unit remains (or has been) in its OFF state, such an authentication operation may be deemed to be “on hold.”

Once acquired, however, UI_{THEN} (or another user sub-input) may cause an O/S or a (software) application of a terminal to start execution of one or more unexecuted or remaining steps of an authentication operation so that a terminal may run (including “start to run”) at least one authentication operation which has been (or was) “on hold.” It is appreciated and as defined above that “an O/S or a (software) application of a terminal” is to be abbreviated as a “terminal,” while “start execution of one or more unexecuted or remaining steps of an authentication operation so that a terminal may run (including “start to run”) at least one authentication operation” is abbreviated as “run at least one authentication operation” or “run an authentication operation.” Therefore, the phrase “run an authentication operation” refers to execution of a certain number of steps of an O/S or at least one (software) application of a terminal which have been (or which was) “on hold” until a user provides UI_{THEN} (or another user sub-input) to a terminal, but which starts to be executed in response to UI_{THEN} (or another sub-input), i.e., after a terminal receives UI_{THEN}, after such a terminal extracts at least a piece of information for authentication from UI_{THEN} (or another sub-input), and the like. As a result, execution of the unexecuted or remaining steps of the O/S/and/or application leads to performing at least one specific function which is designated to the authentication operation. Accordingly and in one example, a terminal may execute at least a portion of the O/S and/or application to perform a specific function of authenticating a user, where the above “execute” corresponds to “run an authentication operation.”

In this respect, an “authentication operation” may include one or more steps of, e.g., retrieving a pre-stored value to run an authentication operation, comparing UI_{THEN} with the pre-stored value, comparing information accompanying UI_{THEN} with a pre-stored value thereof, and the like, where all steps in this paragraph are to be collectively referred to as the “comparing steps.” Accordingly, “running an authentication operation” or an “authentication operation” may refer to exemplary operations represented by the numerals such as, e.g., [12], [22], [32], [42], [53], [A101], [A111], [A112] or [A151] in appending figures of this disclosure, where such steps may correspond to or may include therein the above “comparing steps.”

However, the “authentication operation” is deemed to not include one or more steps of determining whether or not UI_{THEN} itself or authentication information may pass or fail the authentication operation. For simplicity of illustration, all such steps in this paragraph are collectively referred to as the “determining steps,” which are not a part of “run an authentication operation.” Thus, such “determining steps” may refer to exemplary operations represented by the numerals such as, e.g., [13], [23], [34], [44], [A102], [A104] or [A152] in appending figures of this disclosure.

As used herein, an “authentication (user) sub-input,” “authentication sub-input,” and “UI_{THEN}” are synonymous with each other and refer to a (user) sub-input which a terminal use so as to run an authentication operation. It is appreciated that, without any UI_{THEN}, an O/S or a (software) application may not run any authentication operation, for UI_{THEN} starts execution of one or more remaining or unexecuted steps of a user authentication operation. It is also appreciated that characteristics of UI_{THEN} depend upon a mechanism of an authentication sensor which may acquire UI_{THEN} or other information necessary for such authentication operation. In this aspect, UI_{THEN} may be, correspond to or accompany at least one of the following information such as, e.g., biometric information of a user (e.g., an image of a fingerprint, that of an iris, retina or eye, that of an ear or face, that of a hand or wrist, that of another body part, that of blood vessels or their distribution pattern, a sound or voice of a user, and the like), other biometric information of a user (e.g., a displacement, a velocity or an acceleration of a body part of a user), a password, a pass code, a non-user image or sound, a non-user light rays or electromagnetic waves, a displacement (or a velocity, an acceleration) of at least one part of a terminal, a number of movements of a body part of a user or a part of a terminal, a sequence or an order of such movements, their duration, and the like. A terminal receives (i.e., acquires) UI_{THEN} (or other user sub-inputs) in various modes such as, e.g., when a user provides UI_{THEN} voluntarily to an input unit or at least a part of a terminal, when a terminal automatically receives UI_{THEN} even without a voluntary conduct of a user, when the terminal receives an image of an iris or retina, and the like.

When a terminal requires multiple (user) sub-inputs, a user may provide a terminal with UI_{THEN} concurrently with UI_{ACT}, UI_{AUX} or another authentication (user) sub-input, UI_{THEN2}, by various means such as, e.g., when a user manipulates a single (or multiple) part(s) of an input unit or another single part of a terminal, when a user manipulates the single part in different directions, for different periods, with different forces, and the like. Alternatively, a user may provide UI_{THEN} along with UI_{ACT}, UI_{AUX} or another authentication sub-input, UI_{THEN}, by various means such as, e.g., by manipulating multiple parts of a terminal with a single body part of a user concurrently or sequentially, by manipulating multiple parts of a terminal with multiple body parts of a user concurrently or sequentially. In another alternative, a user may provide a terminal with a single (user) sub-input, while a terminal may acquire another sub-input without an action from a user, e.g., by monitoring an image of an iris or retina of a user and then extracting authentication information therefrom, by monitoring a movement direction, its velocity or acceleration and extracting authentication information, and the like.

As used herein, “Result” and “Results” collectively mean an “authentication (user) sub-input (UI_{THEN})” itself, any result from the above “comparing steps” or any result from the above “determining steps (e.g., including those such as a “pass” or a “fail”).” “Result” or “Results” may be stored inside and/or outside a terminal, may be retrieved and then used for an authentication operation, i.e., after an O/S and/or a (software) application of a terminal starts to execute one or more unexecuted or remaining steps of an authentication operation. Alternatively, “Result” or

“Results” may be used after a user performs at least one active or passive task for reacting to a screen displayed on a display unit such as, e.g., an advertisement screen, a content screen, and the like.

As used herein, an “activation operation” refers to an operation for switching (including starting to switch) a terminal from its inactive state to its active state in response to an activation (user) sub-input, UI_{ACT} (or another user sub-input when applicable). It is noted that an inactive state excludes a state in which a power is (or has been) turned off and, therefore, that a user has to turn on the power of a terminal before use. It is also noted that a terminal may run certain operations in the inactive and active states, where examples of such certain operations may include, but not limited to, receiving an incoming call, receiving an incoming email or message, and the like. It is further noted that a display unit may be in its OFF state when a terminal is in its inactive and active states, but that a terminal is in its active state when a display unit is in (or switches to) its ON state. Therefore, there generally exists no one-to-one relationship between the inactive and active states of a terminal and the OFF and ON states of a display unit.

As used herein, an “operation of turning ON at least one display unit while (or when) the display unit was (or has been) turned OFF” refers to an operation for switching (including starting to switch) a display unit from its OFF state to its ON state. Accordingly, the above operation is synonymous with an “operation of turning ON a display unit while (or when) the display unit was (or has been) turned OFF,” an “operation of switching a display unit from its OFF state to its ON state,” an “operation of turning ON a display unit,” simply “turn ON a display unit,” or more simply “turn ON.” “An operation of switching a display unit from its OFF state to its ON state” is also abbreviated as “switch a display unit to its ON state,” as “switch to its ON state” or simply as “turn ON.”

A “turn ON” of a display unit may include various steps such as, e.g., receiving (i.e., acquiring) UI and a (user) sub-input, closing an electrical switch of a display unit, supplying (or beginning to supply) electric current to a display unit, selecting at least one screen to be displayed on a display unit, displaying the screen on the display unit, optionally replacing an old screen with a new screen or overlapping an old screen with a new screen, and the like. Therefore, various terminals may employ different arrangements of such steps of a “turn ON” of a display unit such that, e.g., a terminal may keep a pre-selected screen in its storage or library ready while a display unit is turned OFF so that a display unit displays a pre-selected screen once the unit is turned ON, a terminal may select a screen to be displayed from its storage or library only after acquiring UI or a sub-input, a terminal may receive at least one screen to be displayed from an external source, and the like.

Regardless of such differences in detailed arrangements of such steps, however, the “turn ON” is deemed to be “on hold” (or to have been “on hold”) in the OFF state, i.e., one or more unexecuted or remaining steps of the “turn ON” have not been executed while (or as long as) a display unit is (or remains) turned OFF. Once acquired, however, a single user input (i.e., UI) and a (user) sub-input cause an O/S or at least one (software) application of a terminal to start execution of one or more unexecuted or remaining steps of the “turn ON” which were (or have been) on HOLD. For illustration purposes, it is appreciated that “an O/S or at least one (software) application of a terminal” is abbreviated as a “terminal,” and that “start execution of one or more unexecuted or remaining steps of the ‘turn ON’ which were (or have been) on HOLD” is abbreviated as “turn ON.” Therefore, the “turn ON” refers to executing a certain number of steps of an O/S or an application which have been (or was) on HOLD until a user provides a single user input (UI) and at least one (user) sub-input to a terminal, but which start to be executed in response to the user input and (user) sub-input. As a result, executing the unexecuted or remaining steps of the O/S or (software) application leads to switch a display unit from its OFF state to its ON state (i.e., “turn ON a display unit” or simply “turn ON”).

It is appreciated, however, that the “turn ON” may be deemed to not include following steps such as, e.g., the step of acquiring a user input and a (user) sub-input (to be referred to as the “acquiring steps”), the step of displaying on a display surface at least one screen (to be referred to as “displaying steps”), other (optional) steps which may be executed before such “acquiring steps” and/or after such “displaying steps,” and the like.

As used herein, an “activation (user) sub-input (UI_{ACT})” refers to a (user) sub-input which a terminal uses to activate itself (i.e., switch itself from an inactive state to an active state) and which a terminal may optionally use to turn ON at least one display unit (i.e., switch a display unit from its OFF state to its ON state). Without UI_{ACT}, an O/S or a (software) application may not activate itself, for it is “UI_{ACT}” which starts execution of one or more unexecuted or remaining steps of the “activation operation” of a terminal.

Similar to UI_{THEN}, characteristics of an “activation (user) sub-input (UI_{ACT})” also depend on a mechanism of an activation sensor for receiving UI_{ACT} and activating a terminal. Therefore, various characteristics of UI_{ACT} are identical or at least similar to those of UI_{THEN} as described above. Similar to UI_{THEN}, a user may provide UI_{ACT} concurrently with UI_{THEN} or UI_{AUX}, e.g., by manipulating a single part or multiple parts of an input unit or another part(s) of a terminal. Alternatively, a user-may provide such sub-inputs in a certain sequence such as, e.g., by manipulating a single part of an input unit or another part of a terminal with a single body part, by manipulating multiple parts of an input unit or another part of a terminal with a single or multiple body parts, and the like.

As used herein, an “auxiliary (user) sub-input (UI_{AUX})” refers to (user) sub-inputs other than UI_{THEN} and UI_{ACT} as defined above. Accordingly, unless otherwise specified, UI_{AUX} is neither UI_{THEN} nor UI_{ACT}. In general, UI_{AUX} refers to a (user) sub-input provided by a user for reacting to an “advertisement screen” or a “content screen” in order to proceed to a next step of operating a terminal. In addition, UI_{AUX} may relate to other screens to be displayed on a display unit, other (user) sub-inputs to control operations or settings of a terminal, other (user) sub-inputs for running an auxiliary operation and for performing an auxiliary function, and the like. It is noted that, without acquiring (or having to acquire) UI_{ACT}, an O/S or a (software) application of a terminal may not be able to run any auxiliary operation and, therefore, may not be able to perform any auxiliary function.

A user may provide UI_{AUX} concurrently with UI_{THEN} or UI_{ACT}, e.g., by manipulating at least one part of an input unit or another part of a terminal. For example, a user may provide UI_{AUX} concurrently with UI_{THEN} or UI_{ACT} or in a certain sequence by manipulating at least two parts of an input unit, at least two other parts of a terminal, at least one part of an input unit along with at least one part of a terminal, and the like. When desirable, UI_{AUX} may correspond to UI_{THEN} or UI_{ACT}, only when expressly specified in this disclosure.

As used herein, an “input unit” refers to all prior art devices which receive (i.e., acquire) one or more user inputs (UI) and one or more (user) sub-inputs included therein or accompanied thereby. An “input unit” may directly receive at least one UI and (user) sub-input or, alternatively, may only acquire UI and then extract one or more sub-inputs therefrom. Alternatively, an “input unit” may only acquire UI and then a different part of a terminal may extract one or more sub-inputs therefrom. Depending on a nature or a detailed mechanism thereof, an input unit may include a mechanical input unit, an electromagnetic input unit, an electrical input unit, a magnetic input unit, an acoustic or vocal input unit, a ultrasonic input unit, a visual input unit, an optical input unit, and the like, where each of such units is designed to respectively receive a mechanical user input, an electromagnetic user input, an electrical user input, a magnetic user input, an acoustic or vocal user input, an ultrasonic user input, a visual user input, and an optical user input.

Depending upon such nature and mechanism of an “input unit,” a user may provide UI and (user) sub-input by directly or indirectly manipulating at least a portion of the input unit in various modes. For example, a user may directly manipulate a portion of the “input unit,” e.g., when UI and its sub-input are mechanical in nature. In another example, a user may indirectly manipulate at least a portion of the “input unit” when, e.g., UI and sub-input are visual or acoustic and a terminal acquires such on its own using its camera or microphone.

A terminal may include a single input unit which receives (i.e., acquires) a single UI one at a time or which receives multiple UI of the same, similar or different types sequentially or concurrently, where each UI may include therein a single (user) sub-input or multiple (user) sub-inputs of the same, similar or different types. A terminal may instead include multiple input units (of the same, similar or different types) each of which may receive a single UI or multiple UI of the same, similar or different types concurrently or sequentially.

Various conventional input units may be employed in a mobile communication terminal of this disclosure as long as such input units receive (i.e., acquire) various UI and (user) sub-inputs. First examples of such input units are various input devices described in U.S. Pat. No. 5,463,388 (entitled “Computer mouse or keyboard input device utilizing capacitive sensors,” filed by Boie et al. on Jan. 29, 1993, assigned to AT&T IPM Corp., and incorporated herein in its entirety by reference), where such input devices include a force imaging input unit, an input tablet (with or without a stylus), a joy stick, a keyboard, a mouse or a track ball, and where each of such devices receives mechanical user inputs, tactile user inputs, and the like.

Second examples of such input units are various input devices described in U.S. Pat. No. 7,479,949 (entitled “Touch screen device, method, and graphical user interface for determining commands by applying heuristics,” filed by Steve Jobs and 24 co-inventors on Apr. 11, 2008, assigned to Apple, and incorporated herein in its entirety by reference), where such input devices include a click wheel, a dial pad, a finger gesture input unit, a hand-writing input unit, an image-based input unit, a keyboard, a touch pad or screen (including those capable of recognizing multiple-touch inputs), and the like, and where each of such devices receives mechanical user inputs, tactile user inputs, and the like. Such input devices also include a microphone capable of receiving acoustic user inputs or electrical user inputs.

Third examples of such input units are various input devices described in U.S. Pat. No. 8,392,340 (entitled “Method and apparatus for detecting conditions of a peripheral device including motion, and detecting, predicting temperature(s) wherein at least one temperature is weighed based on detected conditions,” filed by K. Cox et al. on Sep. 21, 2009, assigned to Apple, and incorporated herein in its entirety by reference), where such input devices include a touch pad, a mouse, a keyboard, a pointing unit, and the like. Such input devices also receive mechanical user inputs such as, e.g., an acceleration of a user or a device.

Fourth examples of such input units are various input devices disclosed in U.S. Pat. No. 8,542,206 (entitled “Swipe gestures for touch screen,” filed by W. C. Westerman et al. on Sep. 23, 2011, claiming a priority date of Jun. 22, 2007, assigned to Apple Inc., and incorporated herein in its entirety by reference), where such input devices include a joy stick, a button, a keyboard, a mouse, a pointing stick, a switch, a touch surface (including a touch pad and screen) or a trackball, and where each of such devices receives mechanical user inputs, tactile user inputs, and the like. Examples of such devices also include a touch panel or a touch screen which may be positioned in front of a display unit or constructed integrally with a display unit so that a touch sensitive surface corresponds to all or a portion of a viewable area of a display unit, which may detect touch events and send corresponding signals to a controller which may then process the signals and send data to a mobile phone, that a mobile phone can translate such touch events into computer events which are recognizable by the phone, and the like.

Fifth examples of such input units are various input devices disclosed in U.S. Pat. No. 8,279,182 (entitled “User input device and method using fingerprint recognition sensor,” filed by H. S. Kim et al. on Jun. 26, 2007, claiming a priority date of Jun. 27, 2006, assigned to Samsung Electronics Co., Ltd., and incorporated herein in its entirety by reference), where such input devices include a button key, a keypad, a soft keyboard, a touch screen, and the like, and where each of such devices receives mechanical user inputs, tactile user inputs, and the like.

Sixth examples of such input units are various input devices disclosed in U.S. Pat. No. 8,554,275 (entitled “Mobile terminal having an image projector and controlling method therein,” filed by D. Y. Chung on Nov. 24, 2010, assigned to LG Electronics, and incorporated herein in its entirety by reference), where such input devices include a dome switch, a jog switch, a jog wheel, a keypad, a touch film, a touch pad or a touch sheet (for receiving or acquiring various mechanical user inputs or tactile user inputs), a microphone (for receiving acoustic user inputs such as, e.g., user's voice or environmental sounds), a camera (for receiving a visual user inputs or optical user inputs), an electrical capacitive unit (for receiving an electrical user input), and the like.

The above prior arts such as U.S. Pat. Nos. 5,463,388, 7,479,949, 8,279,182, 8,542,206, and 8,554,275 also disclose various manipulations of such input devices, where such manipulations may be applied to various input units to provide UI and other (user) sub-inputs to various terminals of this disclosure. Therefore, a user of the mobile communication terminal of this disclosure may provide UI and other (user) sub-inputs according to similar manipulations such as, e.g., by pressing, pushing, contacting, touching, deforming, displacing, swiping, pulling, rotating, swiveling, rolling or otherwise manipulating at least a portion of such input units. A user may also provide UI and other (user) sub-inputs by other user manipulations such as, e.g., by touching or contacting at least a portion of the input unit with his or her finger or another body part, sliding or tapping such a portion of the input unit with his or her finger or another body part, otherwise moving his or her finger or another body part with respect to such a portion of the input unit, and the like.

In addition and as disclosed in U.S. Pat. Nos. 5,463,388, 7,479,949, 8,279,182, and 8,554,275, a user may provide UI and other (user) sub-inputs by similar manipulations such as, e.g., by contacting or touching the portion of an input tablet, a touch film, a touch pad, a touch screen, a touch sheet or a touch surface with at least one object concurrently or sequentially, where examples of such objects may include, but not limited to, a finger(s) of a user, another body part of a user, a stylus, and the like. In addition, a user may provide UI and other (user) sub-inputs by other manipulations such as, e.g., by supplying an acoustic user input to an acoustic input unit (such as, e.g., a microphone), by supplying an electronic user input to an electrical input unit, by providing a visual user input to a visual input unit (such as, e.g., a camera, a charge coupled device or CCD or a light-sensitive sensor), by providing an electrical user input to an electrically capacitive input unit, and the like.

As used herein, a “display unit” refers to a hardware element of a terminal and includes at least one “display surface” on which a color (or black-and-white) image or video clip may be displayed. A terminal may include any prior art display unit examples of which may include, but not limited to, an LCD (liquid crystal display), a TFT (thin film transistor) display, an OLED (organic light emitting diode) display, an AMOLED (active matrix organic light emitting diode) display or any other prior art display units capable of displaying such images.

A terminal may include more than one display unit such as, e.g., a first display unit and a second display unit, where each display unit may switch between its OFF state and ON state. A terminal may operate multiple display units independently of each other or dependently on each other such as, e.g., in synchronization. For example, the first and second display units may switch to their ON states in response to the same single user input (and sub-input) or each of the first and second display units may switch to its own ON state in response to a separate user input (and sub-inputs). In another example, the first and second display units may switch to their ON states in response to a single or multiple user inputs (and sub-inputs) provided to the same input unit (or another part of a terminal) or, alternatively, in response to multiple user inputs (and sub-inputs) provided to different input units (or different parts of a terminal). In another example, the first and second display units may switch between their OFF and ON states together or independent of each other. Therefore, one display unit may always remain in its ON state while another display unit may switch between its OFF and ON states in response to a single user input (and sub-input) or in response to one of multiple user inputs (and sub-inputs). In another example, the second display may be turned ON [A] concurrently with turning ON the first display unit, [B] only after the first display unit is turned ON, or [C] when the first display unit was turned ON and then switches to its OFF state, where the brackets “[ ]” represent that such operations or steps following such brackets are alternatives to one another. In other words, a terminal may control both of the first and second display units in almost any type of temporal synchronization. Instead a terminal may control the first and second display units in another synchronization which is based on positions of such display units in a terminal, where this mode is referred to as spatial synchronization, in contrast to the above temporal synchronization. When it is desirable, the terminal may resort to a combination of such temporal and spatial synchronizations.

Multiple display units may be of the same type or at least two of such display units may be of different types such that, e.g., the first and second display units are OLEDs, the first display unit is an LCD but the second display unit is an AMOLED, and the like. In addition, multiple display units may define various configurations so that they may have the same, similar or different shapes, lengths, heights, resolutions, and the like. Such display units may be positioned in various positions and/or arrangements such that multiple display units are disposed side by side, one over another, concentrically or in a combination thereof. When desirable, such display units may be disposed on different sides or surfaces of the terminal such that one display unit may be disposed on a front side of the terminal, while another display unit is disposed on a back side thereof.

One of such display units may serve as a main display unit, while another display unit(s) may then serve as a minor display unit(s). For example, the main display unit may be installed on a certain side or position of a terminal, regardless of its shape or size, where examples of such side or position may include, e.g., a center portion of a front side, an upper portion of a front side, and the like.

A terminal may synchronize multiple display units to display different portions of a single image on different display units such that, e.g., the first display unit displays a right half of a still image or a video clip, while the second display unit displays a remaining half of an image or a video clip. Alternatively, a terminal may control multiple display units to display different images independently or dependently so that, e.g., the first display unit displays images relevant to an operation which is run by an O/S or a (software) application of a terminal, while the second display unit displays one or more routine data such as, e.g., a time, a weather, and the like.

Contrary to the above terminal which includes multiple display units, a terminal may include a single display unit defining multiple sections thereon, and manipulate each section as it manipulates the separate display units. In particular, a terminal may switch each section between its OFF and ON states, and control each section in various modes which are similar to the modes of controlling multiple display units as described in the foregoing paragraphs. Accordingly, configurational and operational details of the display unit with multiple sections thereon are omitted for simplicity of illustration.

As used herein, an “authentication unit” refers to a hardware unit and/or a software unit of a terminal which may directly receive (i.e., acquire) UI_{THEN} (or another user sub-input), which may directly or indirectly extract UI_{THEN} or other information necessary to run an authentication operation from UI (and other user sub-inputs), which may run an authentication operation in a computational level, and the like. Thus, an “authentication unit” may include, e.g., at least one “authentication sensor (or sensing element)” which may detect (i.e., acquire) UI_{THEN} (or another user sub-input), at least one “authentication element” which may perform the above “comparing steps” and/or “determining steps,” and the like.

As used herein, the phrase “in response to a single user input and at least one (user) sub-input” has the same meaning as other phrases such as, e.g., “in response to a single user input,” “in response to a user input” or “in response to UI.” It is noted that “a result ‘in response to UI’” is defined as at least one result from at least one hardware unit and/or software unit of a terminal in response to a single user input and at least one (user) sub-input included in a single user input. Accordingly, the phrase “in response to UI” in a software perspective means that an O/S or at least one (software) application reacts directly to UI, e.g., by running at least one (predetermined) operation or a set of instructions in order to perform at least one specific function, and the like.

As defined hereinabove, a “user input” is synonymous with a “single user input” in such a manner that both refer to a single input provided to a terminal by a user under certain conditions such as, e.g., when a user manipulates at least a portion of an input unit (or another part of a terminal) with a body part only once, when a user does not move his or her body part with respect to an input unit (or another part of a terminal) during such manipulation (for a certain period, less than a certain period or longer than a certain period), when a user does not detach his or her body part from an input unit (or another part of a terminal) (for a certain period, less than a certain period or longer than a certain period) during the manipulation, when a user does not stop manipulating an input unit (for a certain period, less than a certain period or longer than a certain period), when a user does not change a mode of manipulation of an input unit (or another part of a terminal) (for a certain period, less than a certain period or longer than a certain period), and the like. Accordingly, “in response to UI” refers to a situation [A] where a user does not provide any intervening user input (UI) and any (user) sub-input or [B] where a user does not provide any additional user input (UI) and any (user) sub-input [B-1] before a terminal completes execution of such unexecuted or remaining steps of an O/S or a (software) application which has started upon receiving a first user input (UI₁) and (user) sub-input, [B-2] while a terminal executes such unexecuted or remaining steps, [B-3] after a terminal completes execution of at least a substantial portion of such unexecuted or remaining steps thereof, and the like. In other words, when determining whether or not a certain operation is run “in response to UI,” it typically does not refer to a time taken to run such an operation but it refers to presence or absence of any intervening or additional user input (and its sub-input).

It is appreciated throughout this disclosure that “in response to UI” is deemed to be preceded by the step(s) of “receiving UI,” which in turn is synonymous with “acquiring UI,” where both phrases are abbreviated as “acquiring steps.” Thus, “run an operation in response to UI” means that a terminal runs an operation after a terminal receives UI and at least one (user) sub-input, but before acquiring any intervening or additional UI and at least one intervening or additional (user) sub-input. For illustration purposes, “in response to a single authentication (user) sub-input” is synonymous with “in response to an authentication (user) sub-input” or “in response to UI_{THEN}.”

As used herein, the phrase “upon receiving (i.e., acquiring) a single user input” is deemed to be synonymous with the phrases “upon receiving a single user input,” “upon receiving a user input,” “in response to at least one user input,” “in response to a user input,” or “in response to UI.”

As used herein, the phrase “as a result of a user input” is synonymous with “as a result of UI,” where both phrases mean that a terminal reacts indirectly to UI. More particularly, “as a result of UI” refers to a situation where a terminal runs a certain operation in response to a first user input (UI₁) and at least one first (user) sub-input. However, the terminal is also required to receive at least one intervening or additional second user input (UI₂) and at least one second (user) sub-input to complete to run the certain operation or, alternatively, the terminal also requires a user to provide at least one intervening or additional second user input (UI₂) and at least one second (user) sub-input to a terminal to complete to run the certain operation.

As used herein, the phrase “display at least one screen on at least one display unit” is synonymous with the phrases “display at least one screen on a display unit,” “display a screen on a display unit” or simply “display a screen.” Despite its plain appearance, detailed steps and resulting sequences of “display a screen” may differ from situation to situation, where FIGS. 1A through 1I explain such steps and consequences.

In one example and as depicted in FIGS. 1A and 1B, a display unit “displays a screen” in response to a user input (and at least one user sub-input) when a terminal receives UI while its display unit was (or has been) in its OFF state. In this case, a terminal turns ON a display unit in response to UI, and then display at least one “screen” on an entire portion of a display surface of a display unit (FIG. 1A) or, in the alternative, on only a portion of a display surface thereof (FIG. 1B).

In another example and as illustrated in FIGS. 10 to 1E, a display unit has been (or was) in its ON state while displaying at least one old screen on a display surface thereof. As a terminal receives UI, a display unit may display a new screen in response to UI. In such a case, a user does not need to activate a terminal, for its display unit was (or has already been) in its ON state, and a terminal may replace an entire (or only a) portion the old screen with the new screen (FIG. 10). In other words, a terminal removes the old screen from a display surface by stopping to display the old screen. In the alternative, a terminal may display the new screen on top of an entire portion of the old screen (FIG. 1D) or, alternatively, on top of only a portion of the old screen (FIG. 1E). It is noted that “displaying a new screen over (or on top of) an entire portion (or only a portion) of an old screen” is referred to as “overlapping an old screen with a new screen,” “overlaying a new screen over an old screen” or “covering an old screen with a new screen,” and the like.

In another example, a terminal includes multiple display units and manipulates such display units to display various screens thereon. For example, a terminal may switch each display unit between its OFF state and its ON states independently. In another example, a terminal may turn ON at least two of multiple display units in a certain synchronization, where such a synchronization may be “turning ON” all (or at least two) display units concurrently, sequentially or in a combination thereof. In another example, each display unit may display such screens as described above.

Therefore and as shown in FIGS. 1F to 1H, a terminal includes a major display unit (e.g., the unit positioned in a center portion of a display surface) and a minor display unit (e.g., the unit positioned in a top portion of a display unit), where each display unit “displays a screen” in response to a user input as a terminal receives UI, while at least one of its display units was (or has been) in its OFF state. The terminal may display a screen on an entire portion of the major display unit in response to a user input as in shown FIG. 1F, or displays different screens on the major and minor display units as shown in FIG. 1G. In the alternative, the terminal may display a screen on only a portion of the major display unit as shown in FIG. 1H or on the minor display unit (not shown in the figure).

When a terminal receives UI while at least one display unit displays (or has been displaying) an old screen, a terminal replaces an entire (or only a) portion the old screen with the new screen as shown in FIG. 1I, e.g., by stopping to display the old screen on a display unit. Alternatively, a terminal may overlap an entire (or only a) portion of the old screen with the new screen.

Various mobile communication terminals incorporating such structures and configurations of this disclosure thereinto and various methods of operating such terminals and sequences therefor of this disclosure offer various benefits to a user. Followings are selected benefits of the terminals which incorporate such systems, methods, and their sequences of this disclosure.

The first objective of various terminals, methods, and sequences of this disclosure is to provide a user with both seamless and secure operations of authenticating and advertising. For example, a terminal is activated and concurrently runs (including “starts to run”) at least one authentication operation in response to a single user input (UI) and at least one user sub-input such as, e.g., an authentication user sub-input, UI_{THEN}, an optional sub-input, and the like, which are provided to a terminal while its display unit was turned OFF (i.e., the display unit has been in its OFF state). A terminal may turn ON its display unit and display (including “start to display”) at least one advertisement screen or at least one content screen thereon prior to, after or concurrently with activating a terminal or “running at least one authentication operation” (to be abbreviated as “running the authenticating” or “running such authenticating”). Therefore, a terminal can display a content screen or an advertisement screen in a display unit as well as “run the authenticating,” all in response to a single authentication (user) sub-input, UI_{THEN}.

Such a terminal may activate (including “starts to activate”) itself in response to a single user input, execute (including “starts to execute”) at least one step of such “determining steps” after (or during) “running the authenticating” in response to the user input, and optionally switch (including “starts to switch”) its display unit from its OFF state to its ON state (i.e., “turn ON), and display at least one advertisement screen or at least one content screen thereon. Such a terminal may turn ON its display unit in various sequences such as, e.g., [A] prior to, after or concurrently with “running the authenticating,” [B] prior to, after or concurrently with “executing at least one step of such determining steps” (to be abbreviated as “execute the ‘determining’” executing such ‘determining’”) or [C] in a combination thereof, where the brackets “[ ]” represent that such operations or steps following such brackets are alternatives to each other.

In one exemplary embodiment of this first objective, a terminal activates itself, “runs the authenticating” upon (or after) receiving a single UI, and then “executes the determining” after (or during) “running the authenticating” in response to the single UI, while optionally or conditionally turning ON a display unit in one of the sequences as described in the preceding paragraph.

In another exemplary embodiment of this first objective, a terminal may activate itself in response to a single UI, and then execute each of the following sequences in response thereto. [A1] In one example, a terminal “turns ON” a display unit and displays at least one screen on the display unit, then “runs the authenticating,” and then “executes the determining.” [B1] In another example, a terminal “turns ON’ a display unit and displays at least one screen on the display unit, “runs the authenticating” concurrently therewith, then “executes the determining,” and the like. [C1] In another example, a terminal “runs the authenticating,” then “turns ON” a display unit and displays at least one screen on the display unit, then “executes the determining,” and the like. [D1] In yet another example, a terminal “runs the authenticating,” then “turns ON” a display unit and displays at least one screen on the display unit, and then “executes the determining” concurrently therewith. [E1] In another example, a terminal “runs the authenticating,” then “executes the determining,” and then “turns ON” a display unit and displays at least one screen on the display unit. That is, the terminal can execute each of the above sequences, [A1] to [E1], in response to the single UI which includes at least one (user) sub-input, where UI preferably includes therein UI_{THEN} to “run the authenticating.”

As described above, a display unit, when turned ON, may display at least one advertisement or content screen, where a terminal may obtain such a screen from diverse sources. In one example, a manufacturer of a terminal or a distributor thereof may already have stored such a screen in a terminal before purchase by a user. Similarly, a user may have downloaded the screen to a terminal from an external source after purchase and prior to displaying such. In the alternative, an external source may provide such a screen to a terminal in response to a single UI (including at least one user sub-input therein) in real time or in almost real time.

It is appreciated that the advertisement or content screen displayed on a display unit may require a user to react to such a screen in order to proceed to a next step of operation of a terminal such as, e.g., by providing at least one auxiliary (user) sub-input (UI_{AUX}) thereto or by performing at least one active task or passive task, where a user performs such a task, e.g., by pressing or touching a portion of a touch screen of an input unit, by manipulating a different input unit, by manipulating another part of a terminal, and the like. However, a terminal executing each of the above sequences may not require a user to provide any additional UI_{THEN2}. In other words, even if such a screen requires a user to react thereto by providing UI_{AUX} or performing the task, a display unit may remain in the ON state, a terminal may remain in a lock state, or a terminal may switch to an unlock state, all in response to a single UI_{THEN}. As a result, a user can proceed to a next step of operating a terminal when the user is done (or finished) with such a screen by providing UlAux or performing the task, without having to provide any additional authentication (user) sub-input, UI_{THEN2}.

The terminals of the above embodiments as well as others throughout this disclosure may accomplish these seamless operations by utilizing “Result” or “Results” which collectively mean the authentication (user) sub-input (UI_{THEN}) itself, any results from such “comparing steps,” any results from such “determining steps (e.g., including a “pass” or a “fail”),” and other information or signals related to the above. For example, when a terminal receives a single UI including therein UI_{THEN}, a terminal may store “Result” in various modes such as, e.g., storing UI_{THEN} itself, “executing the “comparing steps” (to be abbreviated as “executing the comparing” or “executing such comparing” hereinafter) and storing results therefrom, executing the “determining steps” and storing their results, and the like. The user may then react to such a screen, e.g., by providing UI_{AUX} to a terminal or by performing an active task or a passive task as required by a screen. After the user is finished with reacting to the screen (i.e., by providing UI_{AUX} or performing the task) or while the user is reacting to the screen, the terminal retrieves “Result” from its storage and completes the remaining or unexecuted steps of “running the authenticating.” Therefore, a terminal may accomplish authenticating the user and displaying at least one screen on a display unit in response to a single UI_{THEN} (i.e., by requiring a user to provide only one UI_{THEN}), even when a user has to provide one or multiple intervening auxiliary sub-inputs (UI_{AUX}) or to perform one or more active tasks or passive tasks.

Various display units throughout this disclosure may work in various modes. For example, a display unit may be always turned ON in response to a single UI, where a display unit may display different screens (including a lock screen or a home screen) based on “Result.” In another example, a display unit may display a screen only when a user passes an authentication operation, only when a user fails an authentication operation, and the like. In other words, a display unit may remain in its OFF state until a terminal finishes an authentication operation. In another example, a display unit may display one of at least two different screens based upon “Result” and/or switch to its OFF state when a user fails an authentication operation. In another example, a display unit may display multiple screens sequentially or concurrently, may display such screens before, while or after a terminal “runs the authenticating,” may display such screens, before, while or after the user reacts (or starts to react, finishes to react, and the like) to the screen, and the like.

The terminals throughout this disclosure may receive various user inputs and their sub-inputs. For example, a user may provide UI which includes a single sub-input such as, e.g., UI_{THEN}, therein. In such a case, a user may have to provide a separate user input including a (user) sub-input such as, e.g., UI_{ACT}, so as to activate a terminal, unless UI_{THEN} also serves as UI_{ACT}. In the alternative, the user may provide UI which may include therein at least two (user) sub-inputs such as, e.g., UI_{THEN} and UI_{ACT}. In response to such UI, a terminal may activate itself in response to UI_{ACT} and may “run the authenticating” in response to UI_{THEN}.

Depending upon a structure and a mechanism thereof, a single input unit may receive (i.e., acquire) only one (user) sub-input so that, e.g., a terminal may require at least two input units so as to receive UI_{ACT} and UI_{THEN}. Alternatively, a single input unit may receive multiple sub-inputs such as, e.g., UI_{ACT} and UI_{THEN}, and may optionally receive UI_{AUX}. This input unit may be constructed to incorporate at least two sensors or sensing elements therein for sensing multiple sub-inputs such as, e.g., UI_{ACT} and UI_{THEN}.

The second objective of various terminals, methods, and sequences of this disclosure is to provide a user with both seamless and secure operations of authenticating and advertising, while also displaying at least one screen concurrently therewith. More particularly, a terminal is activated, runs (including “starts to run”) an authentication operation, executes (including “starts to execute”) at least one step of the “determining steps,” and may optionally turn ON its display unit while displaying (including “start to display”) at least one screen (e.g., an advertisement screen, a content screen, and the like) thereon, all in response to a single (user) sub-input (more particularly, a single authentication user sub-input, UI_{THEN}) provided to a terminal while its display unit was turned OFF (or remains in its OFF state). Therefore, a terminal may display an advertisement screen and “run the authenticating,” all in response to a single UI which includes therein UI_{THEN}. This second object may correspond to the sequences [A1] and [B1] of the first objective, and may also correspond to the sequence [C1] when other conditions are met.

The terminal of this second objective may activate itself in response to a single UI_{THEN}, and turn ON a display unit concurrently therewith, “run the authenticating,” and “execute the determining” after (or during) “running the authenticating” in response to UI_{THEN}. Therefore, this terminal may turn ON a display unit and display thereon at least one advertisement or content screen in response to a single UI_{THEN}. Like the terminal of the first objective, a terminal of this second objective may switch itself to its unlock state when a user passes an authentication operation. Alternatively, a terminal may switch itself to its OFF state [A] when a user fails an authentication operation, [B] when a user does not provide any UI_{AUX} within a certain period, [C] when a user does not perform any task thereto within a certain period, and the like.

It is appreciated that any step of various sequences of this second objective may be altered or at least two steps of such sequences may be executed concurrently, as long as “executing the determining” may not be performed prior to “running the authenticating.” Other hardware or software features of various terminals of this second objective and their operational features may be identical or similar to those of the terminals of the first objective when applicable.

The third objective of various terminals, methods, and sequences of this disclosure is to provide a user with both seamless and secure operations of authenticating and advertising, while also displaying at least one screen. More particularly, such a terminal is activated, runs at least one authentication operation, executes such “determining steps,” turns ON its display unit, and displays an advertisement or content screen, all in response to a single authentication (user) sub-input (UI_{THEN}) provided to a terminal while its display unit was turned OFF. Thus, a terminal turns ON its display unit, displays a screen, and “runs the authenticating,” all in response to a single UI_{THEN}. This third object may correspond to a subset of the second objective.

The terminal of this third objective may utilize “Result” in order to provide various seamless operations when an advertisement or content screen requires a user to provide UI_{AUX} or to perform an active or passive task in order to proceed to a next step of operating the terminal. That is, such a terminal may keep its display unit always ON while a user is reacting to the screen, whether or not a user passes an authentication operation. Like other terminals of other objectives, a terminal may switch to its unlock state when a user passes an authentication operation or, alternatively, may switch its display unit to its OFF state in a certain period after a user fails an authentication operation or in a certain period of non-action by the user.

It is appreciated that any steps of the above sequences of this third objective may be altered or at least two steps of such sequences may be executed concurrently, as long as “executing the determining” may not be performed prior to “running the authenticating.” Other hardware or software features of the terminals of this third objective and their operational features may be identical or similar to those of the terminals of the first or second objectives when applicable.

The fourth objective of various terminals, methods, and sequences of this disclosure is to provide a user with both seamless and secure operations of authenticating and advertising, while conditionally keeping a display unit in its OFF state. More particularly, a terminal is activated, runs at least one authentication operation, and executes at least one step of such “determining steps,” all in response to a single (user) sub-input, UI_{THEN}, provided to a terminal while its display unit was (or has been) turned OFF. The terminal also turns ON its display unit while displaying an advertisement or content screen thereon only on occurrence of a certain event. In other words, a terminal may keep its display unit in its OFF state or may turn OFF a display unit until occurrence of a certain event such as, e.g., when a user passes an authentication operation.

Therefore, upon or after receiving a single (user) sub-input such as, e.g., UI_{THEN}, from a user, a terminal of this fourth objective may “run the authenticating” and “execute the determining” based on “Result” obtained from “running” at least portion of “authenticating.” In one example, after obtaining “Result” from “running the authenticating” or “executing the determining,” a terminal may keep its display unit in its OFF state if “Result” is a fail, turn ON a display unit if “Result” is a pass, and the like. In another example, after obtaining “Result,” a display unit may display a default screen when “Result” may be a fail, rather than keeping it in (or switching to) its OFF state. As described above, a default screen may include a lock screen, a screen with at least one of “routine data” as defined above, or another screen with an advertisement or a content, where each of such screens may not allow a user to react thereto. In the alternative, a default screen may allow a user to react to such a screen to only a minimum extent, where the term “minimum” is used in a relative sense such that a default screen allows a user to provide UI_{AUX} or to perform the active or passive task, but that various options provided by such screens to a user are limited than options provided by other screens (e.g., AD_{D} and CT_{D}) to the user and may also be limited than options provided by yet other screens (e.g., AD_{B} and CT_{B}) to the user.

It is appreciated that any step of various sequences of this fourth objective may be altered or at least two steps of such sequences may be executed concurrently, as long as “executing the determining” may not be executed prior to “running the authenticating.” Other hardware or software features of such terminals of this fourth objective and their operational features may be identical or similar to those of the terminals of the first, second or third objectives when applicable.

The fifth objective of various terminals, methods, and sequences of this disclosure is to provide a user with both seamless and secure operations of authenticating and advertising, while always keeping a display unit in its ON state. More particularly, a terminal is activated in response to a single or multiple auxiliary (user) sub-inputs (e.g., UI_{ACT} or UI_{AUX}), turns ON a display unit, and displays an advertisement or content screen, all in response to a single or multiple UI_{ACT} or UI_{AUX}, when such sub-inputs are provided to a terminal while its display unit has been (or was) turned OFF. A user is then required to react to the screen by providing a single additional (user) sub-input for reacting to the screen. In particular, the terminal is arranged such that a portion of the screen (e.g., a “tab” defined above) receives a single authentication (user) sub-input (UI_{THEN}) from a user.

After the user is finished with such a screen, the terminal may then proceed to a next step of operation while utilizing UI_{THEN} itself or “Result” obtained from “running the authenticating.” Accordingly, the terminal allows the user to enjoy both seamless and secure operations of the terminal in response to a single UI_{THEN}, despite the fact that he or she has to provide a single or multiple UI_{ACT} or UI_{AUX}.

More particularly, in response to a single UI_{ACT}, a terminal may activate itself, switch its display unit to its ON state, and display thereon an advertisement or content screen. While a user reacts to a screen by providing UI_{THEN} (or by performing the active or passive task) to an input unit or to a certain tab provided on a screen, a terminal may acquire (or extract) UI_{THEN} or other authentication information, may “execute the determining,” and may then obtain “Result.” After a user is finished with reacting to an advertisement or content screen, a terminal may retrieve “Result” and manipulate its display unit in one of the following modes.

In one example, a terminal may display different screens based upon “Result” or may display a preselected screen regardless of “Result.” In another example, a terminal may display different screens according to a preset sequence which may be determined based upon “Result.” In another example, a terminal may display the same screen until a user passes an authentication operation or may instead display different screens in the same or different sequences based on whether or not a user may pass an authentication operation. Accordingly, a terminal of this fifth objective may enable a user to see at least one screen on its display unit regardless of whether or not a user passes the authentication operation.

It is appreciated that a terminal may turn ON its display unit in response to UI_{ACT} but at different timings. For example, a display unit [A] may switch to its ON state after a terminal receives UI_{ACT} but before “running the authenticating,” [B] may switch to its ON state concurrently with “running the authenticating,” [C] may be turned ON after “running the authenticating” but before “executing the determining,” [D] may be turned ON concurrently with “executing the determining,” and the like, where those following the brackets “[ ]” represent that they are alternatives to each other. It is also appreciated that a terminal may store UI_{THEN} before a user reacts to the screen, and then retrieves such UI_{THEN} (or extracts information carried by UI_{THEN}) after the user is finished with reacting to the screen. In this case, a terminal retrieves UI_{THEN} and “executes the determining.” Based on whether the user passes or fails an authentication operation, a terminal may manipulate a display unit in various modes. In the alternative, a terminal may “execute the determining” and store a “pass” or a “fail” obtained therefrom before a user reacts to the screen. In this case, the terminal retrieves the “pass” or “fail” after a user is done with the screen and, based thereupon, a terminal may manipulate a display unit in various modes as described heretofore and hereinafter. It is further appreciated that any steps of the above sequences of this fifth objective may be altered or at least two steps of such sequences may be executed concurrently, as long as “executing the determining” is not performed prior to “running the authenticating.” Other hardware or software features of the terminals of this fifth objective and their operational features may be identical or similar to those of the terminals of the first, second, third or fourth objectives when applicable.

The sixth objective of various terminals, related methods, and sequences of such methods of this disclosure is to provide various hardware or software features for guaranteeing secure operations of advertising while providing seamless authentication operations. For example, a terminal may be activated in response to a single (user) sub-input (e.g., UI_{THEN}), may run at least one authentication operation in response thereto, may execute at least one step of the “determining steps,” and may turn ON its display unit and display at least one advertisement or content screen, all in response to a single (user) sub-input (UI_{THEN}). At the same time, a terminal may be arranged to sequester and/or secure data stored therein from an unauthorized attempt or from an unauthorized user, may completely or conditionally deny an access to such data by an unauthorized site or link, and the like.

In one exemplary embodiment, upon (or after) receiving (i.e., in response to) a single (user) sub-input (e.g., UI_{THEN}) from a user, a terminal may activate itself, run at least one authentication operation in response to UI_{THEN}, execute at least one step of such “determining steps” after (or during) “running the “authenticating,” turn ON a display unit, and display at least one advertisement or content screen, all in response thereto. A terminal may display the screen in various modes or at various timings such as, e.g., [A] prior to “running the authenticating” or “executing the determining,” [B] after “executing the determining” or “running the “authenticating,” [C] concurrently with “running the authenticating” or “executing the determining,” or [D] in a combination thereof. It is appreciated that a user provides a single user input (UI) which includes therein both of UI_{THEN} for “running the authenticating” and UI_{ACT} for activating a terminal, that a single UI_{THEN} may include UI_{ACT} therein, that a single UI_{THEN} may serve as UI_{ACT}, and the like.

In another exemplary embodiment, upon (or after) acquiring (i.e., in response to) a single (user) sub-input (e.g., UI_{THEN}) from a user, a terminal activates itself and then executes various operations or steps according to any of the following sequences. In one example, a terminal may turn ON its display unit and display at least one advertisement or content screen, then “run the authenticating,” “execute the determining,” and the like, all in response to a single UI_{THEN}. In another example, a terminal turns ON its display unit and displays an advertisement or content screen, “runs the authenticating” concurrently with such “turning ON,” and then “executes the determining,” all in response to a single UI_{THEN}. In another example, such a terminal “runs the authenticating,” then turns ON a display unit and displays the above screen thereon, and then “executes the determining,” all in response to a single UI_{THEN}. In another example, a terminal runs the “authenticating,” then turns on a display unit and displays the advertisement or content screen, and executes the “determining” concurrently with displaying the screen or with the “turning ON,” all in response to a single UI_{THEN}. In another example, a terminal “runs the authenticating,” then “executes the determining,” and then turns ON a display unit and displays an advertisement or content screen, all in response to a single UI_{THEN}.

It is appreciated that the terminals according to each embodiment of this disclosure may display the same or different screens at different timings, on occurrence of a certain event, and the like. Accordingly, the seventh objective of various terminals, methods related such terminals, and sequences of various methods of this disclosure is to accomplish the secure operations of advertising while providing seamless authentication operations by employing following structures, configurations, sequences, and the like. It is to be appreciated that various hardware or software features of this seventh objective may be equally applicable to the above objectives as well as various exemplary aspects and embodiments to be disclosed below.

Therefore, in one exemplary embodiment of this seventh objective, a terminal may guarantee an enhanced security in advertising, primarily focusing on its software configuration and/or operation. In one example, a terminal may include an O/S or a (software) application which may display the above screen on a display unit but which may completely or conditionally prevent a user from accessing any external link provided on such a screen, from downloading any file from an external source accessible from the screen, from running any application available from an external link or source provided on such a screen or accessible from such a screen, and the like. As a result, neither any perpetrator nor any external server can access data stored in such a terminal.

In another example of the exemplary embodiment of this seventh objective, an O/S and/or an application of a terminal may display an advertisement screen or a content screen on a display unit, only if such a screen is provided in an authorized format or only if such a screen is pre-approved by a user, by an external source, and the like. For example, a terminal may receive such a screen, check its format, store the screen only if it is in an authorized format (or pre-approved), and then display such a screen thereafter (e.g., when a display unit is turned ON in response to a single UI_{THEN}). Alternatively, a terminal may receive such a screen when a display unit is turned ON, check its format (or whether or not pre-approved), and display such a screen only if it is in an authorized format (or pre-approved). When the screen is not in the authorized format (or not pre-approved), an O/S or an application may completely block displaying such a screen. Alternatively, an O/S or an application may conditionally block such a screen such as, e.g., displaying the screen but completely preventing a user from reacting thereto, displaying the screen for only a short period of time, displaying only a portion of the screen, and the like. The O/S or application may also be arranged to display such a screen based upon a difference between its format and an authorized format. In addition, a terminal may select an extent of blocking based on circumstances such that a terminal may employ various extents of blockings such as, e.g., a total blocking, a conditional blocking, an intermediate blocking based on a “pass” or a “fail” of an “authenticating,” and the like.

In another example of the exemplary software embodiment of this seventh objective, a (software) application which is installed to a terminal and displays an advertisement screen or a content screen may be operatively sequestered or isolated from a library or a memory of a terminal. Therefore, the terminal may be able to deny all request from such an application to access the library or memory, thereby guaranteeing absolute security to data stored in the terminal. Because such an application is sequestered, a user may access an external link, download files from an external source, or run another application through the external link or source, without compromising the security to those data, as far as such external source or link cannot access the library or memory of the terminal. When desirable, a terminal may also select extents of access denial depending upon circumstances such that a terminal may employ various extents of blockings such as, e.g., a total blocking, a conditional blocking or a blocking based on a “pass” or a “fail” of the “authenticating.”

In another example of the exemplary software embodiment of this seventh objective, a terminal may also include any (software) applications as exemplified throughout this disclosure, but an O/S may provide such an application with “Result” such as, e.g., a “pass” or a “fail” from an authentication operation. Based thereon, an application may display the same or different screens on a display unit. It is noted that such an application may be designed to passively or unilaterally receive “Result” from an O/S, but may not be designed enough to actively or bilaterally interact with the O/S. Accordingly, the O/S may easily deny the application from accessing a library or memory of the terminal. When desirable, the terminal may unilaterally provide such an application with additional data from the library or memory only when they are required to execute some steps or operations. In addition, the terminal may allow such an application to access a limited portion of the library or memory when desirable. Even in such a case, the terminal may not allow such an application to actively access data stored in the library or memory of the terminal without an approval from a user, an O/S, and the like.

In another exemplary embodiment of this seventh objective, a terminal may ensure an enhanced security in advertising and authenticating, primarily focusing on its hardware configuration or operation. In one example, a terminal may include a sequestered or separate memory in which a (software) application for displaying the advertisement or content screen is downloaded but completely or conditionally blocked from accessing a memory or a library of a terminal. In other words, a user may access an external link through the application stored in the separate memory, or may download files onto the separate memory. Whatever applications may be executed in such a separate memory, however, a terminal ensures that whatever resides in the separate memory cannot access a main memory or a main library of the terminal, thereby securing the data stored in the main memory or library.

In another example of the exemplary hardware embodiment of this seventh objective, a terminal may include a separate input unit which is designated to receive (i.e., acquire) a user input and (user) sub-input such as, e.g., an auxiliary (user) sub-input (UI_{AUX}). Upon receiving UI_{AUX} with a separate input unit, a terminal may run an application for displaying the advertisement or content screen. Thereafter, the terminal may completely or conditionally block such an application from accessing an external link, from downloading files, and the like. The terminal may also include the aforementioned separate memory and may optionally and operatively link the separate input unit with the separate or sequestered memory.

It is appreciated that various software embodiments as well as hardware embodiments of this seventh objective may be incorporated into the terminals of the above first through sixth objectives as well as other aspects and embodiments of this disclosure. Accordingly, the terminals of this seventh objective may provide not only secure operations in advertising but also seamless operations in user authentication. As a result, such terminals can secure personal data stored therein by completely or conditionally blocking the user from accessing the data from the advertisement or content screen or from external websites, external links or files downloadable from such websites or links. Other hardware or software features of such terminals of this seventh objective and their operational features may be identical or similar to those of the terminals of the first through sixth objective when applicable.

The eighth objective of various terminals of this disclosure is to provide a user with both of seamless and secure operations of advertising and multiple authentication operations, where such terminals provide a user with more options or depths as the user passes more authentication operations. A terminal may receive (i.e., acquire) at least two user inputs (e.g., UI₁ and UI₂) as well as at least two (user) sub-inputs (e.g., UI_{THEN1} and UI_{THEN2}), where a terminal is activated upon (or after) receiving the first user input (UI₁) and a first (user) sub-input included therein (e.g., UI_{ACT}), where the terminal may optionally turn ON its display unit upon (or after) receiving UI₁ and UI_{ACT}, and where a display unit displays thereon at least one advertisement or content screen. The terminal also runs at least two authentication operations in response thereto, and execute at least two “determining steps” in response thereto as well. It is appreciated that multiple user inputs and (user) sub-inputs may be of the same, similar or different types, where the multiple authentication operations may be of the same, similar or different types each requiring a corresponding user input and at least one (user) sub-input as well. More particularly, the terminal may provide a user with more options or more depths as the user passes more authentication operations, while optimizing its sequence of performing such operations or steps such that the user proceeds to a unlock state with only a minimum number of UI_{THEN}, while securing the data stored in the terminal from being accessed by an unauthorized user, unauthorized application or unauthorized server.

In one exemplary embodiment of this eighth objective, a terminal may execute various operations (or steps) as described above according to one of the following sequences when a terminal may receive (i.e., acquire) a single first user input (UI₁) or a single first (user) sub-input such as, e.g., UI_{THEN1}, provided by a user to a terminal while its display unit was (or has been) turned OFF. In one example, such a terminal may turn ON a display unit and display at least one advertisement screen and/or content screen thereon, then “run at least one 1^{st} authenticating,” and then “execute the 1^{st} determining,” all in response to a single UI₁ or UI_{THEN1}. In another example, a terminal may turn ON its display unit and display the advertisement or content screen, “run the 1^{st} authenticating” concurrently with such “turn ON,” and then “execute the 1^{st} determining,” all in response to a single UI_{THEN1} or UI₁. In another example, a terminal may “run the 1^{st} authenticating,” then turn ON its display unit and display such a screen, and then “execute such 1^{st} determining,” all in response to a single UI₁ or UI_{THEN1}. In another example, a terminal may “run the 1^{st} authenticating,” then turn on a display unit and display such a screen, and “executes the 1^{st} determining” concurrently with such “turn ON,” all in response to a single UI₁ or UI_{THEN1}. In yet another example, a terminal may “run the 1^{st} authenticating,” then “execute the 1^{st} determining,” then turn ON a display unit and display such a screen, all in response to a single UI₁ or UI_{THEN1}.

When a terminal is arranged to run the 2^{nd} authentication operation and to execute at least one step of the 2^{nd} “determining steps,” the terminal may incorporate the 2^{nd} authentication operation and 2^{nd} determining steps into those sequences of operations or steps as described in the previous paragraph. For simplicity of illustration, “run at least one 1^{st} authentication operation” is to be referred to as “run the 1^{st} authenticating,” “run at least one 2^{nd} authentication operation” is referred to as “run the 2^{nd} authenticating,” “executing at least one step of the 1^{st} ‘determining steps’” is referred to as “execute the 1^{st} determining,” “executing at least one step of the 2^{nd} ‘determining steps’” is referred to as “execute the 2^{nd} determining,” and the like. By definition, it is to be appreciated that a terminal runs “the 1^{st} authenticating” prior to or concurrently with “running the 2^{nd} authenticating,” that a terminal “executes the 1^{st} determining” after “running the 1^{st} authenticating,” and that a terminal “executes the 2^{nd} determining” after “running the 2^{nd} authenticating.” However, it is also appreciated that a terminal “executes the 2^{nd} determining” after “the 1^{st} determining” but that a terminal may also “execute the 1^{st} determining” after, concurrently with or before “executing the 2^{nd} determining,” depending on detailed characteristics of sequences of operations or steps.

For example, a terminal may “run the 1^{st} authenticating,” then “execute the 1^{st} determining,” and then take a user to a 1^{st} unlock state when the user passes the 1^{st} authenticating. Thereafter, a terminal may run “the 2^{nd} authenticating,” then “execute the 2^{nd} determining,” and then take a user to a 2^{nd} unlock state when the user also passes the 2^{nd} authenticating. Of course a user may access more data and/or a terminal may provide a user with more options in running more operations in the 2^{nd} unlock state than the 1^{st} unlock state. In another example, a terminal may “run the 1^{st} and 2^{nd} authenticating” sequentially or concurrently, and “execute the 1^{st} and 2^{nd} determining” in any proper sequence. Based on the results from such 1^{st} and 2^{nd} authenticating, such a terminal may display different screens, allow a user to access different amount of data stored in a terminal, or allow a user to run different operations, and the like. Such “1^{st} and 2^{nd} authenticating” and/or such “1^{st} and 2^{nd} determining” may be combined with or incorporated into the sequences, their operations or steps which have been described throughout this disclosure in conjunction with a single authenticating and determining, as will be described in greater detail below.

When desirable, the “1^{st} authenticating” may require a fingerprint of a user, while the “2^{nd} authenticating” may require a fingerprint of a different part of the same finger of the user, a fingerprint of a different finger of the user, a fingerprint of a finger of a business partner or a soul-mate of the user, and the like. In addition, such “1^{st} and 2^{nd} authenticating” may utilize any biometric information of the user or another person or may also use any non-user information such as, e.g., a password or a pass code, as have been described above and as will be explained below. Accordingly, such “1^{st} and 2^{nd} authenticating” may employ various authentication (user) sub-inputs, UI_{THEN}, as long as such sub-inputs may identify a user or may be selected by a user as he or she sees fit, regardless of accuracy or reliability of such sub-inputs.

Such a terminal may “run the 1^{st} and 2^{nd} authenticating” either sequentially or concurrently, while receiving (i.e., acquiring) UI_{THEN1} and UI_{THEN2} either sequentially or concurrently. It is appreciated that a terminal may neither “run the 2^{nd} authenticating” nor receive UI_{THEN2} when a user fails the 1^{st} authenticating. In a sequence where an advertisement or content screen requires a user to provide an auxiliary (user) sub-input, UI_{AUX} or to perform an active or passive task, a terminal may obtain “Result₁” from the 1^{st} authenticating and optionally obtain “Result₂” from the 2^{nd} authenticating. The terminal may then use both “Result₁,” and “Result₂,” or may use “Result₁,” and then “Result₂” only when a user passes the 1^{st} authenticating. Even when a terminal uses both “Result₁,” and “Result₂,” such a terminal may use “Result₁,” and “Result₂” (or vice versa) concurrently or sequentially.

It is noted that various terminals of this eighth objective provide a user with seamless and secure operations of advertising and authenticating. Therefore, an exemplary terminal of this eighth objective may be arranged to “run the 1^{st} authenticating” when a user actively provides his or her UI_{THEN1} (i.e., through an active action of a user or an action of a volition of a user), and then to “run the 2^{nd} authenticating” not necessarily with the active action of the user.

A terminal may embody this exemplary feature by acquiring at least one biometric information of a user such as, e.g., an image of an iris or retina, an image of an ear, a face or a head, an image of a hand or a wrist, a voice, a movement of at least one body part, a number or a pattern of the movement, a direction or a period of such movement, a combination of at least two of the above, and the like. A terminal may also embody this exemplary feature by acquiring at least one non-biometric information of a user such as, e.g., a movement of at least a portion of a terminal, a number or pattern of the movement, a direction or period of the movement, an image of an environment, a brightness of an environment, an environmental sound, a signal or a beacon from a certain object (e.g., a device in a network of IoT, i.e., an internet of things), a signal or a beacon from a wearable device worn by a user or another person, a signal or a beacon from a (software) application or an O/S of a terminal, a combination of at least two of the above, and the like.

Accordingly, the terminal may acquire the 2^{nd} (user) sub-input (UI_{THEN2}) on its own while a user is operating a terminal, without requiring a user to stare at an input unit of a terminal, to talk to a microphone of a terminal, to move his or her body according to a preset pattern, to record an image or a sound of an environment, and the like. Through this feature, a user may be able to provide a single UI_{THEN1} for the 1^{st} authenticating, while a terminal then acquires UI_{THEN2} required for the 2^{nd} authenticating on its own (i.e., without requesting a user to provide the above), whereby the terminal provides the user with both of seamless and secure operations of advertising while multiple authentication operations.

Another exemplary terminal of this eighth objective may “run the 1^{st} authenticating” as a user provides his or her UI_{THEN1} actively as described above, and then “run the 2^{nd} authenticating” as the user actively provides UI_{THEN2}. Although this arrangement is a bit cumbersome to a user than the arrangement in the preceding paragraph, this arrangement ensures that the user intends to get to the 2^{nd} unlock state when UI_{THEN2} is provided to the terminal.

The ninth objective of various terminals of this disclosure is to provide methods with which various terminals can seamlessly authenticate a user.

In one exemplary method of this ninth objective, a mobile communication terminal seamlessly authenticates a user by a method which may include the steps of: running a first authentication operation by authenticating a first biometric information of the user while the terminal is in a lock state; keeping the terminal in the lock state when the user fails the first authentication operation; switching the terminal from the lock state to an unlock state when the user passes the first authentication operation; running a second authentication operation by authenticating a second biometric information of the user one of immediately before, concurrently with, and immediately after the switching, without receiving an additional user input and without acquiring an additional user sub-input except acquiring from the user the second biometric information; and running one of a third operation and a fourth operation when the user passes and fails the second authentication operation, respectively, where the third and fourth operations are different from each other.

The step of running the first authentication operation may include the steps of: acquiring the first biometric information while the terminal is in the lock state; and starting to run the first authentication operation upon the acquiring. The step of acquiring the first information may include at least one of the steps of: acquiring the first information related to a first fingerprint of the user; acquiring the first information related to one of an iris and a retina of the user; acquiring the first information related to a face of the user; acquiring the first information related to a voice of the user, and the like. When the terminal includes a fingerprint sensor, the step of acquiring the first information about the first fingerprint may include at least one of the steps of: acquiring the first information with the sensor implemented on a front surface of the terminal; acquiring the first information with the sensor implemented on a side of the terminal; and acquiring the first information with the sensor implemented on a bottom surface of the terminal. When the terminal includes a display unit, the step of keeping the terminal in the lock state may include one of the steps of: keeping the display unit completely turned off; keeping the display unit turned off but displaying routine data thereon; and keeping the display unit turned off and stopping to display routine data which have been displayed thereon. When the terminal includes a display unit, the step of switching the terminal from the lock state to the unlock state may include one of the steps of: turning on the display unit concurrently with obtaining the first biometric information; turning on the display unit immediately after obtaining the first biometric information; and turning on the display unit only when that the user passes the first authentication operation. The step of running the second authentication operation may include one of the steps of: acquiring the second biometric information concurrently with acquiring the first information; acquiring the second biometric information immediately after acquiring the first information; acquiring the second biometric information concurrently with the switching; and acquiring the second biometric information immediately before running the second authentication operation. The step of acquiring the second information may include at least one of the steps of: acquiring the second information related to a second fingerprint of the user; acquiring the second information related to one of an iris and a retina of the user; acquiring the second information related to a face of the user; and acquiring the second information related to a voice of the user. The fourth operation may perform at least one function which the third operation does not perform. Alternatively, the fourth operation may perform at least one function which the third operation is not capable of performing. The fourth operation may include keeping the terminal in the unlock state but not running any additional operation.

In another exemplary method of this ninth objective, a mobile communication terminal includes at least one display unit and seamlessly authenticates a user by a method which may include the steps of: receiving a first user input and turning on the display unit in response to the receiving; running a first authentication operation by authenticating a first biometric information acquired from the first user input while the terminal is in a lock state; keeping the terminal in the lock state when the user fails the first authentication operation; switching the terminal from the lock state to an unlock state when the user passes the first authentication operation; running a second authentication operation by authenticating second biometric information of the user one of immediately before, concurrently with, and immediately after the switching, without receiving an additional user input and without acquiring an additional user sub-input except acquiring from the user the second biometric information; and running one of a third operation and a fourth operation when the user respectively passes and fails the second authentication operation, where the third and fourth operations are different from each other.

The step of running the first authentication operation may include one of the steps of: acquiring the first biometric information immediately before the turning on; acquiring the first biometric information concurrently with the turning on; and acquiring the first biometric information immediately after the turning on. The step of acquiring the first information may include at least one of the steps of: acquiring the first information related to a first fingerprint of the user; acquiring the first information related to one of an iris and a retina of the user; acquiring the first information related to a face of the user; and acquiring the first information related to a voice of the user. The step of running the second authentication operation may include one of the steps of: acquiring the second information concurrently with acquiring the first biometric information; acquiring the second information immediately after acquiring the first biometric information; acquiring the second information concurrently with the switching; acquiring the second information immediately after the switching; and acquiring the second information immediately before running the second authentication operation. The step of acquiring the second information may include at least one of the steps of: acquiring the second information related to a second fingerprint of the user; acquiring the second information related to one of an iris and a retina of the user; acquiring the second information related to a face of the user; and acquiring the second information related to a voice of the user. The fourth operation may include keeping the terminal in the unlock state but not running any additional operation.

In another exemplary method of this ninth objective, a mobile communication terminal may seamlessly authenticate a user by a method which may include the steps of: obtaining a first biometric information of the user while the terminal is in a lock state; obtaining a second biometric information of the user while the terminal is in a lock state, wherein the obtaining the second information is one of immediately before, concurrently with, and immediately after the obtaining the first information; running a first authentication operation by authenticating the first biometric information; running a second authentication operation different from the first operation by authenticating the second information one of immediately before, concurrently with, and immediately after the running the first authentication operation; keeping the terminal in the lock state when the user fails the first authentication operation; switching the terminal from the lock state to an unlock state when the user passes the first authentication operation; and running a third operation when the user passes both of the first authentication operation and the second authentication operation.

When the terminal includes at least one display unit, the step of running the first authentication operation may include one of the steps of: acquiring the first biometric information immediately before turning on the display unit; acquiring the first biometric information concurrently with turning on the display unit; and acquiring the first biometric information immediately after turning on the display unit. The step of acquiring the first information comprises at least one of the steps of: acquiring the first information related to a first fingerprint of the user; acquiring the first information related to one of an iris and a retina of the user; acquiring the first information related to a face of the user; and acquiring the first information related to a voice of the user, and wherein the acquiring the second information comprises the step of acquiring the second information which is different from the first information.

Various mobile communication terminals have been illustrated to provide the user with seamless and secure operations of advertising and authentication operations. More particularly, various exemplary embodiments and their examples of such terminals have been provided to explain their structural characteristics as well as their operational benefits. It is however appreciated that such terminals may further be embodied and may be manufactured or used in other exemplary embodiments and their examples as will be described below.

Unless otherwise defined in this specification, all technical and scientific terms used herein have the same meaning as commonly understood by one of ordinary skill in the art to which various mobile communication terminals, methods of manufacturing and using such terminals, and sequences used in which such terminals and methods belong. Although various other structures, methods, and sequences equivalent or similar to those described throughout this disclosure may be used in practicing and/or testing such terminals, methods, and sequences, suitable structures, methods, and sequences are to be described below. All publications, patent applications, patents or other references mentioned herein are incorporated by reference in their entirety. In case of any conflict, this disclosure, including definitions as provided above, will control. In addition, the structures, methods, and sequences are only illustrative and not intended to be limiting.

### BRIEF DESCRIPTION OF THE DRAWINGS

FIGS. 1A to 1I are schematic drawings exemplifying various modes of displaying one or more screens on a display surface of a display unit of various mobile communication terminals throughout this disclosure;

FIGS. 2A to 2C are block diagrams illustrating various embodiments of the first exemplary aspect of various terminals, methods, and operation sequences of this disclosure;

FIGS. 3A to 3C are block diagrams illustrating various embodiments of the second exemplary aspect of various terminals, methods, and operation sequences of this disclosure;

FIGS. 4A to 4C are block diagrams illustrating various embodiments of the third exemplary aspect of various terminals, methods, and operation sequences of this disclosure;

FIGS. 5A and 5B are to block diagrams illustrating various embodiments of the fourth exemplary aspect of various terminals, methods, and operation sequences of this disclosure;

FIG. 6 is a block diagram illustrating an exemplary embodiment of the fifth exemplary aspect of various terminals, methods, and operation sequences of this disclosure;

FIGS. 7A and 7B are block diagrams illustrating various embodiments of the sixth exemplary aspect of various terminals, methods, and operation sequences of this disclosure;

FIGS. 8A to 8D represent block diagrams illustrating various embodiments of the seventh exemplary aspect of various terminals, methods, and operation sequences of this disclosure;

FIGS. 9A to 9D represent block diagrams illustrating various embodiments of the eighth exemplary aspect of various terminals, methods, and operation sequences of this disclosure;

FIGS. 10A to 10D show block diagrams illustrating various embodiments of the ninth exemplary aspect of various terminals, methods, and operation sequences of this disclosure;

FIGS. 11A and 11B illustrate a schematic external appearance of an exemplary mobile communication terminal of this disclosure; and

FIG. 12 is a block diagram illustrating an exemplary embodiment of a service providing server of the twelfth aspect of this disclosure.

### DETAILED DESCRIPTION OF THE INVENTION

This disclosure relates to structures and software sequences of mobile communication terminals which allow users to experience seamless operations in an environment of enhanced security. Also described throughout this disclosure includes various methods of manufacturing and using such terminals.

More particularly, each terminal illustrated in this disclosure authenticates a current user and displays at least one advertisement screen and/or content screen, all in response to a single authentication (user) sub-input. Therefore, one exemplary terminal receives a single user sub-input from a user, displays such a screen in its lock state, allows a user to react to the screen by providing at least one auxiliary (user) sub-input or performing a task thereto, and then switch to its unlock state after running an authentication operation based on such a single authentication (user) sub-input. In other words, a terminal can seamlessly run all of such operations and steps in response to the single authentication (user) sub-input, i.e., without requiring the user to provide any additional authentication (user) sub-input after the user reacts to the advertisement or content screen. Other exemplary terminals of this disclosure may also run the above operations or steps in response to a single authentication (user) sub-input, but based upon different arrangements or sequences of the above operations or steps. This disclosure also relates to methods of running various operations or steps for executing at least a portion of an operating system (O/S) or at least one application of a terminal while ensuring such seamless and secure operations, methods of manufacturing and using such terminals, and methods of operating such terminals in various sequences of execution of the O/S or application when the terminals employ multiple authentication operations.

Exemplary aspects and embodiments of mobile communication terminals for providing seamless operations in an environment of enhanced security, methods of making or using such terminals, and software processes or sequences to be embedded in such terminals will now be described, more particularly, with reference to accompanying drawings and text, where such exemplary aspects and embodiments only represent different forms. Such terminals, methods, processes, and/or sequences throughout this disclosure, however, may be embodied in many other different structures, methods, process, and sequences such that they should not be limited to the exemplary aspects and embodiments as set forth herein. Rather, such exemplary aspects and embodiments described herein are provided so that this disclosure will be thorough and complete, and fully convey the scope of such terminals, methods, processes or sequences of this disclosure to one of ordinary skill in the relevant art.

It is to be understood that, unless otherwise specified, various members, units, elements, and parts of such terminals throughout this disclosure are not typically drawn to scales or proportions for ease of illustration. It is also noted that such members, units, elements, and parts of the terminals as well as operations, steps, and sequences throughout this disclosure which are designated by the same numerals may represent the same, similar or functional equivalent members, units, elements, parts, operations, steps, and sequences, respectively.

It is appreciated that exemplary aspects and embodiments of such mobile communication terminals of this disclosure, although different, are not necessarily mutually exclusive. That is, a particular feature, structure, operation, function, method, sequence or characteristic of such terminals described herein in connection with one exemplary aspect and/or embodiment may also be implemented into another aspect and/or embodiment of this disclosure, without departing from a spirit and a scope of such terminals of this disclosure, within an extent where they may not conflict each other, and the like. It is also appreciated that an arrangement and a position of each member, unit, element or part of exemplary aspects or embodiments of this disclosure may vary without departing from a spirit and scope of other exemplary terminals of this disclosure. Therefore, the following detailed description is not to be taken to limit the scope of various terminals capable of providing seamless operations in an environment of enhanced security. Rather, the scope of such terminals, methods, processes, and sequences are defined only by appended claims that should be appropriately interpreted in a full range of equivalents to which such claims are entitled. In the drawings, like reference numerals identify like or similar elements or functions through the several views.

Hereinafter, exemplary aspects and embodiments of mobile communication terminals of this disclosure will be explained in detail in both hardware and software perspectives and with reference to the accompanying drawings so that those skilled in the art can easily practice such terminals, such methods of manufacturing and using those terminals, and such sequences of various operations and steps for such terminals as well as related methods thereof. Related features and advantages of the mobile communication terminals, methods, and sequences of this disclosure will also be apparent from the following description, and from the claims.

In the first exemplary aspect of this disclosure, a mobile communication terminal may receive (i.e., acquire) a single authentication (user) sub-input, UI_{THEN} along with at least one activation (user) sub-input (UI_{ACT}) while its display unit was (or has been) in its OFF state. Upon (of after) receiving UI_{ACT}, the terminal activates itself. In addition, upon (or after) receiving a single UI_{THEN}, the terminal “runs at least one authentication operation” (i.e., “runs the authenticating”) based on such UI_{THEN} (or other information accompanied thereby), executes at least one step of the “determining steps” (referred to as “executes the determining”), and displays at least one screen on its display unit in various sequences, all in response to a single UI_{THEN}.

A user may apply a single user input (UI) to a single input unit, where UI includes therein an activation (user) sub-input (UI_{ACT}) and an authentication (user) sub-input (UI_{THEN}) in order to activate the terminal and to “run the authenticating,” respectively. Because the terminal acquires (i.e., receives) UI_{ACT} and UI_{THEN} concurrently, such a terminal may activate itself in response to UI_{ACT} and concurrently turn ON its display unit in response to UI_{THEN}.

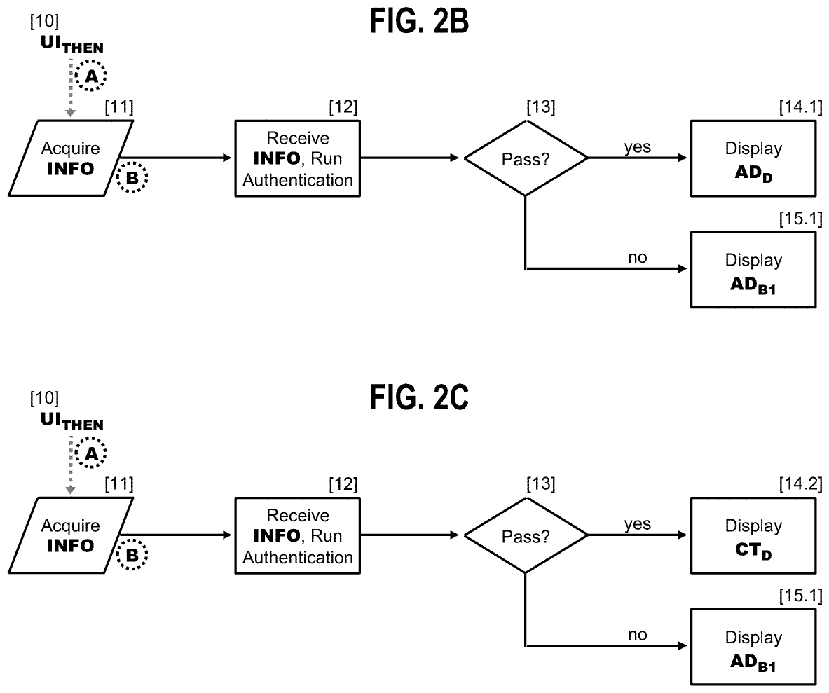

In the alternative, a user may apply at least two user inputs (UI₁ and UI₂) to at least two input units, where UI₁ includes UI_{ACT} therein and where UI₂ includes therein UI_{THEN}. When the user provides such UI_{ACT} and UI_{THEN} concurrently to two different input units, a terminal may activate itself in response to UI_{ACT} and concurrently turn ON its display unit in response to UI_{THEN}. However, when the user provides UI_{ACT} and UI_{THEN} to a single or multiple input units sequentially, the terminal may turn ON its display unit and display at least one screen at different timings such as, e.g., after (or concurrently with) receiving UI_{ACT} or UI_{THEN}, after (or currently with) “running the authenticating,” after (or concurrently with) executing the determining,” and the like. FIGS. 2A to 2C are block diagrams illustrating various embodiments of this first exemplary aspect of various terminals, methods, and operation sequences of this disclosure.

FIG. 2A shows a block diagram of one exemplary embodiment of the first aspect of this disclosure, where a terminal receives (i.e., acquires) a single authentication (user) sub-input (UI_{THEN}) while a display unit is in its OFF state (e.g., step [11]), where such a single UI_{THEN} may be accompanied by an activation (user) sub-input (UI_{ACT}) or may serve as UI_{ACT}. Based thereon, the terminal may “run at least one authentication operation” (i.e., “run the authenticating” of the step [12]), and may then display a “pass screen (SC_{PASS})” or a “fail screen (SC_{FAIL})” on a display surface of the display unit when the user passes or fails “the authentication operation” (i.e., the “authenticating”), respectively. Therefore, such a terminal provides a user with a seamless operation, for the user can proceed to an unlock state of the terminal simply by providing the single UI_{THEN} (and when the user also passes the “authenticating”).

It is appreciated that “information (abbreviated as “INFO”) as used throughout this disclosure is synonymous with authentication information, with other information accompanied by and/or extracted from UI_{THEN}, and the like. In this regard, such “information” may refer to various biometric or non-biometric information required to run at least one authentication operation, where examples of such “biometric or non-biometric information” have been enumerated above.

The fail screen (SC_{FAIL}) of the step [15] may include therein or correspond to a basic content (CT_{B1}), a basic advertisement (AD_{B1}), a warning to notify that a user failed the authenticating, an instruction to a user to retry the authenticating, and the like. SC_{FAIL} may be or include a lock screen which may optionally include at least one of various basic contents (CT_{B1}, CT_{B0}, and the like) or basic advertisements (AD_{B1} or AD_{B0}, and the like).

As used herein, a “basic advertisement (AD_{B})” may refer to a non-directed advertisement, a non-detailed advertisement or a non-personal advertisement, all in the user's perspective. A “basic advertisement (AD_{B})” may be classified into, e.g., AD_{B0}, AD_{B1}, AD_{B2}, and the like, where the subscripts B0, B1, and B2 denote degrees of being directed, detailed or personalized (i.e., customized) for a user. It then follows that a “basic advertisement, AD_{B0},” is less directed, detailed or personal to a user than “other basic advertisements such as AD_{B1} and AD_{B2},” and that the “basic advertisement, AD_{B1}” is less directed, detailed or personal to a user than the “basic advertisement, AD_{B2}.” It is noted, however, that the “basic advertisement, AD_{B} (i.e., AD_{B2}, AD_{B1} or AD_{B0})” is generally less directed, less detailed or less personal than a “directed advertisement, AD_{D}” as will be explained below. Therefore, the “basic advertisement, AD_{B}” is typically not based on any of various personal information such as, e.g., a current or previous location of a user, an activity of a user, a preference of a user, a trait of a user, a setting selected by a user, and the like.

As will be described in greater detail below, such “basic advertisement, AD_{B} (e.g., AD_{B2}, AD_{B1}, or AD_{B0})” is usually displayed on a display unit when a terminal is in a lock state. In addition, the “basic advertisement AD_{B}” may require a user to react thereto for proceeding to a next operation (or step) for using a terminal. In the alternative, AD_{B} may require only a minimal reaction thereto for such proceeding, may not require any reaction thereto for such proceeding, and the like, where a user reaction to AD_{B} may be accomplished when the user provides at least one “auxiliary (user) sub-input, UI_{AUX}” to an input unit, to another part of a terminal, to AD_{B} itself (i.e., to a display unit displaying a screen with AD_{B}), and the like.

Compared with the above “basic advertisement, AD_{B},” a “directed (or detailed) advertisement (AD_{D})” refers to a directed, detailed or personal advertisement, all in the user's perspective. A “directed advertisement, AD_{D}” may also be classified into, e.g., AD_{D0}, AD_{D1}, AD_{D2}, and the like, where the subscripts D0, D1, and D2 denote degrees of being directed, detailed or personal (e.g., customized) for a user. Thus, a “directed advertisement, AD_{D2}” is more directed, detailed or personal to a user than “other directed advertisements such as AD_{D1} and AD_{D0},” while a “directed advertisement, AD_{D1}” is more directed, detailed or personal to a user than a “directed advertisement, AD_{D0}.” It is noted that the “directed advertisement, AD_{D} (i.e., AD_{D2}, AD_{D1} or AD_{D0})” is typically more directed, more detailed or more personal than any “basic advertisement, AD_{B}.” Therefore, the “directed advertisement, AD_{D}” may typically be based on any of various personal information such as, e.g., a current or previous location of a user, an activity of a user, a preference of a user, a trait of a user, a setting selected by a user, and the like.

The “directed advertisement, AD_{D}” is usually displayed on a display unit when a terminal is in an unlock state. In addition, the “directed advertisement AD_{D} (e.g., AD_{D2}, AD_{D1}, or AD_{D0})” may require a user to react thereto for proceeding to a next operation (or step) for using a terminal, where the “directed advertisement, AD_{D2}” may require a full or more active reaction thereto than AD_{D1} or AD_{D0}. Alternatively, AD_{D} may require only a minimal reaction thereto for such proceeding, may not require any reaction thereto for such proceeding, and the like, where a user reaction to AD_{D} may be accomplished (i.e., done or finished) when a user provides at least one “UI_{AUX}” to an input unit, to another part of a terminal, to AD_{D} itself (i.e., to a display unit displaying a screen with AD_{D}), and the like.

It is appreciated that both of the “basic advertisement, AD_{B}” and the “directed advertisement, AD_{D}” generally relate to a certain product, service, event, person, company, location, and the like, where each of such may be supported by a sponsor. Accordingly, a terminal may display the advertisements in such a way that both of AD_{B} and AD_{D} relate to the same product or event, that AD_{B} relates to a first product but AD_{D} relates to a second product, that AD_{B} relates to a first product but AD_{D} relates to a first location, and the like.

As used herein, a “basic content (CT_{B})” refers to a non-directed or non-detailed content or a non-personal content, all in the perspective of a user. A “basic content, CT_{B}” may be classified into, e.g., CT_{B0}, CT_{B1}, CT_{B2}, and so on, where the subscripts B0, B1, and B2 are similar to those of the basic advertisements, AD_{B}. Thus, a “basic content, CT_{B0}” is less directed, detailed, and/or personal to a user than “other basic contents such as CT_{B1} and CT_{B2},” and that the “basic content, CT_{B1}” is less directed, detailed, and/or personal to a user than the “basic content, CT_{B2}.” It is appreciated, however, that the “basic content, CT_{B} (i.e., CT_{B2}, CT_{B1} or CT_{B0})” is generally less directed, less detailed, and/or less personal than a “directed content, CM” as will be explained below. Accordingly, the “basic content, CT_{B}” may typically be not based on any of various personal information such as, e.g., a current or previous location of a user, a preference of a user, a trait of a user, a setting selected by a user, and the like.

As will be described in greater detail below, such a “basic content, CT_{B}” is usually displayed on a display unit when a terminal is in a lock state. The “basic content CT_{B} (e.g., CT_{B2}, CT_{B1}, or CT_{B0})” may also require a user to react thereto for proceeding to a next operation using a terminal. Alternatively, CT_{B} may require only a minimal reaction thereto for such proceeding, may not require any reaction thereto for such proceeding, and the like, where a user reaction to CT_{B} may be finished when the user provides at least one “UI_{AUX}” to an input unit, to another part of a terminal, to CT_{B} itself (i.e., to a display unit displaying a screen with CT_{B}), and the like.

Compared with the “basic content (CT_{B}),” a “directed (or detailed) content (CT_{D})” refers to a directed, detailed or a personal content, all in the user's perspective. A “directed content, CT_{D}” may also be classified into, e.g., CT_{D0}, CT_{D1}, CT_{D2}, and the like, where the subscripts D0, D1, and D2 are similar to those of the “directed advertisement, AD_{D}.” Accordingly, a “directed content, CT_{D2}” is more directed, detailed or personal to a user than “other directed contents such as CT_{D1} and CT_{D0},” and a “directed content, CT_{D1}” is more directed, detailed or personal to a user than a “directed content, CT_{D0}.” In general, a “directed content, CT_{D} (i.e., CT_{D2}, CT_{D1} or CT_{D0})” is more directed, detailed or personal than any “basic content, CT_{B}.” Therefore, the “directed content, CT_{D}” may typically be based on at least one of various personal information such as, e.g., a current or previous location of a user, a preference of a user, a trait of a user, a setting selected by a user, and the like.

The “directed content, CT_{D} (e.g., CT_{D2}, CT_{D1} or CT_{D0})” is usually displayed on a display unit when a terminal is in an unlock state. The “directed content CT_{D}” may also require a user to react thereto for proceeding to a next operation (or step) for using a terminal, where the “directed content, CT_{D2}” may require a full or more active reaction thereto than CT_{D1} or CT_{D0}. Similarly, CT_{D} may require only a minimal reaction thereto for such proceeding, may not require any reaction thereto for such proceeding, and the like, where a reaction of a user to CT_{D} may usually be finished when the user provides at least one “UI_{AUX}” to an input unit, to another part of a terminal, to CT_{D} itself (i.e., to a display unit displaying a screen with CT_{D}), and the like.

It is appreciated that both of the “basic content, CT_{B}” and the “directed content, CT_{D}” may relate to a certain fact, opinion, expression, and the like, where each of such may be financially or otherwise supported by a sponsor. Accordingly, a terminal may display the contents in such a way that both of CT_{B} and CT_{D} relate to the same opinions, that CT_{B} relates to a first fact but CT_{D} relates to a second fact, that CT_{B} relates to a first fact but CT_{D} relates to a first opinion, and the like.

A terminal or user may run various operations after the step [15]. For example, a terminal may return to the step [11] and wait for a new authentication (user) sub-input, UI_{THEN2} from a user. Upon (or after) receiving such, the terminal may extract the authentication information from UI_{THEN2} and proceed to the step [12]. During this period, the terminal [A] may display the fail screen or [B] may turn its display unit OFF. In another example, a terminal may display an advertisement or content screen as the fail screen in its lock state, where such a screen requires a user to react thereto, e.g., by supplying UI_{AUX} or performing an active or passive task. After the user is finished with reacting to the screen, the terminal [A] may return to the step [11], [B] may keep a display unit in its ON state, [C] may switch a display unit to its OFF state, and the like, where the brackets “[ ]” mean that operations or steps following such brackets are alternatives to each other. In another example, a user may decline [A] to provide a new user input or sub-input, [B] to take any action for more than a certain period, and the like. A terminal may then [A-1, B-1] turn OFF the display unit or [A-2, B-2] display a different fail screen after a certain period, where the bracket “[A-1, B-1]” means that an operation or step following such brackets are sub-alternatives of those following [A] or [B]. In another example, a terminal may run at least one (predetermined) operation and, when running such an operation is completed, the terminal may [A] return to the step [11], [B] switch a display unit to its OFF state, [C] keep displaying a fail screen, and the like. Because such an operation is run in a lock state, the terminal may restrict a number or a type of such operations which the user may select.

Although not shown in the figure, the step [15] may be replaced by other operations. For example, a terminal [A] may display a fail screen for a certain period and then turn OFF a display unit, [B] may display a fail screen for a certain period and then display a lock screen or another screen, [C] may display a fail screen until a user provides UI_{AUX} or performs an active or passive task, and the like. The terminal may instead keep the display in its OFF state.

The pass screen (SC_{PASS}) of the step [14] may include therein or may correspond to a directed content (CT_{D}), a directed advertisement (AD_{D}), a basic content (CT_{B2}) or a directed advertisement (AD_{B2}). SC_{PASS} may also include or correspond to a home screen which optionally includes therein a detailed or basic content (CT_{D} or CT_{B2}), a detailed or basic advertisement (AD_{D} or AD_{B2}), and the like.

A terminal or user may run various operations after the step [14]. For example, like a prior art home screen, a pass screen (SC_{PASS}) may display icons or their equivalents so that a user may run different operations when touching, pressing or otherwise manipulating the icons. In another example, a terminal may [A] run at least one (predetermined) operation after a certain period or [B] display an advertisement or content screen as a pass screen in its unlock state, where such a screen may require a user to react thereto, e.g., by supplying UI_{AUX} or performing an active or passive task. After the user is done with reacting to the screen, a terminal may [A] display a home screen or [B] run the predetermined operation [B-1] after a certain period, [B-2] immediately after displaying SC_{PASS} or [B-3] without displaying any pass screen. In another example, a terminal may replace SC_{PASS} with a home screen or another screen [A] after a certain period, [B] when a user provides UI_{AUX}, and the like. In another example, a terminal turns OFF its display unit when a user does not provide another user input or sub-input within a certain period.

Although not depicted in FIG. 2A, the step [14] may be replaced by other operations or steps. For example, a terminal may [A] display SC_{PASS} indefinitely, [B] display SC_{PASS} for a certain period and then turn OFF its display unit, [C] turn a display unit OFF if a user does not provide any user input or sub-input in a certain period. In another example, a terminal may run a predetermined operation [A] after receiving another user input or sub-input, [B] after displaying SC_{PASS} for a certain period, [C] without displaying any pass screen at all, and the like.

In another example, when a user declines to take any action in a certain period, a terminal may [A] display SC_{PASS} indefinitely, [B] display SC_{PASS} for the certain period and then turn its display unit OFF, [C] display SC_{PASS} until a user provides another user input or sub-input, [D] run at least one (predetermined) operation immediately, [E] run such an operation after another certain period, and the like. Regardless of an action from a user, a terminal may [A] turn its display unit OFF in a certain period, [B] display a different SC_{PASS} after a certain period, and the like. In another example, a terminal may [A] run at least one predetermined operation and, after completing such “run,” display a home screen or another screen which results from such an operation, [B] turn OFF its display unit after a certain period, [C] keep displaying the same SC_{PASS} for at least a certain period, [D] display each of multiple SC_{PASS} in a preset sequence, and the like.

It is appreciated that a terminal or user may [A] pre-select which screen is to be displayed as SC_{PASS} or SC_{FAIL}, [B] pre-determine in which sequence multiple screens are to be displayed, [C] pre-select which (predetermined) operation is to be run after the steps [14] and/or [15], and the like. A terminal may also [A] display different SC_{PASS} or SC_{FAIL} according to various factors or [B] may run different operations according thereto, where examples such factors may include, but not limited to, a preference of a user, a user setting, a location of a user, a user destination, a time of the day, a season, a weather, an environment, a preference, a setting of a certain application, and the like.

A terminal may employ at least two identical, similar or different authentication operations in order to provide a user with different levels of security, thereby allowing the user to access different amounts of data stored in the terminal, providing the user to run different number of (software) applications downloaded to the terminal, allowing the user to run a single operation but with different options, and the like. That is, such a terminal allows a user to get to an unlock state when he or she passes at least one authentication operation, but the terminal may be deemed to provide the user with multiple unlock states in such a way that a user is provided with more directed, detailed or personal data to access to, more directed, detailed or personal operations to run or more options to select while running a certain operation, as the user passes more authentication operations.

Such a terminal [A] may not run the 2^{nd} authentication operation until a user provides the 2^{nd} authentication (user) sub-input (UI_{THEN2}) to the terminal, [B] may acquire UI_{THEN2} on its own, i.e., without requiring a user to voluntarily provide UI_{THEN2}, and the like. When the user passes the 2^{nd} authentication operation, the terminal may proceed to the 2^{nd} unlock state which is generally more directed, detailed or personal than the 1^{st} unlock state such that, e.g., a user may access more personal data, may reach a more secure operation level, may be given options to run more personal operations, and the like. When the user fails the 2^{nd} authentication operation, however, a terminal may wait for UI_{THEN2} to retry the 2^{nd} authentication operation. Such a terminal with multiple authentication operations may be viewed in such a way that some of the steps [11] to [13] are repeated in a certain sequence as well and, accordingly, such a terminal may be combined with such steps or other steps of FIG. 2A.

The terminal of FIG. 2A may also operate according to other arrangements or sequences which correspond to variations or modifications of the aforementioned arrangements.

In one example, a terminal may complete the steps [11], [12], and/or [13] within a certain period such that a user may enjoy seamless, secure, and speedy operations of the terminal. In another example, an O/S may directly perform the steps [14] or [15] or the O/S may cause at least one (software) application to run at least one application to perform the steps [14] or [15], where such an application may have been installed into the terminal before purchase by a user or a user has downloaded the application after purchase. When desirable, the steps [14] and [15] may be replaced by “running the 1^{st} and 2^{nd} operation,” respectively, with or without requiring a user to provide an additional UI_{AUX}.

In another example, a terminal may display SC_{DEF} concurrently with the step [11], immediately after the step [10] but before the step [11], and the like. Such SC_{DEF} may correspond to a lock screen, basic advertisement (AD_{B}) screens, basic content screens (CT_{B}), or other screens which may be pre-selected by the terminal or user, which may be randomly selected by the O/S or its (software) application, and the like.

In another example, when an advertisement or content screen requires a user to provide UI_{AUX} or to perform an active or passive task, such a screen may include a tab thereon with which the user may provide UI_{AUX} or perform such a task in order to proceed to a next step of operating the terminal. Such a feature is typically embodied where a display unit is a touch screen unit and such a tab may correspond to an authentication sensor. In this case, a terminal may run operations according to an alternative arrangement, where a user first provides UI_{ACT} to a terminal while its display unit was in its OFF state, the display unit is turned ON, and the display unit displays such a screen with the above tab. While reacting to such a screen, a user can provide UI_{THEN} to a terminal which then “runs the authenticating” and proceeds to the next step based on “Result” of such an operation.

The pass or fail screen may be a prior art unlock screen or lock screen, where such a screen may have been the screen which was pre-stored in a terminal and selected by a user, another screen which is generated by the terminal, and the like. The terminal may use any prior art displaying algorithms in such a way that [A] an O/S determines and displays a proper pass or fail screen, [B] an O/S may run at least one predetermined operation to determine and display a suitable pass or fails screen, and the like.

However, when the fail or pass screen includes an advertisement or content provided by an external source, some security concerns may arise because a bug intentionally impregnated therein may enter a main library or memory of a terminal, because a user may inadvertently download an infected file, or because a user may inadvertent make a link to an infected site, where each of such may degrade the security of a terminal, cause unintended loss of personal data stored in a terminal, and the like. Therefore, such security risks associated with displaying an advertisement screen or a content screen originating from an external source may have to be eradicated or at least mitigated. Various software and hardware approaches may be deployed in order to maintain enhanced security during such operations.

Therefore and in one exemplary embodiment, a terminal may be equipped with a software security means to guarantee not only seamless but also secure operations to a user. In one example of the software security means, a terminal includes at least one 1^{st} (software) application which has been installed by a manufacturer or a distributor before purchase by a user or which has downloaded by the user after purchase. In response to a single UI_{THEN}, the 1^{st} application may display an advertisement or content screen while completely or conditionally preventing the user [A] from linking an external source provided by such a screen, [B] from downloading any file from an external source or link provided by such a screen, [C] running any operation provided by or through such a link, and the like. Accordingly, the terminal may prevent any potential risk from such an external source or link. Such an example of this embodiment may be realized by employing a prior art file viewer, application viewer or passive viewer as the above 1^{st} (software) application.

In another example of such software security means, a terminal may incorporate at least one 2^{nd} (software) application which is incorporated into the terminal similar to the above 1^{st} application. In response to (or upon receiving) a single UI_{THEN}, the 2^{nd} application may display only those advertisement or content screens which are provided in an authorized format, while completely blocking displaying any other screens which do not conform to the authorized format. As a result, the terminal may prevent any potential risk associated with any non-conforming screens provided through an external source or external link. When desirable, the terminal may display an entire (or only a) portion of such non-conforming advertisement or content screens, while [A] preventing a user from reacting thereto at all, [B] allowing the user to react thereto only to a minimum extent, and the like.

In another example of such software security means, a terminal may incorporate at least one 3^{rd} (software) application which is incorporated into the terminal similar to the above 1^{st} application. However, the terminal may store the 3^{rd} application in a space which is sequestered or isolated from a main library or memory of the terminal so that the 3^{rd} application only allows the 3^{rd} application [A] to utilize those data stored in such a space but not those data stored in the library or memory, [B] to download a file from an external source or link only in such a space, [C] to access an external source or link only therefrom. In addition, the terminal denies any request from the 3rd application or others in such a space to access the main library or memory. Accordingly, regardless of what may happen in such an isolated space, the terminal may ensure the security of the main memory or library of the terminal. It is noted that the terminal may adjust an extent or a range of access denial to the main memory or library such that, e.g., the terminal may unconditionally or conditionally block any access to the main memory or library from such a space, may block such an access based upon whether or not the user passes or fails the authentication operation, and the like.

In another example of such software security means, a terminal may incorporate at least one 4th (software) application which may be incorporated into the terminal similar to the 1^{st} application. The 4^{th} application may be any of such 1^{st}, 2^{nd} or 3^{rd} (software) application or another application. The 4^{th} application may acquire “Result” from an O/S or another application installed in the terminal. Based on the “Result,” the 4th application may [A] display different screens (e.g., the basic or directed advertisement or content, default screen, lock screen or home screen), [B] display a certain screen for different periods, [C] turn OFF its display unit, and the like. When desirable, the terminal may display on such a screen “Result” such as, e.g., the authentication information, the “pass” or “fail,” other information (e.g., the user input or sub-input), and the like, depending on various criteria.

In another exemplary embodiment, a terminal may be equipped with at least one conventional programs or algorithms capable of coping with malware, spyware, virus, and the like, thereby guaranteeing a user with seamless as well as secure operations. In one example, a terminal may include an on-access scanner which may check whether or not any file downloaded through a content or advertisement screen is a legitimate file. When any file is identified as malware by the scanner, a terminal may block access to an external source or link. In another example, a terminal may include an anti-spyware program which may inspect contents of any file downloaded through the advertisement or content screen, either after such downloading is completed or during such downloading. Once the anti-spyware program identifies any file or entry which matches a known list of spyware, such a program may remove such spyware works, block activity of such works, and the like. In another example, a terminal may include an anti-subversion software which may block tampering of an O/S or applications of the terminal by an unauthorized subversion software through performing a static anti-subversion, a dynamic anti-subversion, and the like. In another example, a terminal may include an anti-virus software which may detect, prevent, and remove various malicious software by various means such as, e.g., a signature-based detection, heuristics, root-kit detection, a real-time protection, and the like, where details of such means are well known to one of ordinary skill in the relevant art.

In another exemplary embodiment, a terminal may be implemented with a hardware security means in order to guarantee not only seamless but also secure operations to a user of the terminal. In one example of the hardware security means, a terminal includes at least one sequestered (or isolated) memory therein, where the sequestered memory cannot access a main library or memory of a terminal without any approval from a user or terminal. In addition, when a user downloads any (software) application from an external source or link, such application may be stored only inside the sequestered memory, may run various operations or steps only inside the sequestered memory, and the like. The terminal may also provide limited data to the sequestered memory when desirable, but block the sequestered memory from accessing the main memory or library without an approval from the user or the O/S. It is appreciated that such a sequestered (or isolated) memory may be provided in a (main) memory or library of the terminal or that the sequestered (or isolated) memory may be provided as an add-on unit (e.g., a SIM card, a memory card, an external memory or their equivalents) and then incorporated into the terminal.

In another example of such hardware security means, a terminal includes at least one separate input unit with which a user may [A] only display an advertisement or content screen on a display unit, [B] turn OFF a display unit, [C] replace the advertisement or content screen with another screen, and the like. Therefore, in response to (or upon receiving) a single UI_{THEN}, a terminal runs an application for displaying such a screen, while recognizing that a user may request to make a link to an external source or to download an external file from the external source or link. Accordingly, the terminal may secure a main memory or library by restricting access to such a memory or library from any request made by a user through the separate input unit or by the application providing such a screen.

FIG. 2B is a block diagram illustrating another exemplary embodiment of the first aspect of this disclosure, where a terminal may display different advertisement screens on its display unit when a user passes or fails an authentication operation of the step [12]. Accordingly, such a terminal can provide a user with a seamless operation, for the user can proceed to an unlock state by simply supplying a single authentication (user) sub-input UI_{THEN}. It is appreciated that the terminal displays a basic advertisement (AD_{B1}) as the “fail screen” as in the step [15.1] and that the terminal displays a directed advertisement (AD_{D}) as the “pass screen” as in the step [14.1]. Further details of the terminal of FIG. 2B are similar or identical to those provided in conjunction with the terminal of FIG. 2A.

FIG. 2C is a block diagram illustrating another exemplary embodiment of the first aspect of this disclosure, where a terminal may display a content screen or an advertisement screen on a display unit when a user passes or fails an authentication operation of the step [12], respectively. Accordingly, such a terminal can provide a user with a seamless operation, for the user can proceed to a unlock state by simply supplying a single user input UI_{THEN}. It is appreciated that the terminal displays a basic advertisement (AD_{B1}) as the “fail screen” as in the step [15.1], while displaying a directed content (CT_{D}) as the “pass screen” as in the step [14.2]. Further details of the terminal of FIG. 2C are similar or identical to those provided in conjunction with the terminals of FIGS. 2A and 2B.

Other configurational or operational variations (or modifications) of such terminals described in conjunction with FIGS. 2A to 2C are similar to those illustrated in various exemplary aspects or embodiments throughout this disclosure. Accordingly, each feature of such embodiments and examples of FIGS. 2A to 2C of the first exemplary aspect of this disclosure may be applied to, may be incorporated into, may be replaced by, may replace, and/or may be combined with [A] corresponding features of each other or [B] other embodiments and examples which have been described heretofore and are to be disclosed hereinafter, including various aspects and embodiments of various objectives as described in the “Summary of the Invention.”

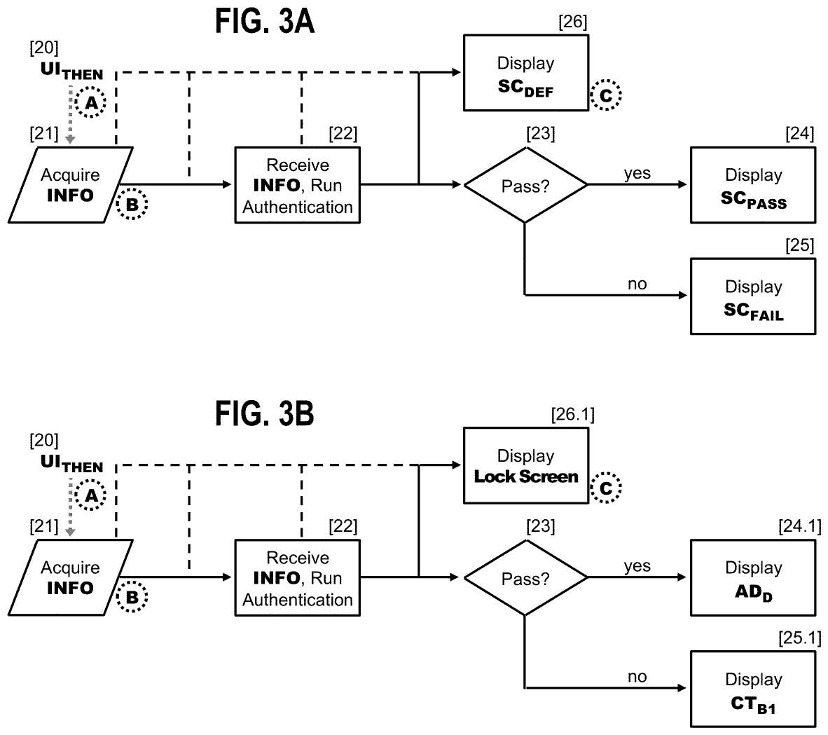

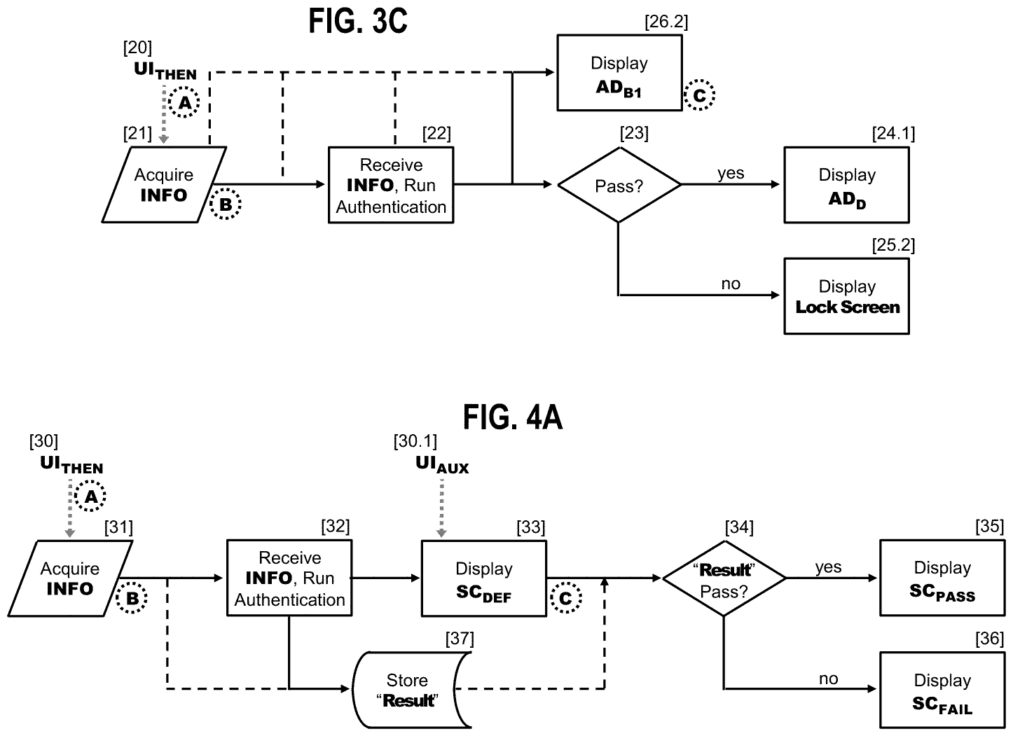

In the second exemplary aspect of this disclosure, a mobile communication terminal may also acquire (i.e., receive) a single authentication (user) sub-input, UI_{THEN} along with at least one activation (user) sub-input (UI_{ACT}), while its display unit was (or has been) in its OFF state. Upon (of after) receiving UI_{ACT}, the terminal activates itself. In addition, upon (or after) receiving UI_{THEN}, the terminal turns ON its display unit, displays at least one default screen (SC_{DEF}) on the display unit, and then “runs at least one authentication operation” (i.e., “runs the authenticating”) based upon UI_{THEN}, all in response to a single UI_{THEN}. Thereafter, the terminal “executes the determining” and displays a new screen (such as, e.g., a “pass screen” or a “fail screen”), e.g., by overlaying a new screen over at least a portion of SC_{DEF}, by covering at least a portion of SC_{DEF} with a new screen, by replacing SC_{DEF} with a new screen, and the like. As described above, a single authentication (user) sub-input, UI_{THEN}, may accompany an activation (user) sub-input (UI_{ACT}) or, alternatively, UI_{THEN} itself may serve as UI_{ACT} in order to activate the terminal. It is appreciated that a terminal may turn ON its display unit [A] concurrently with acquiring the single UI_{THEN}, [B] after acquiring such UI_{THEN}, [C] concurrently with “running the authenticating”, [D] after “running the authenticating,” and the like. FIGS. 3A to 3C are block diagrams illustrating various embodiments of this second exemplary aspect of various terminals, methods, and operation sequences of this disclosure.

FIG. 3A describes a block diagram of one exemplary embodiment of the second aspect of this disclosure, where a terminal displays a “default screen (SC_{DEF})” on a display unit either before, concurrently with or after “running the authenticating (e.g., the step [22]), then “runs the authenticating,” and then displays a “pass screen (SC_{PASS})” or a “fail screen (SC_{FAIL})” when a user passes or fails an authentication operation of the step [22], respectively. Accordingly, this terminal can provide a user with a seamless operation, for the user can proceed to an unlock state by simply supplying the single authentication (user) sub-input UI_{THEN}.

The default screen (SC_{DEF}) of the step [26] may include therein or correspond to a basic content (CT_{B0} or CT_{B1}), a basic advertisement (AD_{B0} or AD_{B1}), an instruction to a user to wait until an authentication operation is completed, and the like. The default screen may be or correspond to a lock screen which may optionally include a basic content (CT_{B1} or CT_{B0}), a basic advertisement (AD_{B1} or AD_{B0}), and the like. In addition, the default screen may include authentication information (e.g., INFO), a confirmation notice of acquiring UI_{THEN}, another confirmation notice of acquiring INFO, other information related to UI_{THEN}, and the like.

The default screen (SC_{DEF}) may include the advertisement or content and may define a tab through which a user may react to such a screen, e.g., by providing at least one auxiliary (user) sub-input (UI_{AUX}) or by performing an active or passive task in order to proceed to a next step of operating the terminal. After the user provides UI_{AUX} or performs such a task, the terminal may determine whether the user is finished with reacting to the screen, e.g., by checking whether the screen may require the user to provide additional (user) sub-inputs or to perform further tasks. In the alternative, a (software) application responsible for displaying SC_{DEF} may generate a signal after the user is finished with such reacting to the screen, and transmits such a signal to an O/S and/or a (software) application so that a terminal may proceed to the next step of operation such as, e.g., the step [23].

Although not depicted in FIG. 3A, the step [26] may be replaced by other operations or steps. For example, a terminal [A] may display SC_{DEF} only for a certain period and then turn OFF its display unit or [B] may display SC_{DEF} only until the terminal replaces SC_{DEF} with either SC_{FAIL} or SC_{PASS}.

It is appreciated that the pass screen (SC_{PASS}) and fail screen (SC_{FAIL}) may be identical or similar to those of FIG. 2A. In addition, the terminal or user may select the default screen (SC_{DEF}), and the pass screen (SC_{PASS}) independently of each other. Accordingly, SC_{PASS} may be different from SC_{DEF} or may be identical or similar to SC_{DEF} as well. Similarly, SC_{FAIL} may become different from SC_{DEF} or may be identical or similar to SC_{DEF}.

The steps [24] and [25] may also be replaced by other operations similar to the steps [14] and [15] of FIG. 2A, respectively, with an extra option that the terminal may display SC_{DEF} when the user fails the authentication operation. Similarly, the step [26] may also be replaced by other operations similar to those of the steps [15] of FIG. 2A and [15.1] of FIG. 2B.

The terminal or user may run various operations after the step [26]. For example, the default screen (SC_{DEF}) may correspond to a prior art lock screen or another screen which is [A] pre-selected by the terminal or user, [B] randomly selected by the terminal or by a certain application, [C] provided by an external source or link and stored in the terminal, [D] provided by the external source or link in real time, and the like. In another example, a terminal may [A] display SC_{DEF} only for a certain period and then turn OFF the display unit, [B] display SC_{DEF} and then replace SC_{DEF} by the pass or fail screen (or overlay SC_{DEF} with the pass or fail screen) after “executing the determining,” and the like.

The terminal or user may also run various operations after the step [25], where such operations are similar or identical to those of [15] or [15.1] of FIGS. 2A and 2B, respectively. In addition, the terminal or user may also run various operations after the step [24], where such operations may be similar or identical to those of [14], [14.1] or [14.2] of FIGS. 2A to 2C, respectively.

The terminal of FIG. 3A may also operate according to other arrangements or sequences which correspond to variations or modifications of the aforementioned arrangements.

In one example, a terminal may complete the steps [21] and [22], and optionally the step [23] within a preset period so that a user may enjoy seamless and fast operations in an environment with enhanced security. In another example, a terminal [A] may directly perform the step [24] or [25] or [B] may cause at least one (software) application to run at least one (predetermined) application to perform the step [24] or [25], where the application has been installed into the terminal before user's purchase or where a user has downloaded the application after purchase. When desirable, the steps [24] and [25] may be replaced by “running the 1^{st} and 2^{nd} operation,” respectively, with or without requiring a user to provide an additional authentication (user) sub-input, UI_{THEN}.

In another example, a terminal may employ at least two same, similar or different authentication operations, where a terminal may acquire at least two authentication (user) sub-inputs and, more particularly, UI_{THEN1} and UI_{THEN2}. As described above, a user may actively provide both of UI_{THEN1} and UI_{THEN2} to the terminal. In the alternative, a user provides UI_{THEN1} to the terminal, then the terminal may acquire UI_{THEN2} on its own, e.g., without requiring a user to voluntarily providing UI_{THEN2}. To this end, the terminal may acquire a fingerprint of a user as UI_{THEN2} while he manipulates the terminal, may acquire an image of an iris or retina of a user and extract UI_{THEN2} therefrom while the user stares at a camera of the terminal, and the like. Based thereon, the terminal may “run the 2^{nd} authenticating,” and then “execute the 2^{nd} determining.”

As described above, “the 2^{nd} authenticating” may be run concurrently with or after “the 1st authenticating.” On the other hand, “the 2^{nd} determining” may be executed before, concurrently with or after “the 1^{st} determining.” The terminal may also display various screens after “running such 1^{st} or 2^{nd} authenticating,” after “executing such 1^{st} or 2^{nd} determining,” and the like. Therefore, as the user passes more authentication operations, the terminal may display more directed, detailed or personal advertisement (or content) screen to a user, may allow a user to access more data, may lead a user to a more secure level of operation, may provide more or diverse options to run more operations, and the like.

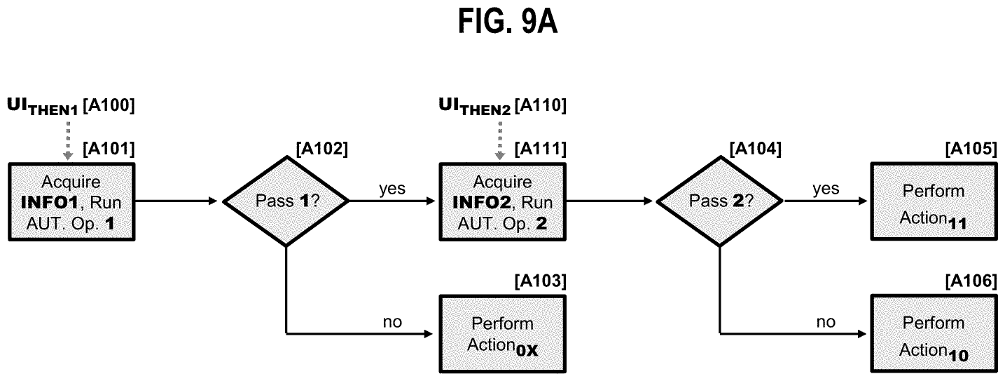

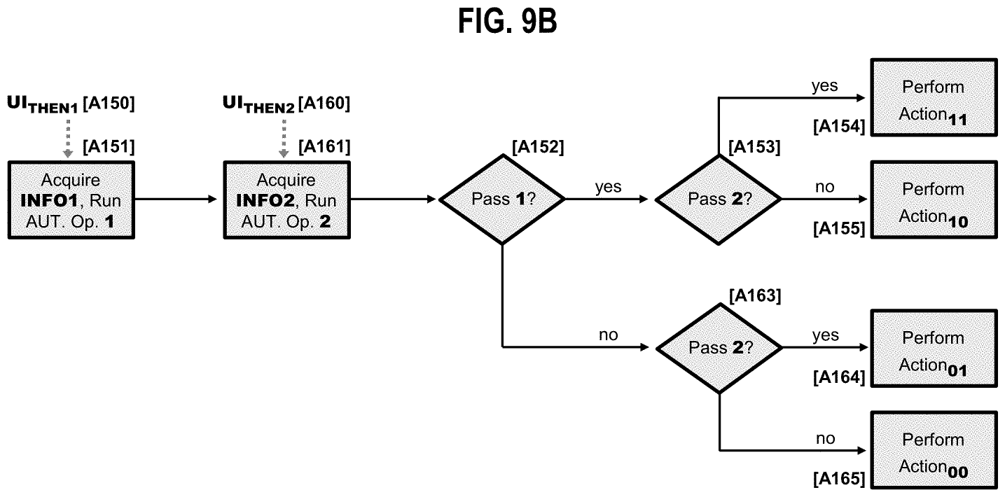

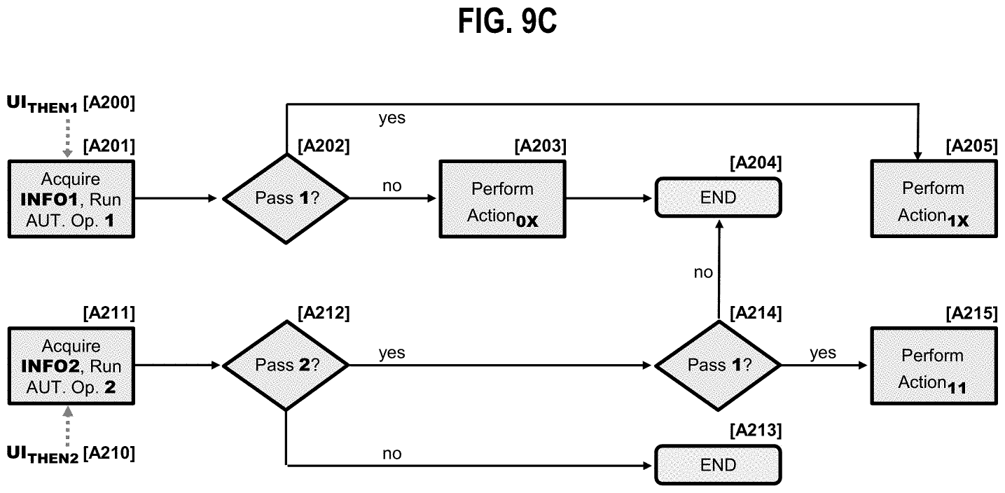

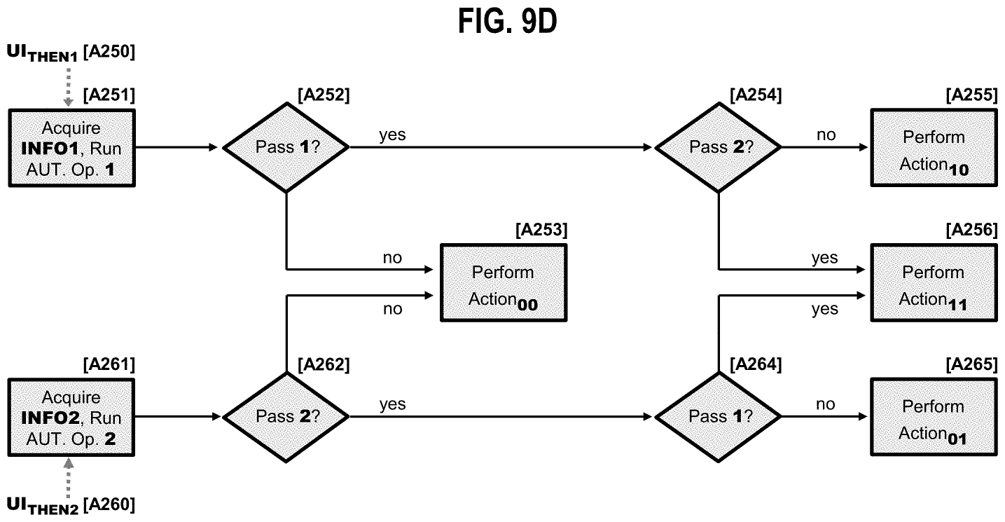

When a user fails the 2^{nd} authentication operation, the terminal may wait for another UI_{THEN3} so as to retry the 2^{nd} authentication operation. The terminal employing at least two authentication operations may be viewed in such a way that some or all of the steps [21] to [23] may be repeated in a certain sequence and, accordingly, the terminal may operate based on various combinations of such steps and/or other steps of FIG. 2A. It is noted that further details of such an arrangement of employing multiple authentication operations are to be provided in conjunction with FIGS. 9A to 9D, and the like.

In another example, the terminal may be implemented with various software and/or hardware security means in order to guarantee both seamless and secure operations to a user of the terminal. To this end, a terminal may include various hardware or software features for guaranteeing secure operations of advertising while providing seamless authentication operations as have been described in conjunction with FIG. 2A.

FIG. 3B is a block diagram illustrating another exemplary embodiment of the second aspect of this disclosure, where a terminal may display on a display unit a lock screen as a default screen (SC_{DEF}) [A] upon (or after) the terminal receives a single authentication (user) sub-input, UI_{THEN}, or [B] before, concurrently or after “running such authenticating.” Thereafter, such a terminal may display a basic content screen (CT_{B}) or a directed advertisement screen (AD_{D}) when a user fails or passes the authentication operation of the step [22], respectively. Accordingly, the terminal can guarantee a user with both seamless and secure operations, for the user can proceed to an unlock state of the terminal by simply supplying a single authentication (user) sub-input UI_{THEN}.

It is noted that the terminal displays a basic content (CT_{B1}) as the “fail screen” as in the step [25.1], while displaying a directed advertisement (AD_{D}) as the “pass screen” as in the step [24.1], although such screens may display other advertisements or contents. Further details of the terminal of FIG. 3B may be identical or similar to those provided in conjunction with the terminal of FIG. 3A.

FIG. 3C is a block diagram illustrating another exemplary embodiment of the second aspect of this disclosure, where a terminal may display a basic advertisement screen (AD_{B1}) as a default screen [A] upon (or after) receiving a single authentication (user) sub-input, UI_{THEN} from a user or [B] before, concurrently with or after “running the authenticating,” all in response to a single UI_{THEN}. The terminal may then display a lock screen or a directed advertisement screen (AD_{D}) when the user fails or passes an authentication operation of the step [22], respectively. Therefore, the terminal can provide a user with seamless and secure operations, for a user can proceed to an unlock state of the terminal simply by providing a single authentication (user) sub-input UI_{THEN}.

It is appreciated that such a terminal displays a lock screen as the “fail screen (SC_{FAIL})” as in the step [25.2], while displaying a directed advertisement (AD_{D}) as the “pass screen (SC_{PASS})” as in the step [24.1] but that such a terminal may display different screens as SC_{PASS} or SC_{FAIL} or may turn OFF its display unit instead of displaying SC_{FAIL}. Further details of the terminal of FIG. 3C are similar or identical to those described in conjunction with the terminals of FIGS. 3A and 3B.

Other configurational or operational variations (or modifications) of such terminals described in conjunction with FIGS. 3A to 3C are similar to those illustrated in various exemplary aspects or embodiments throughout this disclosure. Therefore, each feature of such embodiments and examples of FIGS. 3A to 3C of the second exemplary aspect of this disclosure may be applied to, may be incorporated into, may be replaced by, may replace, and/or may be combined with [A] corresponding features of each other or [B] other embodiments and examples which have been described heretofore and are to be disclosed hereinafter, including various aspects and embodiments of various objectives as described in the “Summary of the Invention.”

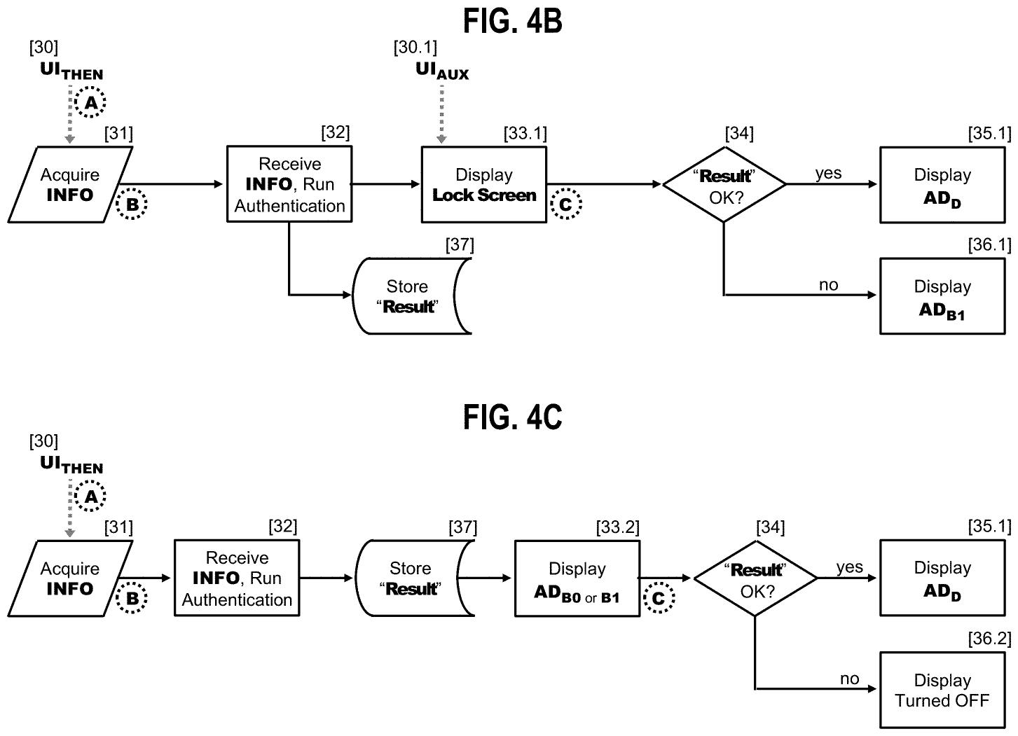

In the third exemplary aspect of this disclosure, a mobile communication terminal may receive (i.e., acquire) a single authentication (user) sub-input (UI_{THEN}) along with at least one activation (user) sub-input (UI_{ACT}), while its display unit was (or has been) in its OFF state. Upon acquiring a single authentication (user) sub-input, UI_{THEN}, a terminal “runs the authenticating” based on UI_{THEN} or other information carried by or included in UI_{THEN}, and stores at least one “Result” resulting from such “authenticating” (or such UI_{THEN} or information) in a library, a memory or another storage area, all in response to the single UI_{THEN}. The terminal may turn ON its display unit and display a default screen (SC_{DEF}) which may require a user to react thereto by providing at least one auxiliary (user) sub-input (UI_{ACT}) or by performing at least one active or passive task. After a user is finished with such reacting, the terminal may retrieve such “Result,” “execute the determining” based on the retrieved “Result,” and then display a new screen (e.g., a “pass screen” or a “fail screen”), e.g., by covering at least a portion of SC_{DEF} with a new screen, by overlaying a new screen over at least a portion of SC_{DEF}, or by replacing SC_{DEF} with a new screen. A terminal may store “Result” [A] immediately after acquiring UI_{THEN}, [B] after “running the authenticating” or [C] before displaying a default screen (SC_{DEF}). FIGS. 4A to 4C are to block diagrams illustrating various embodiments of this third exemplary aspect of various terminals, methods, and operation sequences of this disclosure.

FIG. 4A is a block diagram of one exemplary embodiment of the third aspect of this disclosure, where a terminal displays a default screen, SC_{DEF}, after “running the authenticating,” display a “pass screen” or a “fail screen” on a display unit when a user respectively passes or fails an authentication operation of the step [32]. Accordingly, this terminal can provide a user with seamless and secure operations, for the user can proceed to a unlock state by simply supplying a single authentication (user) sub-input UI_{THEN}.

The fail screen (SC_{FAIL}) of the step [36] and the pass screen (SC_{PASS}) of the step [35] may include therein or correspond to various screens as explained in conjunction with FIG. 2A or other figures. Furthermore, the default screen (SC_{DEF}) of the step [33] may include therein or correspond to various screens as described in conjunction with FIG. 3A or other figures.

It is appreciated that the terminal may store “Result” concurrently with or immediately after acquiring a single UI_{THEN} (i.e., the step [31]), where such “Result” may be UI_{THEN} itself or other information necessary to run the authentication operation. Alternatively, the terminal may store “Result” concurrently with or after “running the authenticating” (i.e., the step [32]), where the “Result” may include UI_{THEN}, above information, a “pass” or a “fail.” Thereafter, the terminal may display SC_{DEF}, and may [A] keep SC_{DEF} while it performs the step [34] and then remove SC_{DEF} from a display surface of the display unit after a certain period, [B] keep SC_{DEF} until SC_{DEF} is replaced or overlaid by SC_{PASS} or SC_{FAIL}, [C] keep SC_{DEF} for a certain period and turn a display unit OFF, and the like.

When SC_{DEF} is or includes therein a basic advertisement screen (AD_{B}) or a basic content screen (CT_{B}), such a screen may define at least one tab thereon and also allow a user to proceed to a next step of operating the terminal only after a user reacts to the scree, as depicted in the step [30.1], e.g., by supplying at least one auxiliary (user) sub-input (UI_{AUX}) to the tab or by performing an active or passive task onto the tab as defined above. After a user is finished with reacting to the screen at the step [33], the terminal may retrieve “Result” from a memory, a library or another storage space, and “execute the determining” at the step [34]. Thereafter the terminal displays SC_{PASS} or SC_{FAIL}, depending on results from the authentication operation. The terminal may optionally run one of various (predetermined) operations after the steps [35], [36] or even [33], where examples of such operations are similar or identical to those of FIGS. 2A, 3A, and others.

It is appreciated that, even when a user may have to supply one or multiple UI_{AUX} to react to SC_{DEF}, SC_{PASS}, SC_{FAIL} or other screens, the user still has to provide only a single UI_{THEN} to the terminal in order to get to an unlock state of the terminal. Such seamless operations are enabled, for the terminal can store such “Result” and then utilize such “Result” after the user is finished with reacting to various screens. Accordingly, in the perspective of the user, he or she can authenticate himself or herself by providing only a single UI_{THEN} to the terminal, thereby enjoying both seamless and secure operations provided by such a terminal.

More particularly and in one example, when SC_{DEF} (or other screens) may require a user to react thereto by providing an additional (user) sub-input (e.g., UI_{AUX} or UI_{THEN}) or by performing a certain task, the terminal may operate according to various sequences. In another example, a user may provide UI_{AUX} to such a tab or to another input unit which may be positioned in another part of the terminal in order to react to SC_{DEF} (or other screens). In the alternative, a user may perform an active task while manipulating at least a portion of another part of the terminal or may perform a passive task while not taking any action for a certain period or otherwise not manipulating the terminal as defined above.

In another example, the 1^{st} user input of the step [30] may include an activation (user) sub-input (UI_{ACT}) but the 2^{nd} user input of the step [30.1] may include an authentication (user) sub-input (UI_{THEN}). Therefore, a user may be able to provide UI_{THEN} while he or she is reacting to SC_{DEF} or while he or she is reacting to SC_{PASS}, SC_{FAIL} or other screens when SC_{PASS}, SC_{FAIL} or other screens are arranged to receive UI_{THEN}. In other words, the terminal of this third aspect of the disclosure requires only a single UI_{THEN} (except in those aspects and embodiments where the terminals employ multiple authentication operations) so as to allow a user to reach an unlock state when he or she passes the authentication operation.

It is to be appreciated that various sequences and resulting advantages of the above five paragraph as well as related paragraphs throughout this disclosure are not unique to this exemplary embodiment of the third aspect of the disclosure. Rather, the above sequences and advantages may be applicable to all exemplary aspects and embodiments illustrated through this disclosure whenever a screen (e.g., SC_{DEF}, SC_{PASS}, SC_{FAIL}, a lock screen, a home screen or other screens) may include the “tab” onto which the user has to provide one or more (user) sub-inputs (e.g., UI_{AUX}, UI_{THEN} and the like) or has to perform an active task or a passive task in order to react to such a screen and to proceed to a next step of operating the terminal. Alternatively, such a screen may require the user to provide such (user) sub-inputs or to perform such a task by manipulating another input unit of the terminal or another part of such a terminal in order to react to such a screen and to proceed to a next step of operating the terminal. Accordingly, in the perspective of the user, he or she can complete the authentication by providing only a single UI_{THEN} to the terminal, thereby enjoying both seamless and secure operations provided by such a terminal.

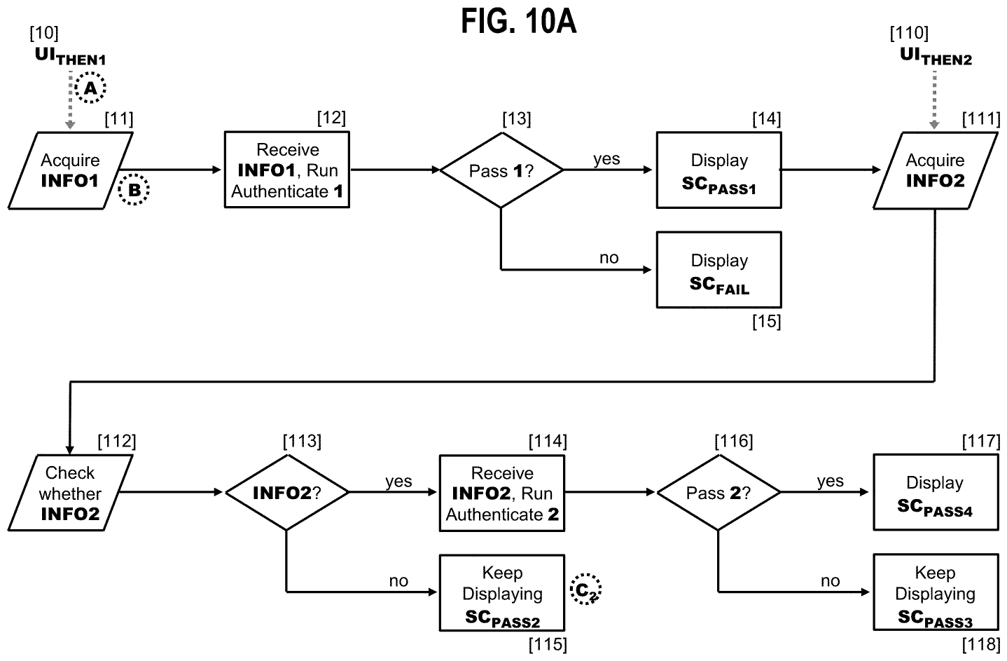

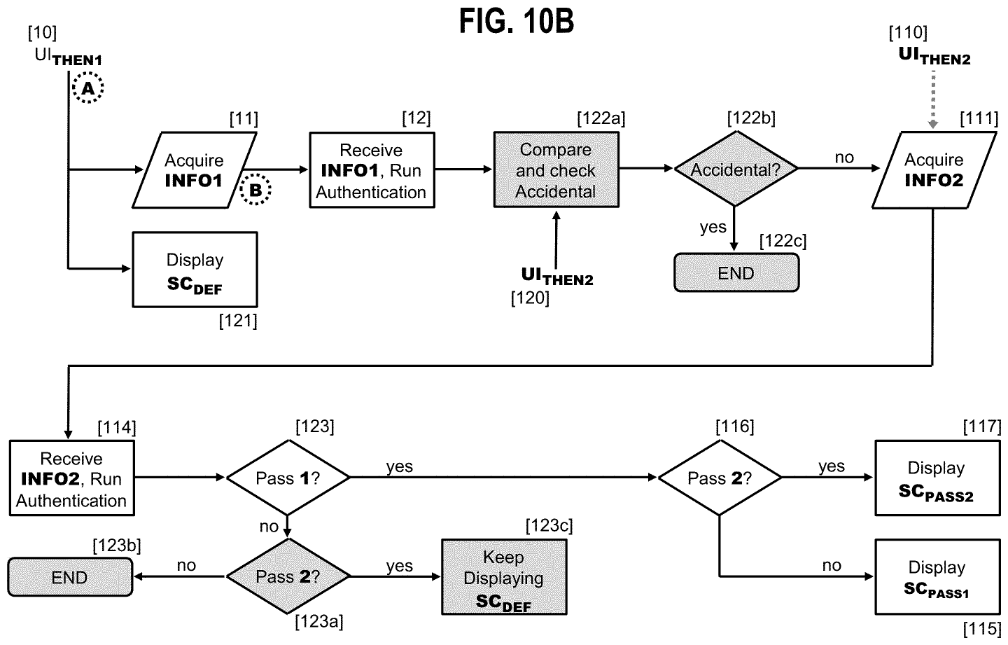

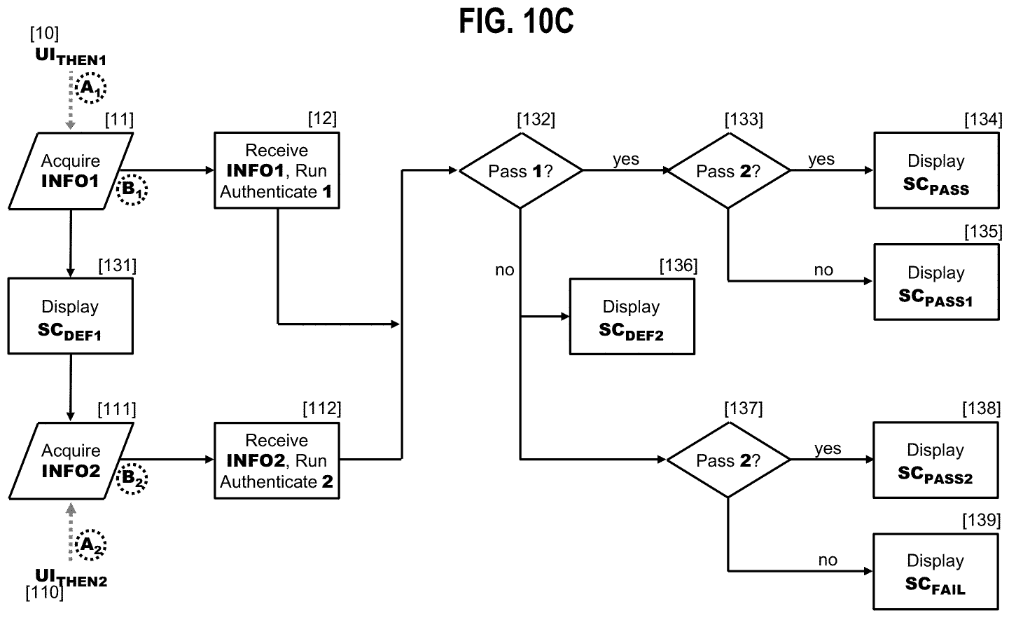

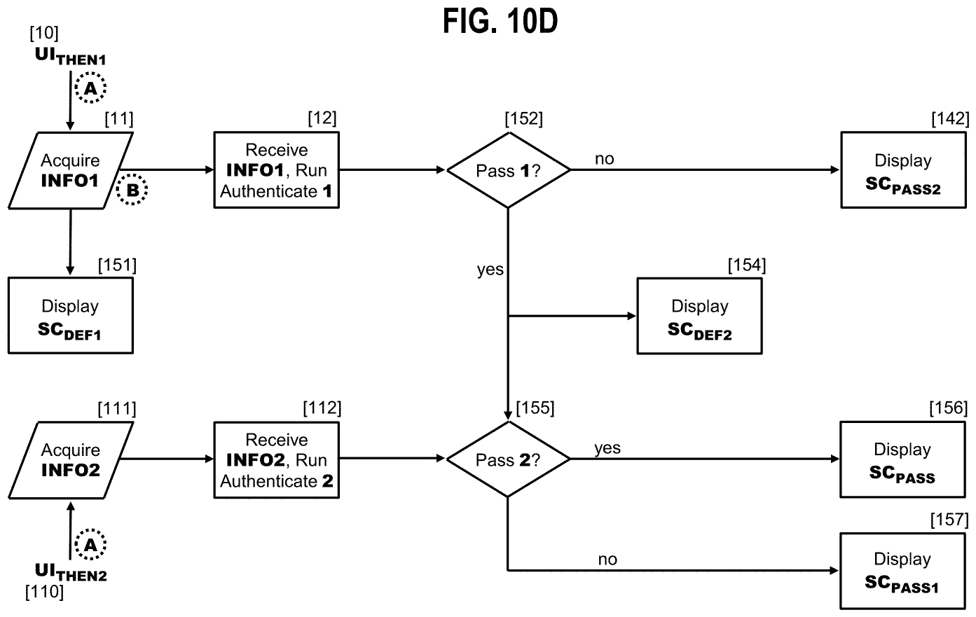

The above sequences may also be applied to all exemplary aspects and/or embodiments in which a terminal employs multiple (series or parallel) authentication operations (e.g., FIGS. 9A to 9D, FIGS. 10A to 10D, and the like). More particularly, the above sequences may be applied to the 1^{st} authentication operation in order to ensure that a user may complete the 1^{st} authentication operation by providing only a single UI_{THEN1} to such a terminal. When desirable, such sequences may also be applied to the 2^{nd} authentication operation in order to ensure that a user may also complete the 2^{nd} authentication operation by providing only a single UI_{THEN2} to such a terminal. By incorporating the above sequences to more authentication operations, the terminal may ensure more seamless and more secure operations to the user.

In addition, the sequences and resulting advantages of the above seven paragraphs and related paragraphs of this disclosure may further be applicable to all exemplary aspects and embodiments of this disclosure when such a screen requires a user to manipulate at least one of remaining input units which may not be arranged to receive UI_{ACT}, UI_{AUX} or UI_{THEN}. Accordingly, various terminals throughout this disclosure may provide the user with seamless and secure operations by requiring the user to provide only a single UI_{THEN} by employing such sequences as described above, e.g., by first acquiring and storing such “Result” and then retrieving and utilizing such “Result” to take the user to an unlock state.

The terminal of FIG. 4A may also operate according to other arrangements or sequences which correspond to variations or modifications of the aforementioned arrangements.

In one example, the default screen (SC_{DEF}) may not require a user to react thereto and, thereby, obviating a user from providing UI_{AUX} or performing any active or passive task thereonto. In such a case, the terminal may proceed to the step [34] in one of various sequences which have been described above.

In another example, the terminal may be implemented with various software and/or hardware security means in order to guarantee both seamless and secure operations to a user of the terminal. To this end, a terminal may include various hardware or software features (e.g., one or more of the 1^{st}, 2^{nd}, 3^{rd}, and 4^{th} applications described above) for guaranteeing secure operations of advertising while providing seamless authentication operations as have been described in conjunction with FIG. 2A.

FIG. 4B is a block diagram showing another exemplary embodiment of the third aspect of this disclosure, where a sequence of FIG. 4B is similar to that of FIG. 4A, except a few following features. That is, a terminal receives a single authentication (user) sub-input (i.e., UI_{THEN}) or activation (user) sub-input (i.e., UI_{ACT}) at the step [31]. After “running the authenticating” at the step [32], a terminal may receive and/or extract “Result” and store such “Result” in a memory, a library or another storage space of the terminal. The terminal then turns ON a display unit and displays a lock screen at the step [33.1].

When the lock screen of the step [33.1] is a prior art lock screen, it may not require the user to react thereto. In such a case, the terminal may proceed to the step [34] in one of various sequences as described above. When the lock screen includes a tab which requires the user to react thereto, the user may provide UI_{AUX} to the tab (or to another input unit positioned in another part of the terminal) or may perform a certain task while manipulating such a tab (or at least another portion of the terminal). When the 1^{st} user input at the step [30] includes an activation (user) sub-input (UI_{ACT}) but not UI_{THEN}, the 2^{nd} user sub-input (UI_{AUX}) of the step [30.1] may be UI_{THEN} which the terminal receives while the user is reacting to the lock screen.

After the terminal displays the lock screen of the step [33.1] and the user is finished with reacting to such a screen, the terminal may [A] remove the lock screen after a certain period, [B] turn OFF the display unit in a certain period, or [C] keep displaying the lock screen until it is replaced or overlaid by AD_{B}, or AD_{D}. After either of [A], [B] or [C], the terminal may then proceed to the step [34], and display AD_{D} (step 35.1) or AD_{B}, (step 36.1) when the use passes or fails the authentication operation, respectively. Accordingly, such a terminal can provide a user with a seamless operation, for the user can proceed to an unlock state by simply supplying a single authentication (user) sub-input, UI_{THEN}.

It is appreciated that a terminal may display a basic advertisement screen or basic content screen at the step [33.1] instead of the lock screen. When the user passes the authentication operation, a terminal may display AD_{D} which may relate to a merchandise or service of AD_{B}, or which may not relate thereto. Further details of the terminal of FIG. 4B may be identical or similar to those provided in conjunction with the terminal of FIG. 4A and other terminals of FIGS. 2A to 2C when applicable.

FIG. 4C is a block diagram showing another exemplary embodiment of the third aspect of this disclosure, where a sequence of FIG. 4C is similar to that of FIG. 4A, except a few following features. That is, a terminal receives a single user authentication (user) sub-input, UI_{THEN}, along with a single activation (user) sub-input, UI_{ACT}, at the step [31]. After “running the authenticating” at the step [32], a terminal may receive or extract “Result” and store such “Result” in a memory, a library or a storage space of the terminal. The terminal then turns ON a display unit and displays at the step [33.2] a screen which may be SC_{ADB0} (i.e., a screen that includes AD_{B0}) or SC_{ADB1} (i.e., a screen that includes AD_{B1}).

Such a terminal may then proceed to the step [34] when SC_{ADB0} or SC_{ADB1} does not require a user to provide any additional (user) sub-input or to perform any task. When SC_{ADB0} or SC_{ADB1} does require the user to provide the additional (user) sub-input or to perform a certain task, however, the terminal may perform various steps in various sequences as described in FIGS. 4A and 4B in order to provide the seamless and secure operations. The terminal then proceeds to the step [34] and may display SCADD (i.e., a screen including AD_{D}) or turn OFF a display unit when the user passes or fails the authentication operation, respectively.

Other configurational or operational variations (or modifications) of such terminals described in conjunction with FIGS. 4A to 4C are similar to those illustrated in various exemplary aspects or embodiments throughout this disclosure. Therefore, each feature of such embodiments and examples of FIGS. 4A to 4C of this third exemplary aspect of this disclosure may be applied to, may be incorporated into, may be replaced by, may replace, and/or may be combined with [A] corresponding features of each other or [B] other embodiments and examples which have been described heretofore and are to be disclosed hereinafter, including various aspects and embodiments of various objectives as described in the “Summary of the Invention.”

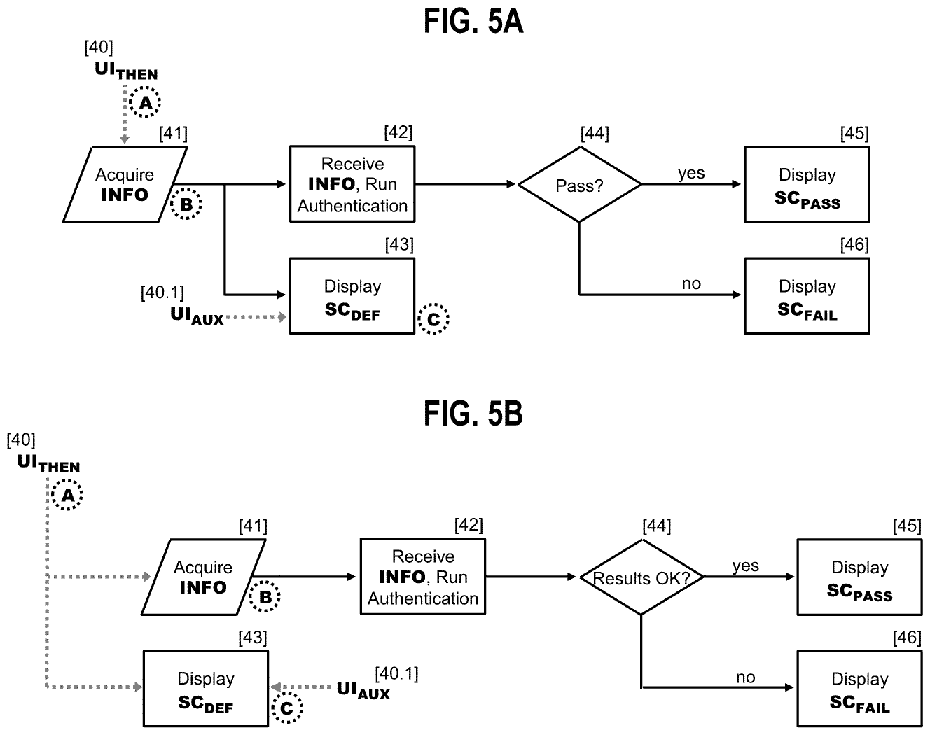

In the fourth exemplary aspect of this disclosure, a terminal receives a single authentication (user) sub-input, UI_{THEN}, along with at least one activation (user) sub-input (UI_{ACT}) while its display unit was (or has been) in its OFF state. Upon (or after) receiving UI_{ACT}, the terminal may activate itself. In addition and in response to (or upon receiving) a single UI_{THEN}, the terminal may “run the authenticating” based on UI_{THEN} (or other information carried thereby). The terminal then turns ON a display unit [A] concurrently with receiving the single UI_{THEN} or [B] concurrently with “running the authenticating.” Depending on a consequence of the authentication operation, a terminal may display a pass screen or a fail screen when the user passes or fails the authentication, respectively. Because such a terminal turns ON a display unit and displays at least one screen thereon in the earlier phase of operation, a user may be able to recognize whether or not his or her input (or sub-input) has been properly received by the terminal. FIGS. 5A and 5B represent block diagrams illustrating various embodiments of the fourth exemplary aspect of various terminals, methods, and operation sequences of this disclosure.

FIG. 5A shows a block diagram of one exemplary embodiment of the fourth aspect of this disclosure, where, a terminal receives a single authentication (user) sub-input, UI_{THEN}, along with at least one activation (user) sub-input, UI_{ACT}. In response to UI_{ACT}, the terminal activates itself. In addition, upon receiving (in response to) UI_{THEN} at the step [41], a terminal “runs the authenticating” based upon UI_{THEN} or other information carried by or included in UI_{THEN} at the step [42], turns ON a display unit concurrently with “running the authenticating” at the step [43], “execute the determining” at the step [44], and display a “pass screen” or a “fail screen” on a display unit at the steps [45] and [46] when a user passes or fails the authentication operation of the step [42], respectively, all in response to a single UI_{THEN}. Accordingly, this terminal can provide a user with seamless and secure operations, for the user can proceed to a unlock state by simply supplying a single UI_{THEN}.

Similar to the default screens (SC_{DEF}) of the above aspects and embodiments, SC_{DEF} of the step [43] may be a basic content (CT_{B2}, CT_{B1} or CT_{B0}) or a basic advertisement (AD_{B2}, AD_{B1} or AD_{B0}). SC_{DEF} may also include a lock screen, an instruction to a user to wait until the terminal completes a certain operation or step, INFO (authentication information), a confirmation notice of acquiring UI_{THEN} or INFO or other necessary information required for the authentication operation, and the like. In addition, the pass screen (SC_{PASS}) and fail screen (SC_{FAIL}) of the steps [45] and [46] are similar or identical to those of the above figures.

It is noted in the default screen (SC_{DEF}) of the step [43] does not require a user to provide any auxiliary (user) sub-input (UI_{AUX}) and/or to perform any task thereonto. Therefore, such a terminal may [A] keep SC_{DEF} for a certain period and turn off the display unit, [B] keep SC_{DEF} during the steps [42] and [44], [C] keep SC_{DEF} until the terminal “executes the determining” (step [44]), and thereafter replace or overlay at least a portion of SC_{DEF} with SC_{PASS} or SC_{FAIL} after the steps [45] or [46], respectively.

The terminal of FIG. 5A may also operate according to other arrangements or sequences which correspond to variations or modifications of the aforementioned arrangements.

In one example, the terminal may run various operations while following the sequence of FIG. 5A, e.g., after displaying SC_{DEF} (step [43]), after “running the authenticating” (step [42]), after displaying SC_{PASS} or SC_{FAIL} (steps [45] and [46]), and the like, where examples of such operations have been enumerated above. In the alternative, the steps [45], [46] or [43] may be replaced by such operations so that, e.g., the terminal may run the 1^{st} operation as the user passes the authentication operation instead of displaying SC_{PASS}, may instead run the 2^{nd} operation as the user fails such an operation, and the like.

In another example, the default screen (SC_{DEF}) may require the user to provide UI_{AUX} (e.g., step [40.1]) or to perform an active or passive task onto the screen in order to proceed to a next step of operating the terminal. In such a case, the terminal may store “Result,” similar to the terminals of FIGS. 4A to 4C, and allow the user to react to SC_{DEF}. Once the user is finished with reacting to such a screen, the terminal may then retrieve such “Result” and “run the authenticating” based thereupon.

FIG. 5B is a block diagram illustrating another exemplary embodiment of the fourth aspect of this disclosure, where a sequence of FIG. 5B is similar to that of FIG. 5A, except a few following features. That is, a terminal receives a single authentication (user) sub-input (i.e., UI_{THEN}) along with at least one activation (user) sub-input (i.e., UI_{ACT}) at the step [41]. Concurrently therewith, the terminal turns ON a display unit and displays a default screen SC_{DEF} at the step [43], all in response to the single UI_{THEN}. After “running the authenticating” at the step [42], a terminal displays a pass screen (SC_{PASS}) or a fail screen (SC_{FAIL}) depending on the results of the authentication operation.

It is appreciated that the terminals operating according to the sequences of FIGS. 5A and 5B offer the benefit of displaying a screen on a display surface of a display unit upon receiving any kind of user input from a user. In the embodiment of FIG. 5A, the terminal displays a screen (SC_{DEF}) upon acquiring (i.e., receiving) UI_{THEN} (or UI_{ACT}) and, therefore, such a terminal may not display any screen and remain in its OFF state when the terminal may not recognize UI_{THEN}. Accordingly, the terminal which activates itself in response to UI_{ACT} may not display any screen in such a case. In contrary, the terminal of FIG. 5B is rather arranged to display the screen whether or not it may recognize UI_{THEN}. Therefore, such a terminal turns ON its display unit whenever the terminal activates itself. Further details of the terminal of FIG. 5B are identical or similar to those of the terminal of FIG. 5A.

Other configurational or operational variations (or modifications) of such terminals described in conjunction with FIGS. 5A and 5B are similar to those illustrated in various exemplary aspects or embodiments of this disclosure. Therefore, each feature of such embodiments and examples of FIGS. 5A and 5B of this fourth exemplary aspect of this disclosure may be applied to, may be incorporated into, may be replaced by, may replace, and/or may be combined with [A] corresponding features of each other or [B] other embodiments and examples which have been described heretofore and are to be disclosed hereinafter, including various aspects and embodiments of various objectives as described in the “Summary of the Invention.”

In the fifth exemplary aspect of this disclosure, a terminal receives a single authentication (user) sub-input, UI_{THEN}, along with at least one activation (user) sub-input (UI_{ACT}) while its display unit was (or has been) in its OFF state. Upon (or after) receiving UI_{ACT}, the terminal may activate itself. In addition and upon receiving a single UI_{THEN}, the terminal may turn ON its display unit, display a default screen (SC_{DEF}) on the display unit, and store information which is included in or accompanied by UI_{THEN}, all in response to the single UI_{THEN}. As described above, examples of such information (INFO) which is stored by the terminal may include, but not limited to, UI_{THEN} itself, authentication information other than UI_{THEN}, other information extractable from UI_{THEN}, and the like. Thereafter, the terminal may retrieve such information and “run the authenticating” based upon such information. Depending on a consequence of the authentication operation, such a terminal may display a pass screen (SC_{PASS}) or a fail screen (SC_{FAIL}) when the user passes or fails the authentication, respectively.

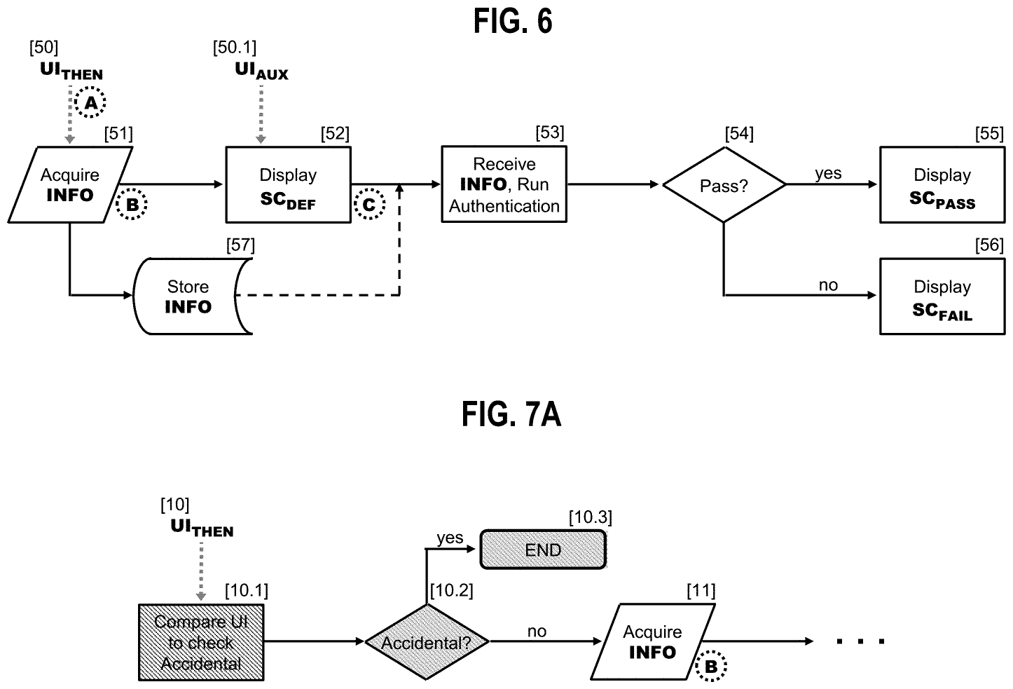

It is appreciated that the terminal of this fifth exemplary aspect is generally similar to the terminals of the third exemplary aspect in such a way that all of such terminals store some information, allow their users to react to the screens which require the users to provide additional (user) sub-inputs or to perform some actions. Once the users are finished with such reacting, the terminals retrieve such information and “run the authenticating” based on such information. But operational sequences of such terminals may differ in one respect. That is, the terminals of the third exemplary aspect (e.g., FIGS. 4A to 4C) generally store information from “running the authenticating” and, therefore, that such information typically includes consequences of the authentication such as, e.g., a “pass,” a “fail,” and optionally UI_{THEN} itself or other authentication information. In this aspect, such information is collectively referred to “Result” heretofore and hereinafter. In contrary, the terminal of the fifth exemplary aspect (e.g., FIG. 6) tends to store whatever is received (i.e., acquired) directly from the user. In this respect, such information generally does not include a “pass” or a “fail,” for the terminal stores such information before “running the authenticating.” Accordingly, such information stored by the terminal of this exemplary aspect may be viewed as raw data for “running the authenticating” thereafter.

FIG. 6 is a block diagram illustrating one exemplary embodiment of this fifth aspect of this disclosure, where a sequence of FIG. 6 is similar to those of FIGS. 5A and 5B, except a few following features. That is, a terminal receives a single authentication (user) sub-input (i.e., UI_{THEN}) along with at least one activation (user) sub-input (i.e., UI_{ACT}) at the step [51]. Upon (or after) receiving UI_{ACT}, and UI_{THEN}, the terminal activates itself, acquires UI_{THEN} at the step [51], stores information (including UI_{THEN} and other optional information included therein or accompanied therewith), turns ON a display unit, and displays at least one default screen (SC_{DEF}), all in response to a single UI_{THEN}. Because the default screen (SC_{DEF}) then requires the user to react thereto, the user may provide UI_{AUX} (step [50.1]) or may perform an active or passive task onto the screen and then proceed to a next step of operating the terminal. The terminal may then retrieve the above information stored in the step [57], “run the authenticating” based thereupon, and displays a pass screen (SC_{PASS}) (step [55]) or a fail screen (SC_{FAIL}) (step [56]) based on a consequence of the authentication operation.

It is appreciated that the terminal may display various screens such as, e.g., SC_{DEF}, SC_{PASS} or SC_{FAIL}, each of which has been described above. In case SC_{DEF} of the step [52] does not require a user to react thereto, the terminal may [A] keep SC_{DEF} for a certain period and turn off the display unit, [B] keep SC_{DEF} during the steps [53] and [54], [C] keep SC_{DEF} until the step [44] and thereafter replace or overlay at least a portion of SC_{DEF} with SC_{PASS} or SC_{FAIL} after the steps [55] or [56], respectively.

The terminal of FIG. 6 may also operate according to other arrangements or sequences which correspond to variations or modifications of the aforementioned arrangements.

In one example, the terminal may run various operations while following the sequence exemplified in FIG. 6, where examples of such operations have been described above. Alternatively, the steps [55], [56] or [53] may be replaced by such operations as described above. In another example, the terminal may store such information (step [57]) concurrently with the terminal receiving UI_{ACT} and/or UI_{THEN}.

Other configurational or operational variations (or modifications) of such terminals described in conjunction with FIG. 6 are similar to those illustrated in various exemplary aspects or embodiments of this disclosure. Therefore, each feature of such embodiments and examples of FIG. 6 of this fifth exemplary aspect of this disclosure may be applied to, may be incorporated into, may be replaced by, may replace, and/or may be combined with [A] corresponding features of each other or [B] other embodiments and examples which have been described heretofore and which are to be disclosed hereinafter, including various aspects and embodiments of various objectives as described in the “Summary of the Invention.”

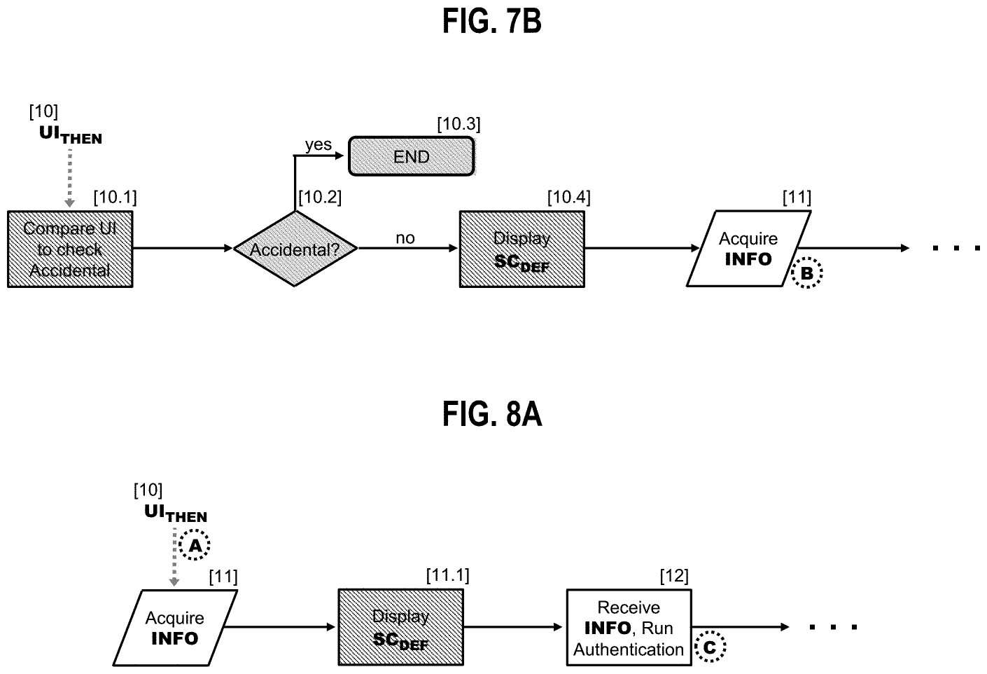

In the sixth exemplary aspect of this disclosure, various operations and their sequences of such terminals of this disclosure may be modified in such a way that such terminals may determine or confirm whether a user input may be the input which is intended by a user (to be referred to as a “preliminary checking” hereinafter). To this end, the terminals may employ various prior art hardware elements and/or software algorithms details of which are to be provided as follows. For simplicity of illustration, however, various terminals of this sixth exemplary aspect incorporate the “preliminary checking” in exemplary steps which are marked “A,” “A₁” or “A₂” inside dotted circles. It is appreciated, however, that the “preliminary checking” may be included in other aspects or embodiments with “A,” “A₁” or “A₂” inside dotted circles throughout this disclosure. FIGS. 7A and 7B are block diagrams illustrating various embodiments of this sixth exemplary aspect of various terminals, methods, and operation sequences of this disclosure.

FIG. 7A is a block diagram illustrating an exemplary embodiment of this sixth aspect of this disclosure, where a terminal performs an exemplary preliminary checking before acquiring a user input (UI), where UI may include a single authentication (user) sub-input (UI_{THEN}) intended by a user or where UI may be an accidental input not intended by the user, where examples of such accidental or unintended input may be an accidental contact between an input unit of a terminal and an object, an unintended mechanical impact applied to the input unit, and the like. To this end, once receiving UI (step [10.1]), a terminal determines or checks (step [10.2]) whether or not UI is a human input. When UI is the latter, the terminal may then check whether the human UI is in an authorized format, and the like. When UI is the human input or UI is in the authorized format, such a terminal proceeds to acquire UI_{THEN} (step [11]) and then follows any of the following steps as described above. Otherwise, the terminal proceeds to the step [10.3] to terminate the preliminary checking.

The terminal may incorporate various conventional sensors for the preliminary checking. In one example, the terminal may employ prior art proximity sensors and check whether or not a terminal is positioned in a closed space. When the sensors determine that the terminal is in such a space (e.g., inside a pocket, a bag, and the like), the terminal recognizes the contact as an accidental and does not proceed to a next step. In another example, the terminal may employ prior art capacitive sensors and check whether or not a user input is a human input. By assessing capacitance or changes thereof, the sensors may find that a contacting object is a non-human article, and the terminal does not proceed to a next step. In another example, the terminal may compare the user input with a stored value to check whether the input is legitimate, and stop to proceed in case the user input does not conform to the stored value. The terminal may further incorporate other prior art sensors which can check whether or not the input is a human input or a legitimate (authorized) non-human input, where various conventional sensors which may be used for the preliminary checking have been disclosed in, e.g., U.S. Pat. No. 8,311,514 entitled “Prevention of accidental device activation,” filed on Sep. 16, 2010 by Shamik Bandyopadhyay et al., assigned to Microsoft Corporation, and incorporated herein in its entirety by reference.

Although not shown in the figure, the terminal may run various operations after the steps [10.2] or [10.3]. In one example, a terminal may keep itself in its inactive state, may keep its display unit in its OFF state, and the like. In another example, a terminal may turn ON a display unit and display a screen notifying the user that there was a false input, that the terminal is awaiting a user input, and the like. In another example, such a terminal may acquire UI_{THEN} (step [11]) before the preliminary checking (e.g., steps [10.1] to [10.3]) so that the terminal may first check whether or not UI_{THEN} conforms to an authorized format. In another example, a terminal may acquire UI_{THEN} (step [11]) after receiving a user input (step [10.1]) but before checking such an input is accidental (step [10.2]). Other modifications of the sequence exemplified in FIG. 7A is also possible as long as such modifications do not conflict with the goal of this exemplary aspect of turning ON the display unit and displaying a screen thereon such the user may readily recognize that a single authentication (user) is in fact received by the terminal.

FIG. 7B is a block diagram showing another exemplary embodiment of this sixth aspect of this disclosure, where a terminal performs an exemplary preliminary checking before acquiring a user input (UI) similar to that of FIG. 7A but displays a default screen (SC_{DEF}) (step [10.4]) when the terminal determines that UI is a human input, UI is in a conforming format, and the like. The default screen displayed at the step [10.4] may not require the user to react thereonto. In such a case, the terminal may display SC_{DEF} for a certain period and then turn OFF a display unit. Alternatively, the terminal may keep displaying SC_{DEF} while the terminal is “executing the determining” (step [10.4]) and display a pass screen (SC_{PASS}) or a fail screen (SC_{FAIL}) based on a result of the authentication operation.

In contrary, a terminal may instead display SC_{DEF} which requires the user to react thereto, e.g., by providing at least one auxiliary (user) sub-input (UI_{AUX}) or by performing at least one active or passive task. However, such a terminal is similar or identical to those of other aspects and embodiments throughout this disclosure and, therefore, further explanations of the terminal and SC_{DEF} are omitted. Other structural and operational features of the terminal of FIG. 7B are similar to those of the terminal of FIG. 7A.

Other configurational or operational variations (or modifications) of such terminals described in conjunction with FIGS. 7A and 7B are similar to those illustrated in other exemplary aspects or embodiments throughout this disclosure. Therefore, each feature of such embodiments and examples of FIGS. 7A and 7B of this sixth exemplary aspect of this disclosure may be applied to, may be incorporated into, may be replaced by, may replace, and/or may be combined with [A] corresponding features of each other or [B] other embodiments and examples which have been described heretofore and are to be disclosed hereinafter, including various aspects and embodiments of various objectives as described in the “Summary of the Invention.”

In the seventh exemplary aspect of this disclosure, various operations and their sequences of such terminals of this disclosure may be modified in such a way that the terminals turn ON their display units in very early stages of their operational sequences and then display various screens on the display units. Such a terminal offers the benefit of allowing a user to recognize whether or not his or her input (or sub-input) has been successfully received. In addition, by displaying an advertisement or content screen in an early stage of the operation, the terminal may offer the benefit of increasing an efficiency of advertising as well.

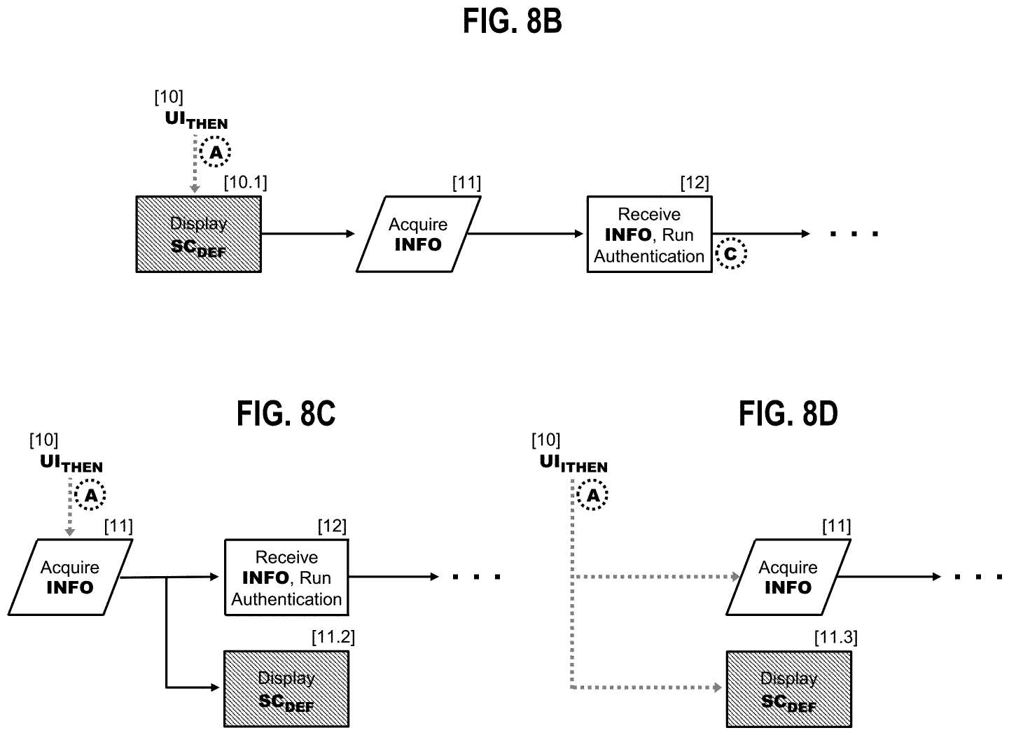

For simplicity of illustration, this seventh exemplary aspect may be included in other aspects or embodiments with “B,” “B₁” or “B₂” inside dotted circles throughout this disclosure. It is appreciated, however, that turning ON the display unit may be performed in other steps along various sequences of the terminals as well. FIGS. 8A to 8D show block diagrams illustrating various embodiments of this seventh exemplary aspect of various terminals, methods, and operation sequences of this disclosure.

FIG. 8A is a block diagram illustrating an exemplary embodiment of this seventh aspect of this disclosure, where a terminal turns ON its display unit in a very early stage of its operational sequence. More particularly, upon (or after) receiving a single authentication (user) sub-input (UI_{THEN}) (step [11]), a terminal turns ON its display unit and displays a default screen (SC_{DEF}) (step [11.1]), where examples of such SC_{DEF} have been described above.

Such a terminal may display SC_{DEF} in various modes. For example, the terminal [A] may display SC_{DEF} until it completes “running the authenticating” (step [12]), [B] may display SC_{DEF} for a certain period and then turn OFF the display unit, [C] may display SC_{DEF} until the terminal “executes the determining” and display a pass screen or a fail screen depending on whether or not the user passes the authentication operation, and the like. In another example, the terminal may perform the step [11.1] of displaying SC_{DEF} concurrently with receiving UI_{THEN} at the step [11].

FIG. 8B represents a block diagram illustrating another exemplary embodiment of this seventh aspect of this disclosure, where a terminal turns ON its display unit in a very early stage of its operational sequence. More particularly, upon (or after) receiving at least one activation (user) sub-input (UI_{ACT}) (step [10.1]), a terminal turns ON its display unit and displays a default screen (SC_{DEF}) (step [10.1]), where examples of such SC_{DEF} have been described above. Other structural and operational features of the terminal of FIG. 8B are similar to those of the terminal of FIG. 8A.

FIGS. 8C and 8D represent block diagrams of further exemplary embodiments of this seventh aspect of this disclosure, where a terminal turns ON a display unit in an early stage of its operational sequence. In FIG. 8C, a terminal may receive a single authentication (user) sub-input (UI_{THEN}) along with at least one activation (user) sub-input (UI_{ACT}) (step [11]), activate itself, turn ON a display unit, and display a default screen (SC_{DEF}) on its display unit (step [11.2]), concurrently with “running the authenticating” (step [12]), all in response to the single UI_{THEN}. In contrary, a terminal of FIG. 8D may receive UI_{THEN} and UI_{ACT}, activate itself, and then acquire UI_{THEN}, concurrently with turning ON a display unit and displaying at least one default screen (SC_{DEF}) on its display unit (step [11.2]), all in response to the single UI_{THEN}. Other structural and operational features of the terminal of FIGS. 8C and 8D are similar to those of the terminals of FIGS. 8A and 8B.

Other configurational or operational variations (or modifications) of such terminals described in conjunction with FIGS. 8A to 8D are similar to those illustrated in other exemplary aspects or embodiments throughout this disclosure. Therefore, each feature of such embodiments and examples of FIGS. 8A to 8D of this seventh exemplary aspect of this disclosure may be applied to, may be incorporated into, may be replaced by, may replace, and/or may be combined with [A] corresponding features of each other or [B] other embodiments and examples which have been described heretofore and are to be disclosed hereinafter, including various aspects and embodiments of various objectives as described in the “Summary of the Invention.”

In the eighth exemplary aspect of this disclosure, a terminal employs multiple authentication operations while guaranteeing a user with seamless as well as secure operations of advertising. To this end, a terminal may require a user to provide only a single authentication (user) sub-input or two authentication (user) sub-inputs, while displaying advertisement or content screens on a display unit, thereby guaranteeing most seamless operations for the user. A terminal may further provide a user with more options or depths as a user passes more authentication operations.

Various terminals according to this eighth exemplary aspect of the disclosure (as well as other terminals of this disclosure which employ multiple authentication operations) may classify various data (stored therein or accessed thereby) into various “depths,” based upon their directed, detailed or personal nature. For example, “the least directed data” may be those which are generic in nature and therefore apply to everybody, while “the most directed data” may be those particularly relating to, e.g., a user preference, a user selection, a user habit, and other user traits. Similarly, the “least detailed data” may be titles, subtitles, classifications or others which lack specificity or details, while the “most detailed data” may be raw data, data processed or classified by a user, any conclusion therefrom, and the like. The “lowest personal data” may not relate to a user and, therefore, may be disclosed to others without concerning a user at all, while the “highest personal data” may be very personal in nature such that a user does not want to disclose the data to others and that a user does not want others to access such data as well. It is appreciated that a terminal manufacturer, a distributor or a data provider may establish proper numbers (or types) of such “depths” (or ranks) of data classification as they see fit. Alternatively, a use may classify the data as he or she sees fit as well.

Various terminals according to this eighth exemplary aspect of this disclosure (as well as other terminals of this disclosure which employ multiple authentication operations) may classify various (software) applications (stored therein or accessed thereby) into various “depths” or may classify various operations of executing the application into various “depths,” similar to classifying data as described in the preceding paragraph.

Thus, some applications may be classified as the “least directed,” “less detailed” or “not likely personal” application, while the remaining applications may be classified as the “most directed,” “moderately directed,” “somewhat detailed,” “a little personal,” and the like.

A terminal may further classify various operations of executing the application into various “options” such that “the least directed (or detailed, personal) application” provides a user with only limited options while running the application, while “the most personal (or detailed, directed) application” provides a user with a maximum number (or extent) of options while running the application. It therefore follows that a user may maximize the use of the application with a maximum number of options when the application is given the most directed, detailed or personal “depth” or “rank.” A terminal manufacturer, a distributor or an application provider may establish proper numbers (or types) of such depths (or ranks) of applications or operations as well as proper numbers or types of such options of operations as they see fit. Alternatively, a use may also classify the applications and operations as he or she sees fit as well.

Various terminals of this eighth exemplary aspect of this disclosure (and other terminals of this disclosure which employ multiple authentication operations) operate according to a following generic sequence. For example, a terminal receives (i.e., acquires) a single user input (UI₁) accompanying a single authentication (user) sub-input (UI_{THEN1}) and at least one activation (user) sub-input (UI_{ACT1}), while its display unit is (or has been) in its OFF state. The terminal is activated upon (or after) receiving the 1^{st} activation sub-input (UI_{ACT1}), “runs the 1^{st} authenticating” based on the 1^{st} authentication sub-input (UI_{THEN1}), “executes the determining,” and optionally turns ON a display unit thereupon (or thereafter), all in response to a single UI_{THEN1}. When a user fails the 1^{st} authentication operation, such a terminal may run one of various aforementioned operations such as, e.g., displaying at least one default screen, keeping a display unit in its OFF state or turning it OFF, and the like. When the user passes the 1^{st} authentication operation, the user may use the terminal to run operations of his or her choice.

Depending on the result from “running the 1^{st} authenticating,” “executing such comparing” or “executing such determining,” a terminal may display at least one screen such as, e.g., a default screen, a home screen, an advertisement screen, a content screen, and the like. Even when a terminal displays a screen which includes at least one “tab” and requires a user to react to the screen by providing at least one sub-input thereto, the terminal may employ a sequence for guaranteeing seamless operations.

In one example, a user may actively or voluntarily provide a second user input (UI₂) accompanying another single authentication (user) sub-input (UI_{THEN2}) onto the tab, e.g., by touching the tap, tapping the tab, slide the tab, move his or her finger over or across the tab, and the like. Accordingly, such a user may advance to a next depth (i.e., more directed, detailed or personal) as he or she actively or voluntarily provides more user inputs (UI₁, UI₂, UI₃, . . . ) and more authentication (user) sub-inputs (UI_{THEN1}, UI_{THEN2}, UI_{THEN3}, . . . ) while he or she is reacting to such a screen(s).

As illustrated in FIGS. 4A to 4C and FIG. 6, a terminal may require the user to react to the tab on the screen, e.g., by providing at least one auxiliary (user) sub-input (UI_{AUX}) to the tab, in order to proceed to a next step or operating the terminal. In this case, the terminal may store “Result.,” from the 1^{st} authentication operation and “Result₂” from the 2^{nd} authentication operation when necessary. The terminal may then retrieve “Result₁,” and/or “Result₂”, and “execute the 1^{st} and/or 2^{nd} determining” based thereon. It is appreciated that a terminal may store “Result₂” after, concurrently with or prior to storing “Result₁,” and that the terminal retrieve “Result₁,” prior to, concurrently with or after retrieving “Result₂” as well. It is therefore appreciated that, regardless of an order of such storing and retrieving, a user has only to provide a single UI_{THEN1} for the “1st authenticating,” to provide another single UI_{THEN2} for the “2^{nd} authenticating,” and the like, in order to proceed to the next step of operating the terminal. Therefore, the terminal may minimize the number of authentication sub-inputs which the user has to provide to the terminal even when the terminal employs multiple authentication operations.

In another example, without a voluntary action by a user, a terminal may proactively acquire a single UI_{THEN2} on its own, e.g., by acquiring an image of an iris or a retina of a user without asking the user to intentionally stare at a camera of the terminal, by acquiring movement characteristics (e.g., a velocity, an acceleration, a displacement, a direction, and the like) of a user (or terminal) without asking the user to intentionally move his or her body part (or terminal), by acquiring a voice of a user during conversation without asking the user to intentionally speak to a microphone of the terminal, and the like. Therefore, a user may advance to a state of a next depth (i.e., more directed, detailed or personal) without having to actively or voluntarily provide more user inputs and more authentication (user) sub-inputs. In other words, all the user has to provide to the terminal is the single UI_{THEN1} for the “1^{st} authenticating,” while the terminal proactively acquires other authentication sub-inputs UI_{THEN2}, UI_{THEN3}, and the like, for the “2^{nd} authenticating,” “3^{rd} authenticating,” and the like. Accordingly, such seamless operations provide the user with the maximum user convenience as well as minimize a total number of authentication sub-inputs which the user has to provide to pass multiple authentication operations.

When a terminal incorporates three or more authentication operations, the terminal may [A] run all of such authentication operations concurrently with one another, [B] run all of such authentication operations sequentially, [C] run at least two authentication operations concurrently with each other, while running other two authentication operations sequentially, and the like. Unlike such multiple authentication operations, the terminal may execute at least one step of the “comparing steps” (i.e., “execute the comparing” hereinafter) or execute at least one step of the “determining steps” (i.e., “executing the determining” hereinafter) at different timings, for the terminal does not have to “execute the (1^{st}) comparing” and “execute the (1^{st}) determining” immediately following “running the 1^{st} authenticating.” Therefore, a terminal which “runs the 1^{st} authenticating” and thereafter “runs the 2^{nd} authenticating” may “execute the 2^{nd} comparing” and thereafter “execute the 2^{nd} determining,” followed by “executing the 1^{st} comparing” and “executing the 1^{st} determining.” In other words, an order of “running the 1^{st} and 2^{nd} authenticating” may not necessarily coincide with an order of “executing such 1^{st} or 2^{nd} comparing” or with another order of “executing the 1^{st} or 2^{nd} determining,” and the like. It then follows that such a terminal may “execute the 1^{st} comparing” [A] before, [B] concurrently with or [C] after “executing the 2^{nd} determining,” “execute the 1^{st} determining” [A] before, [B] concurrently with or [C] after “executing the 2^{nd} comparing,” and the like. It is appreciated that a terminal operating according to various sequences in this paragraph runs the 2^{nd} authentication operations regardless of the result of the 1^{st} authentication operation. However, a terminal may be arranged to not “run the 2^{nd} authenticating” when the user fails the 1st authenticating.

Multiple authentication operations incorporated into such a terminal may have the same, similar or different types such that a terminal manufacturer or a user may select what types of authentication operations are to be run in what order. In one example where a terminal employs two fingerprint authentication operations, the terminal may first authenticate a fingerprint of an index finger, and then authenticate a fingerprint of another part of the same finger of the user, a fingerprint of another finger of the user, a fingerprint of a finger of a 3^{rd} person, and the like. When desirable, the terminal may run such authentication operations concurrently with each other or in a small time gap. In another example where a terminal may employ two different types of authentication operations, the terminal may first authenticate a fingerprint of a user and then authenticate an iris (or retina) of the user.

Such a terminal may also run different authentication operations based upon what kinds of authentication (user) sub-inputs. For example and as explained above, a terminal may acquire at least one biometric information of a user such as, e.g., an image of an iris or retina, an image of an ear, a face or a head, an image of a hand or a wrist, a voice, a movement of at least one body part, a number or a pattern of the movement, a direction or a period of such movement, a combination of at least two of the above, and the like. A terminal may instead acquire at least one non-biometric information of a user such as, e.g., a movement of at least a portion of a terminal, a number or pattern of the movement, a direction or period of the movement, an image of an environment, a brightness of an environment, an environmental sound, a signal or a beacon from a certain object (e.g., a device in a network of IoT, i.e., an internet of things), a signal or a beacon from a wearable device worn by a user or another person, a signal or a beacon from a (software) application or an O/S of a terminal, a combination of at least two of the above, and the like. The terminal may then incorporate an appropriate sensing element to acquire such authentication sub-inputs.

When a terminal may “run the 2^{nd} authentication operation (i.e., “run the 2^{nd} authenticating”) and “execute the 2^{nd} determining steps (i.e., “execute the 2^{nd} determining”), a terminal may incorporate the “2^{nd} authenticating” and “2^{nd} determining” into each of various sequences described hereinabove. It is appreciated that a terminal is to “run the 1^{st} authenticating” prior to or concurrently with “running the 2^{nd} authenticating” and that such a terminal is to “execute the 1^{st} (or 2^{nd}) determining” after “running the 1^{st} (or 2^{nd}) authenticating.” In contrary, a terminal may “execute the 2^{nd} determining” prior to, concurrently with or after “executing the 1^{st} determining,” depending on detailed characteristics of sequences of operations or steps.

Various mobile communication terminals of this eighth exemplary aspect may operate according to various sequences. Followings are selected examples of such sequences and operations thereof which guarantee seamless and secure operations of authenticating the user with the minimum number of authentication (user) sub-inputs while advertising on the display unit of the terminal.

In one exemplary embodiment of this eighth exemplary aspect, a terminal receives a single 1st authentication sub-input (UI_{THEN1}) along with at least one activation sub-input (UI_{ACT}), while its display unit was (or has been) turned OFF. In response to UI_{ACT}, a terminal activates itself. In addition and in response to a single UI_{THEN1}, a terminal turns ON a display unit, display a certain screen on the display unit, [A] “runs the 1^{st} authenticating,” and “executes the 1^{st} determining” or [B] “runs the 1^{st} authenticating” concurrently with such “turning ON,” and “executes the 1^{st} determining.”

In another exemplary embodiment of this eighth exemplary aspect, a terminal receives a single UI_{THEN1} and at least one UI_{ACT}, while its display unit was (or has been) turned OFF. In response to UI_{ACT} and UI_{THEN1}, a terminal activates itself and “runs the 1^{st} authenticating.” In addition and in response to the single UI_{THEN1}, a terminal [A] may turn ON its display unit, display a screen, and “execute the 1^{st} determining,” [B] may turn on its display unit, displays a screen, and “executes the 1^{st} determining” concurrently with such “turning ON” or [C] “executes the 1^{st} determining,” turns ON a display, and displays a screen.

It is appreciated that, in general, a terminal of this eighth exemplary aspect may have to receive (i.e., acquire) multiple authentication (user) sub-inputs, may have to “run the authenticating” as many times, and may have to “execute the determining” as many times as well. In addition, the terminal may display various screens as described above based on the results obtained from the 1^{st} and 2^{nd} authentication operations. FIGS. 9A to 9D describe block diagrams depicting various embodiments of this eighth exemplary aspect of various terminals, methods, and operation sequences of this disclosure, where each exemplary terminals may employ two authentication operations, while using only two authentication (user) sub-inputs, thereby providing seamless and secure operations of double authenticating and advertising on display units of such terminals.

FIG. 9A is a block diagram illustrating another exemplary embodiment of this eighth aspect of this disclosure, where a terminal employs two authentication operations (steps [A101] and [A111]) and where the terminal performs certain actions such as “Action_{0X},” “Action₁₀,” and “Action₁₁,” depending on the results of the 1^{st} and 2^{nd} authentication operations. It is appreciated in this embodiment of FIG. 9A that a terminal may turn ON a display unit [A] concurrently with one of the steps [A101], [A105], and [A106] or, alternatively, [B] prior to, concurrently with or after one of the steps [A102], [A103], [A111], and [A104]. In addition, such a terminal may store “Result₁,” which is obtained after the step [A101] and/or “Result₂” which is obtained after the step [A111], and the like. For simplicity of illustration, various receiving steps, displaying steps or storing steps are omitted in FIG. 9A. However, an exemplary sequence of this figure includes such steps as will be explained in the following disclosure.

Upon (or after) receiving (i.e., acquiring) a single 1^{st} authentication (user) sub-input (UI_{THEN1}) and at least one activation (user) sub-input (UI_{ACT}) (step [A100]), a terminal “runs the 1^{st} authenticating” (step [A101]) and “executes the 1^{st} determining” (step [A102]). The terminal may remain in its (1st) lock state or switches to its INACTIVE state when the user fails the 1^{st} authenticating (step [A103]). In contrast, the terminal may switch to a 1^{st} unlock state as he or she passes the 1^{st} authenticating (step [A111]).

When a user fails the 1^{st} authenticating of the step [A102] (i.e., a 1^{st}-failing user), a terminal remains in its 1^{st} lock state and performs “Action_{0X},” where the 1^{st} subscript “0” means failing the 1^{st} authenticating, while the 2^{nd} subscript “X” means that the terminal does not need to run the 2^{nd} authentication when the user fails the 1^{st} authenticating.

It is noted that the terminal may turn ON its display unit and display at least one screen on the display unit at any step from the step [A100] to the step [A103] or concurrently with one of the steps [A100] through [A103]. Depending on a state of a display unit, “Action_{0X}” may include various operations. For example, Action_{0X} may be keeping a display unit in its OFF state or switching the terminal to its INACTIVE state, when the display unit has not been turned ON before the step [A103]. When a display unit has already been turned ON before or at the step [A103], however, Action_{0X} may include one of other operations such as, e.g., displaying a default screen or a lock screen, displaying a basic screen such as a basic advertisement screen (SC_{ADB0}) or a basic content screen (SC_{CTB0}), running at least one (predetermined) operation, and the like. Because the user failed the 1^{st} authenticating, the terminal is typically in a lock state. Therefore, the terminal may allow the user to run a very limited number of operations, if any.

When the user passes the 1^{st} authenticating of the step [A102] (i.e., a 1^{st}-passing user), the terminal may switch to a 1^{st} unlock state and allow the 1^{st}-passing user to access some data with certain “depths” or to run some (pre-determined) operations with certain “options” and certain “depths.” Because this 1^{st}-passing user has passed the 1^{st} authenticating anyway, such a terminal may treat this 1^{st}-passing user more favorably or personally, with more directedness or details than the 1^{st}-failing user. Therefore, the terminal may allow the 1^{st}-passing user to access more data than the 1^{st}-failing user, to access such data into more “depths” than the 1^{st}-failing user, to run more (software) applications than the 1^{st}-failing user, to run such operations with more options than the 1^{st}-failing user, and the like.

The terminal may then receive (i.e., acquire) a single 2^{nd} authentication sub-input (UI_{THEN2}) (step [A110]), “run the 2^{nd} authenticating” (step [A111]), and “execute the 2^{nd} determining” (step [A104]).

When the 1^{st}-passing user fails the 2^{nd} authenticating, he then turns into a 2nd-failing user. The terminal may then remain in the 1^{st} lock state while treating this user the same as the 1^{st}-failing user. In the alternative, the terminal may switch to a 2^{nd} lock state and treat this 2nd-failing user more favorably or personally, with more directedness or details than the 1^{st}-failing user. Accordingly, the terminal may allow this 2^{nd}-failing user to access more (or the same amount of) data with more “depth” than the 1^{st}-failing user, may allow this 2^{nd}-failing user to run more (or the same number of) applications with more “options” than the 1^{st}-failing user, and the like.

When the user fails the 2^{nd} authenticating, however, the terminal may perform “Action₁₀” (step [A106]) where the 1^{st} subscript “1” refers to passing the 1^{st} authenticating, whereas the 2^{nd} subscript “0” means failing the 2^{nd} authenticating. Action₁₀ may be identical or similar to Action_{0X}. Alternatively, Action₁₀ may be displaying another basic screen such as SC_{ADB1} (a basic advertisement screen), SC_{CTB1} (a basic content screen which includes CT_{B}), and the like, where SCAM is a least a little more directed, detailed or personal than SC_{ADB0} and SC_{CTB1} is at least a bit more directed, detailed or personal than SC_{CTB0}. In addition, Action₁₀ may be running the same application as in the case of Action_{0X}, another operation which is not included in Action_{0X}, and the like.

When a user passes the 2^{nd} authenticating of the step [A105] (i.e., a 2nd-passing user), such a terminal may remain in the same 1^{st} unlock state, while treating the 2nd-passing user in the same way as treating the 1^{st}-passing user. Alternatively, the terminal may switch to a 2^{nd} unlock state where the terminal treats this 2^{nd}-passing user more favorably or personally, with more directedness or details than the (1^{st}-passing) but 2^{nd}-failing user, not to mention the 1^{st}-failing user. Accordingly, the terminal may allow the 2^{nd}-passing user to access all (or most) data stored in the terminal with the greatest “depth” or to run all (or most) operations stored in the terminal with all (or most) “options” available by the terminal.

As the user passes the 2^{nd} authenticating in addition to the 1^{st} authenticating, the terminal performs “Action₁₁” where the 1^{st} and 2^{nd} subscripts “1” refer to passing the 1^{st} and 2^{nd} authenticating, respectively. Such Action₁₁ may be turning ON a display unit and display at least one screen thereon when the display unit has been turned OFF before the step [A105]. However, when the terminal has turned ON the display unit and has already been displaying an old screen, Action₁₁ may include various operations such as, e.g., replacing or overlaying at least a portion of the old screen with a new screen, where the new screen may be a home screen, a directed advertisement screen (SC_{ADD}), a directed content screen (SC_{CTD}), a screen selected by the terminal or the user, and the like. In addition, Action₁₁ may also be running the same application as in the case of Action₁₀, running such an application of Action₁₀ but with more “options,” running at least one another operation which is not included in Action₁₀, and the like.

It is noted that the sequences in the above paragraphs correspond to a case when the screen displayed on the display unit does not require a user to react thereto, e.g., by providing at least one auxiliary (user) sub-input (UI_{AUX}) or by performing an active or passive task. When the screen requires the user to react thereto, the user may have to provide UI_{AUX} and then finish to react to the screen in order to proceed to a next step of operation. However, when a user provides UI_{AUX} after providing UI_{THEN1} or UI_{THEN2} but before “executing 1^{st} or 2^{nd} determining,” the user may have to provide another UI_{THEN1} or UI_{THEN2} after the user is done with reacting to the screen, which is not convenient to the user. To obviate such a problem, the terminal may store “Result₁,” or “Result₂” as explained above, and then retrieve such when the user is done with reacting to the screen. Thus, the terminal may continue to provide the seamless features to the user.

The terminal of this exemplary embodiment may further allow a user to reach multiple lock states or multiple unlock states depending on the results from the 1^{st} and/or 2^{nd} authentication operations.

For example, such a terminal may take a user to a 1^{st} lock state when the user fails the 1st authenticating (step [A103]) but to a 2^{nd} lock state when the user fails the 2^{nd} authenticating (step [A106]). Such a terminal may then allow the user to access more amount of data or the same amount of data with more “depths” in the 2^{nd} lock state than the 1^{st} lock state. Similarly, the terminal may provide a greater number of “options” or “options” with greater “depths” more to a (software) applications running in the 2^{nd} lock state than an operation running in the 1^{st} lock state, and the like. Similarly, such a terminal may also take a user to a 1^{st} unlock state when the user passes the 1^{st} authenticating (step [A111]) and to a 2^{nd} unlock state when the user passes the 2^{nd} authenticating (step [A105]). Such a terminal may allow the user to access more amount of data or the same amount of data with more “depths” in the 2^{nd} unlock state than the 1^{st} unlock state. The terminal may provide a greater number of “options” or “options with greater depths” more to a (software) application running in the 2^{nd} unlock state than another operation running in the 1^{st} unlock state.

As described hereinabove, various terminals may acquire authentication (user) sub-inputs in two different but related modes. In one exemplary mode, a user may voluntarily manipulate at least a portion of at least one input unit of a terminal in order to provide the authentication information to the terminal. In another exemplary mode, a terminal may proactively acquire the authentication information from a user, without asking the user to perform a certain action. It is appreciated that a user may have to perform a certain action even when a terminal proactively acquires the authentication (user) sub-input.

In order to better distinguish such two modes, a “voluntary action of a user for providing an authentication (user) sub-input to a terminal is defined to refer to a situation where a user actively manipulates at least a portion of at least one input unit in order to provide the authentication (user) sub-input so that a terminal may run an authentication operation. In contrary, a “proactive acquisition by a terminal” means a situation where a terminal acquires authentication (user) sub-input from a user while the user is performing a task which is not related to the authentication operation. That is, whether a reception or an acquisition of authentication (user) sub-input is voluntary action by a user or a proactive acquisition by a terminal is typically determined based on whether or not a user is performing such an action for the purpose of providing authentication information to a terminal or for accomplishing a certain task which is different from or not related to run an authentication operation. If the answer is the former, the action is the “voluntary action of user,” whereas, if the answer is the latter, the terminal proactively acquires the authentication (user) sub-input.

For example and in one case, a user supplies a fingerprint to a terminal for the 1^{st} authenticating and then stares at a camera of a terminal to provide an image of an iris or retina. Such actions may be deemed to be voluntary actions of the user. In another case, a user supplies a fingerprint to a terminal and, when the user passes the 1^{st} authenticating, the terminal takes the user to an unlock state, where the user performs certain tasks by running (software) applications stored in the terminal. While the user is performing such tasks, the terminal may acquire an image of an iris or retina of the user or dynamic characteristics of movements of the user or his or her body part, and then acquire the authentication information therefrom. In such a case, the action of providing a fingerprint is deemed to be a voluntary action of the user, whereas acquisition of such an image or such characteristics may be deemed to be a proactive acquisition by the terminal.

The terminal of FIG. 9A may also operate according to other arrangements or sequences which correspond to variations or modifications of the aforementioned arrangements.

Various terminals of this embodiment aim to provide seamless operations to a user with a reasonable speed such that the user does not have to wait for the terminal to spend too much time. Therefore, the terminal may finish “running the 1^{st} authenticating” and “executing the 1^{st} determining” (steps [A101] and [A102]) within a reasonable period, and to finish “running the 2^{nd} authenticating” and “executing the 2^{nd} determining” (steps [A111] and [A104]) within a reasonable period.

The exemplary embodiment of FIG. 9A introduce various states of the terminal such as, e.g., the 1^{st} lock state, the 2^{nd} lock state, the 1^{st} unlock state, the 2^{nd} unlock state, and the like, where the terminal in the 2^{nd} lock state may provide more data “depths” and/or operational “options” to the user than the terminal in the 1^{st} lock state, where the terminal in the 2^{nd} unlock state may provide more data “depths” and/or operational “options” to the user than the terminal in the 1^{st} unlock state, and where the terminal in the 1^{st} unlock state may provide more data “depth” and/or operational “options” than the terminal in the 2^{nd} lock state. It is appreciated, however, that the user (or terminal) may adjust the “depths” and the extent of “options” of each of such lock states and/or unlock states as he or she sees fit. Accordingly, a terminal in the 2^{nd} lock state may provide more data “depth” and operational “options” than the one in the 1^{st} unlock state, a terminal in the 1^{st} unlock state may provide the same data “depths” and operational “options” as the terminal in the 2^{nd} lock state, and the like.

It is appreciated that the above multiple unlock (or lock) states are in a hierarchical order and, therefore, that an unlock (or lock) state with less “depth” and less “options” may be deemed as a subset of another unlock (or lock) state with more “depth” and more “options.” In other words, when described in the Venn diagrams, the unlock (or lock) state with less “depth” and less “options” may be deemed as a small circle an entire portion of which is enclosed by a larger circle which corresponds to another unlock (or lock) state with more “depth” and more “options.”

However, multiple unlock (or lock) states may be arranged not in a hierarchical order but rather in a parallel relationship so that an unlock (or lock) state with less “depth” and less “options” is not necessarily a subset of another unlock (or lock) state with more “depth” and more “options.” In other words, when described in the Venn diagrams, the unlock (or lock) state with less “depth” and less “options” may be a small (or large) circle which may overlap only a portion of a larger circle which corresponds to another unlock (or lock) state with more “depth” and more “options” or, alternatively, which may be disposed away from the larger circle that there is no overlap between two circles. Utilizing such diverse arrangements, the terminal may allow the user to customize what kind (or type) of data and in how much “depth” the user may access in each of such multiple unlock (or lock) states, what kind (or type) of (software) applications and with how many “options” the user may run in each state, and the like.

Although now shown in the figure, the terminal may employ additional authentication operations, e.g., to run the 3^{rd}, 4^{th} or 5^{th} authentication operation. In such a case, the terminal may arrange its operational sequence in such a way that each additional authentication operation may be run concurrently with or after running the aforementioned 1^{st} and/or 2^{nd} authentication operation. Based on their mechanisms or operational features, the additional authentication operations may require the user to provide appropriate authentication (user) sub-inputs as have been described above. The user may also provide the authentication (user) sub-inputs, and the terminal may receive such (user) sub-inputs in various sequences as described above. It is noted, however, that the terminal may receive a single additional authentication sub-input so as to run the additional authentication operation, thereby providing the seamless operations to the user.

The terminal may also include various software or hardware security means for guaranteeing seamless and secure operations to the user. To this end, a terminal may include such hardware or software features (e.g., one or more of the 1^{st}, 2^{nd}, 3^{rd} and 4^{th} applications described above) as have been described in FIG. 2A. In particular, when a (software) application which performs Action_{0X}, Action₁₀ or Action₁₁ and which displays the screens is the application downloaded from an external source, the terminal may completely or conditionally block the application from accessing a (main) memory or library of the terminal, thereby enhancing security of the terminal.

The terminal may give an option to a user to deactivate one of the authentication operations. Accordingly, a user may deactivate the 2^{nd} authenticating (step [A111]) and the 2^{nd} determining (step [A104]) such that the terminal is reduced to those terminals with a single authentication operation as exemplified from FIG. 2A to FIG. 8D. In the alternative, a user may deactivate the 1^{st} authenticating (step [A101]) and the 1^{st} determining (step [A102]) so as to reduce the operational sequence similar to those of the terminals as exemplified from FIG. 2A to FIG. 8D.

Other configurational or operational variations (or modifications) of such terminals described in conjunction with FIG. 9A are similar to those illustrated in various exemplary aspects or embodiments of this disclosure. Therefore, each feature of the above examples of FIG. 9A of this eighth exemplary aspect of this disclosure may be applied to, may be incorporated into, may be replaced by, may replace, and/or may be combined with [A] corresponding features of FIG. 9A or [B] other embodiments and their examples which have been described heretofore and are to be disclosed hereinafter, including various aspects and embodiments of various objectives as described in the “Summary of the Invention.”

FIG. 9B is a block diagram illustrating another exemplary embodiment of this eighth aspect of this disclosure, where a terminal employs two authentication operations (steps [A151] and [A161]) and where the terminal performs certain actions such as “Action₀₀,” “Action₀₁,” “Action₁₀,” and “Action₁₁,” depending on the results of the 1^{st} and 2^{nd} authentication operations. It is appreciated in this embodiment of FIG. 9B that a terminal may turn ON a display unit [A] concurrently with one of the steps [A151] to [A153], steps [A161] to [A163], and the like or, alternatively, [B] prior to, concurrently with or after one of the steps [A152] to [A153], steps [A161] to [A163], and the like. In addition, a terminal may store “Result.,” obtained after the step [A151] and/or “Result₂” obtained after the step [A161], and the like. For simplicity of illustration, various receiving steps, displaying steps or storing steps are omitted in FIG. 9B. However, an exemplary sequence of this figure includes such steps as will be explained in the following disclosure.

Upon (or after) receiving (i.e., acquiring) a single first authentication (user) sub-input (UI_{THEN1}) (step [A150], a terminal also receives (i.e., acquires) a single second authentication (user) sub-input (UI_{THEN2}) (step [A160]). A terminal may then “run the 1^{st} authenticating” (step [A151]) and “run the 2^{nd} authenticating” (step [A161]) and then “execute the 1^{st} determining” (step [A152]). Depending on whether the result is a “pass” or a “fail,” the terminal “executes the 2^{nd} determining” (steps [A153] and [A163]), and then performs one of “Action₀₀,” “Action₀₁,” “Action₁₀” “Action₁₁.” It is appreciated that, unlike the sequence of FIG. 9A where results from multiple authentication operations are used sequentially, the terminal of this embodiment utilize results from multiple authentication operations rather in a parallel mode.

For example, as a user fails the 1^{st} and 2^{nd} authenticating (steps [A153] and [A163]) (i.e., an all-failing user at the step [A165]), a terminal may remain in its 1^{st} lock state and perform “Action₀₀,” where the 1^{st} and 2^{nd} subscripts “0” mean failing the 1^{st} and 2^{nd} authenticating. Thus, examples of “Action₀₀” may include keeping a display unit in its OFF state, switching the terminal to its INACTIVE state, turning ON a display unit to display a 1^{st} lock (or default) screen, a basic advertisement screen (SC_{ADB0}) or content screen (SC_{CTB0}), and the like.

It is appreciated that, although not shown in FIG. 9B, the terminal may turn ON its display unit at any step of the sequence of FIG. 9B. Accordingly, when the display unit has been turn ON and displaying an old screen before the step [A165], the terminal may take similar or different actions so that examples of “Action₀₀” may include, e.g., turning OFF a display unit, switching a terminal to its INACTIVE state, replacing or overlaying at least a portion of the old screen with a new screen (e.g., a 1^{st} lock screen, a default screen, a basic content screen such as CT_{B0} or CT_{B1}, a basic advertisement screen such as AD_{B0} or AD_{B1}, and the like), running at least one (predetermined) operation, and the like. Because the all-failing user has failed both of the 1^{st} and 2^{nd} authenticating, the terminal is typically in its lock state. Therefore, the terminal may allow the user to run a very limited number of operations, if any.

When a user passes the 2^{nd} authenticating (step [A163]) after failing the 1^{st} authenticating of the step [A152] (i.e., a 2nd-passing user of the step [A164]), a terminal may remain in its 1^{st} lock state or its 1^{st} unlock state, and perform “Action₀₁,” where the 1^{st} subscript “0” means failing the 1st authenticating, while the 2^{nd} subscript “1” means passing the 2^{nd} authenticating. In this respect, “Action₀₁” may be similar or identical to “Action₀₀” as described above. Alternatively, “Action₀₁” may be similar to “Action₀₀” in its type or nature, but may be more directed, detailed or personal than “Action₀ₒ,” for the 2nd-passing user who passes the 2^{nd} authenticating is at least a bit more qualified than the all-failing user. Accordingly, additional “Action₀₁” may include, e.g., turning on a display unit and display at least one screen (e.g., a default screen, a 2^{nd} lock screen, a 1^{st} home screen, AD_{B2}, AD_{B1} or AD_{B0}, CT_{B2}, CT_{B1} or CT_{B1}, and the like), running at least one (predetermined) operation, and the like, where such an operation may allow the user to access more (or the same amount of) data with more (or the same) “depths,” to use more (or the same number of) “options” with more “depth,” and the like.

A common feature between the all-failing user of the step [A165] and the 2^{nd}-passing user of the step [A164] is that they all failed the 1^{st} authenticating. But the difference therebetween is that the latter at least passed the 2^{nd} authenticating. Accordingly, it is proper to give a favor to the 2^{nd}-passing user in either the “depths” or “options” or both, regardless of the types or nature of “Action₀₀” and “Action₀₁,” although any favor given to “Action₁₀” may be adjusted or eradicated by the terminal or user as will be described below.

When a user fails the 2^{nd} authenticating (step [A163]) after passing the 1^{st} authenticating of the step [A152] (i.e., a 1^{st}-passing user of the step [A155]), a terminal may remain in its 1^{st} lock state and perform “Action₁₀,” where the 1^{st} subscript “1” means passing the 1^{st} authenticating, while the 2^{nd} subscript “0” mean failing the 2^{nd} authenticating. Therefore, “Action₁₀” is generally similar or identical to “Action₀₁.”

It is appreciated that a common feature between the 2^{nd}-passing user of the step [A164] and the 1^{st}-passing user of the step [A155]) is that they all passed only one of the 1^{st} and 2^{nd} authenticating. But the difference between the 2^{nd}-passing user and the 1^{st}-passing user is that the former failed the 1^{st} but passed the 2^{nd} authenticating, while the latter passed the 1^{st} but failed the 2^{nd} authenticating. Accordingly, giving a favor to the 1^{st}-passing user or the 2^{nd}-passing user in either the “depths” or “options” or both depends upon nature of such 1^{st} and 2^{nd} authentication operations, reliability of such 1^{st} and 2^{nd} authentication operations, difficulty of providing the authentication sub-inputs for the 1^{st} or 2^{nd} authentication operations, user preference to the 1^{st} and 2^{nd} authentication operations, extent of directedness, details or personal secrecy of authentication sub-inputs, an intention of the user, and the like.

When a user passes the 1^{st} as well as 2^{nd} authenticating (steps [A153] and [A163]) (i.e., an all-passing user at the step [A154]), a terminal switches to its 2^{nd} unlock state or its full unlock state and perform “Action₁₁,” where the 1^{st} and 2^{nd} subscripts “1” mean passing both of the 1^{st} and 2^{nd} authenticating. Accordingly, some examples of “Action₁₁” may include, e.g. turning ON a display unit and displaying a screen such as, e.g., a home screen, a directed advertisement screen (SC_{ADD}), a directed content screen (SC_{CTD}), and the like.

As described above, the terminal may turn ON its display unit at any step of the sequence of FIG. 9B. Accordingly, when the display unit has been turn ON and displaying an old screen before the step [A154], the terminal may take similar or different actions so that “Action₁₁” may be replacing or overlaying at least a portion of the old screen with a new screen (e.g., a home screen, a full unlock screen, a directed content screen (SC_{CTD}), a directed advertisement screen (SC_{ADD}), and the like), running at least one (predetermined) operation, and the like. Because the all-passing user has passed both of the 1^{st} and 2^{nd} authenticating, the terminal is typically in its unlock state and allow the user to access all (or almost) data stored in the terminal, to run all (or almost) operations stored therein, and the like.

As described above, “Action₀₀,” “Action₀₁,” “Action₀₀,” and “Action₁₁” are defined in such a relative sense that these actions generally refer to more directedness, more details or more personal secrecy in the above order. Thus, a user may access more data in the order of “Action₀₀,” “Action₀₁,” “Action₀₀,” and “Action₁₁” in general and that a user may generally access such data in a greater “depth” in the same order. In addition, a user may also run a greater number of (software) applications in the same order and that such a user may also be able to use more “options” while running such applications in the same order.

However, the terminal (or user) may adjust different favors given to each of “Action₀₀,” “Action₀₁,” “Action₀₀,” and “Action₁₁” as it sees fit. As a result, the types and extents of “depths” of data accessible to a user of such a terminal may be different from the case in the preceding paragraphs. In addition, the types and number of “options” given to a user in running an application may also be different therefrom.

In one example, a terminal may treat “Action₀₀” (i.e., the all-failing user) and “Action₀₁” (i.e., the 2^{nd}-passing user) equally. This example may apply when the terminal (or user) regards the 1st authenticating as the most important operation for identifying an authorized user and, therefore, a user who failed the 1^{st} authenticating should be treated the same anyway, regardless of whether or not he or she passed the 2^{nd} authenticating. Similarly, the terminal may treat “Action₀₀” (i.e., the all-failing user) and “Action₁₀” (i.e., the 1^{st}-passing user) equally, particularly when a terminal (or user) regards the 2^{nd} authenticating as the most important operation for identifying an authorized user and, therefore, a user who failed the 2^{nd} authenticating should be treated the same anyway regardless of whether or not he or she passed the 1^{st} authenticating.

In a related example, even when the 1^{st} (or 2^{nd}) authenticating may be the most important user identification operation, a terminal may give a limited favor to a user who failed the 1^{st} (or 2^{nd}) authenticating but passed a less important 2^{nd} (or 1^{st}) authenticating. Accordingly, the terminal may allow the 2^{nd}-passing (or 1^{st}-passing) user to access some data with certain “depths” and/or to run a certain number of operations with certain “depths” or “options,” and the like. It is appreciated that such a comparison is between the 2^{nd}-passing (or 1^{st}-passing) user and the all-failing user only. Accordingly, the all-passing user who is given the most favor by the terminal may generally access more data with more “depths,” may generally run more applications with more “depths” and “options,” and the like. It is noted that the rational explained in this paragraph may be deemed as a “degrading rational” or “downgrading rational” in that the terminal does not give any favor at all (or gives only a minimum favor) to a user when he or she fails an important authentication operation.

In an opposite example, a terminal may treat “Action₁₀” (i.e., the 1^{st}-passing user) and “Action₁₁” (i.e., the all-passing user) equally in an opposite sense. This example may apply when the terminal (or user) regards the 1^{st} authenticating as the most important operation for identifying an authorized user and, therefore, passing or failing the 2^{nd} authenticating should not be given a great weight (or gives only a minimum favor). Similarly, the terminal may treat “Action₀₂” (i.e., the 2^{nd}-passing user) and “Action₁₁” (i.e., the all-passing user) equally, particularly when a terminal (or user) regards the 2^{nd} authenticating as the essential operation for identifying an authorized user and, therefore, a user who passed the 2^{nd} authenticating should be treated the same (or almost the same) regardless of whether or not a user passed the 1^{st} authenticating.

In a related example, even when the 1^{st} (or 2^{nd}) authenticating may be the most important user identification operation, a terminal may still give a limited favor to a user who failed the 1^{st} (or 2^{nd}) authenticating but passed a less important 2^{nd} (or 1^{st}) authenticating. Accordingly, such a terminal may allow the 2^{nd}-passing (or 1^{st}-passing) user to access some data with certain “depths” or to run a certain number of operations with certain “depths” or “options,” and the like. It is appreciated that such a comparison is between the 1^{st}-passing (or 2^{nd}-passing) user and the all-passing user only. Accordingly, the all-passing user who is given the most favor by the terminal may generally access more data with more “depths,” may generally run more applications with more “depths” and “options,” and the like. Accordingly, the rational explained in this paragraph may be deemed as a “upgrading rational” in that the terminal gives all (or not all but a maximum) favor to a user when he or she passes an important authentication operation.

Therefore, it is emphasized again that distinctions among “Action₀₀,” “Action₀₁,” “Action₁₀,” and “Action₁₁” may be relative in nature and that such distinctions are not necessarily in such an order. In an extreme example, a terminal may classify such criteria into only two categories such as [A] an all-passing category (Action₁₁ only) and a not-all-passing category (Action₀₀, Action₀₁, and Action₁₀), [B] an all-failing-category (Action₀₀ only) in contrast to a not-all-failing category (Action₀₁, Action₁₀, and Action₁₁), [C] the whatever-1^{st}-passing category (Action₁₀ and Action₁₁) contrary to the whatever-1^{st}-failing category (Action₀₀ and Action₀₁), [D] the whatever-2^{nd}-passing category (Action₀₁ and Action₁₁) and the whatever-2^{nd}-failing category (Action₀₀ and Action₁₀), and the like.

By the same token, the terminal may classify such criteria into a single category, into three categories or, alternatively, may sub-classify such criteria into five or more sub-categories, and the like. Of course the terminal (or user) may assign various “depths” of data and various “options” and “depths” of an application to each of such criteria (e.g., Action₀₀, Action₀₁, Action₁₀, and Action₁₁) so that a user may enjoy more “depths” and “options” in the order exemplified in this sentence or in other orders as it sees fit.

The terminal of FIG. 9B may also operate according to other arrangements or sequences which correspond to variations or modifications of the aforementioned arrangements.

Various terminals of this embodiment aim to provide seamless operations to a user with a reasonable speed such that the user does not have to wait for the terminal to spend too much time. Therefore, the terminal may finish “running the 1^{st} and 2^{nd} authenticating” (steps [A151] and [A161]) as well as “executing the 1^{st} and 2^{nd} determining” (steps [A152], [A153]) within a reasonable period, thereby preventing a hold-up which happens when the user has to wait for the terminal to finish such authenticating and/or executing.

Various operational sequences of this exemplary embodiment may correspond to cases where the screen displayed on a display unit does not require a user to react thereto, e.g., by providing at least one UI_{AUX} or by performing an active or passive task. When the screen requires the user to react thereto, a user may have to provide UI_{AUX} and then finish reacting to the screen for proceeding to a next step of operation. When a user provides UI_{AUX} after providing UI_{THEN1} or UI_{THEN2} but before “executing 1^{st} or 2^{nd} determining,” however, the user may have to provide another UI_{THEN1} or UI_{THEN2} after the user is done with reacting to the screen, which is not convenient to the user. To obviate such a problem, the terminal may store “Result₁,” or “Result₂” as explained above, then retrieve such when the user is done with reacting to the screen, and use such in running the authentication operation. Thus, the terminal may continue to provide the seamless features to the user.

The terminals of this exemplary embodiment may allow a user to reach multiple lock states or unlock states depending on the results from the 1^{st} and/or 2^{nd} authentication operations. For example, the all-failing user of the step [A165] may be in a 1^{st} lock state, while the 2nd-passing user of the step [A164] may be in the same 1^{st} lock state or in a 2^{nd} lock state, a 1^{st} unlock state, and the like, where such “depths” or “options” allowed to the user in such lock or unlock states may differ as explained in the six preceding paragraphs. In addition, the 1^{st}-passing user of the step [A155] may be in the above 1^{st} or 2^{nd} lock state or in a different 3^{rd} lock state, may be in the above 1^{st} unlock state or in a different 2^{nd} unlock state, while the all-passing user of the step [A154] may be in the above 1^{st} or 2^{nd} unlock state or in a different 3^{rd} unlock state. The terminal (or user) may also assign various “depths” of data or various “options” and “depths” of a (software) application to each of such states (e.g., 1^{st}, 2^{nd} or 3^{rd} lock state, 1^{st}, 2^{nd} or 3^{rd} unlockstate, and the like) such that a user may enjoy more “depths” and “options” in the order exemplified in this sentence or in other orders as it sees fit.

As described in FIG. 9A, various unlock or lock states (e.g., Action₀₀, Action₀₁, Action₁₀, and Action₁₁) may be arranged in a hierarchical order such that an unlock (or lock) state with less “depth” and less “options” may be deemed as a subset of another unlock (or lock) state with more “depth” and more “options” so that the unlock (or lock) state with less “depth” or less “options” may be deemed as a small circle an entire portion of which is enclosed by a larger circle corresponding to another unlock (or lock) state with more “depth” or more “options.” Alternatively, such unlock or lock states may be arranged in the parallel relationship such that an unlock (or lock) state with less “depth” and less “options” is not necessarily a subset of another unlock (or lock) state with more “depth” and more “options.” Therefore, the terminal may allow a user to customize what kind (or what type) of data and in how much “depth” the user may access in each unlock (or lock) state, what kind (or what type) of operations and with how many “options” the user may run in each of such states, and the like.

Although now shown in the figure, the terminal may incorporate additional authentication operations in order to run the 3^{rd}, 4^{th} or 5^{th} authentication operation. The terminal may arrange its operation sequence in such a way that each additional authentication operation may be run concurrently with or after running the 1^{st} or 2^{nd} authentication operation. Based on their operational features or mechanisms, such additional authentication operations may require the user to provide appropriate authentication (user) sub-inputs, and the terminal may receive such authentication (user) sub-inputs in various sequences as described above. In addition, the above “downgrading rational” or “upgrading rational” may be applied to each of such multiple authentication operations or to only a portion of such multiple authentication operations.

The terminal may also include various software or hardware security means for guaranteeing both seamless and secure operations to the user. To this end, a terminal may include various hardware or software features (e.g., one or more of the 1^{st}, 2^{nd}, 3^{rd}, and 4^{th} applications described above) as have been described in FIG. 2A. More particularly, when a (software) application performing Action₀₀, Action₀₁, Action₁₀ or Action₁₁ and displaying various screens is the one downloaded from an external source, the terminal may completely or conditionally block the application from accessing a (main) memory or library of the terminal, thereby enhancing security of the terminal.

The terminal may give an option to a user to deactivate one of the authentication operations. Accordingly, a user may deactivate the 2^{nd} authenticating (step [A161]) and the 2^{nd} determining (steps [A153] and [A163]) so that the terminal is reduced to those terminals with a single authentication operation as exemplified from FIG. 2A to FIG. 8D. In the alternative, a user may deactivate the 1^{st} authenticating (step [A151]) and the 1^{st} determining (step [A152]) so as to reduce the operational sequence similar to those of the terminals as exemplified from FIG. 2A to FIG. 8D.

Other configurational or operational variations (or modifications) of such terminals described in conjunction with FIG. 9B are similar to those illustrated in various exemplary aspects or embodiments of this disclosure. Therefore, each feature of the above examples of FIG. 9B of this eighth exemplary aspect of this disclosure may be applied to, may be incorporated into, may be replaced by, may replace, and/or may be combined with [A] corresponding features of FIG. 9B or [B] other embodiments and their examples which have been described heretofore and are to be disclosed hereinafter, including various aspects and embodiments of various objectives as described in the “Summary of the Invention.”

FIG. 9C is a block diagram illustrating another exemplary embodiment of this eighth aspect of this disclosure, where a terminal employs two authentication operations (steps [A201] and [A211]) and where the terminal performs certain actions such as “Action_{0X},” “Action_{0X},” and “Action₁₁,” depending on the results of the 1^{st} or 2^{nd} authentication operations. It is appreciated in this embodiment of FIG. 9C that a terminal may turn ON a display unit [A] concurrently with one of the steps [A201] to [A205], steps [A211] to [A215], and the like or [B] prior to, concurrently with or after one of the steps [A202] to [A205], steps [A212] to [A215], and the like. Such a terminal may store “Result₁,” obtained after the step [A201] or step [A202] or “Result₂” obtained after the step [A211] or step [A212], and the like. For simplicity of illustration, various receiving steps, displaying steps or storing steps are omitted in FIG. 9C. However, an exemplary sequence of this figure includes such steps as will be explained in the following disclosure.

For example, a terminal may receive (i.e., acquire) a single 1^{st} authentication (user) sub-input (UI_{THEN1}) (step [A200] and referred to as the “1^{st} receiving”) and another single 2^{nd} authentication (user) sub-input (UI_{THEN2}) (step [A210] and referred to as the “2^{nd} receiving”), where one or both of UI_{THEN1} and UI_{THEN2} include at least one activation (user) sub-input (UI_{ACT}). In response thereto, a terminal switches to its ACTIVE state, “runs the 1^{st} and 2^{nd} authenticating” (steps [A201] and [A211]), and then “executes the 1^{st} and 2^{nd} determining” (steps [A202], [A212], and [A214]), all in response to a pair of authentication sub-inputs UI_{THEN1} and UI_{THEN2}.

It is appreciated that a terminal may execute a 1^{st} pair of the 1^{st} and 2^{nd} receiving in parallel (i.e., concurrently with each other) or in series (i.e., sequentially or one after the other), may execute a 2^{nd} pair of the 1^{st} and 2^{nd} authenticating in parallel or in series, and/or a 3^{rd} pair of the 1^{st} and 2^{nd} determining in parallel or in series. As a result, depending on exact timings of operating such 1^{st}, 2^{nd}, and 3^{rd} pairs, the terminal may execute the 1^{st} authenticating (step [A201]) after the 2^{nd} determining (step [A214]) or, alternatively, may perform the 2^{nd} authenticating (step [A211]) after the 1^{st} determining (step [A202]). In addition, such a terminal may acquire UI_{THEN1} concurrently with UI_{THEN2}, but may “run the 1^{st} and 2^{nd} (or 2^{nd} and 1st) authenticating” sequentially or may “execute the 1^{st} and 2^{nd} determining” sequentially. Such a terminal may also acquire UI_{THEN1} and UI_{THEN2} sequentially, but “runs the 1^{st} and 2^{nd} authenticating” at the same time (i.e., concurrently), “executes the 1^{st} and 2^{nd} determining” concurrently, and the like. In other words, even if each step of the 1^{st} sequence (i.e., from the steps [A200] to [A204]) may look to be executed at the same time with each matching step of the 2^{nd} sequence (i.e., from the steps [A210] to [A214]) in the figure (i.e., the steps [A200] and [210] that match each other, the steps [A203] and [A213] which match each other, and the like), the terminal does not have to execute them at the same time. Rather, as long as the terminal performs the 1^{st} and 2^{nd} sequences in parallel, the constituent steps of each sequence may be executed at different timing.

Regarding the “1^{st} sequence of operations” (i.e. from the steps [A201] to [A205]), when the user fails the 1^{st} authenticating, the terminal performs “Action_{0X}” (step [A203]), where details of “Action_{0X}” have been provided in FIG. 9A. Thereafter, the terminal proceeds to the step [A204] and then may turn its display unit OFF or switch to its INACTIVE state. When the user passes the 1st authenticating, such a terminal proceeds to the step [A205] and performs “Action_{0X},” where the 1^{st} subscript “1” means passing the 1^{st} authentication, whereas the 2^{nd} subscript “X” means that the terminal does not need to run the 2^{nd} authenticating. The terminal may then perform “Action_{0X}” examples of which are similar or identical to “Action₁₁” of FIGS. 9A and 9B or, alternatively, to “Action₁₀” of FIGS. 9A and 9B, “Action₀₁” of FIG. 9B, and the like.

Regarding the “2^{nd} sequence of operations” (i.e. from the steps [A211] to [A215]), when a user fails the 2^{nd} authenticating, a terminal proceeds to the step [A213] and then may turn its display unit OFF, switch itself to its INACTIVE state, display a default screen or a lock screen, and the like. When the user passes the 2^{nd} authenticating, the terminal checks whether or not a user passes the 1^{st} authenticating (step [A214]). When the user fails the 1^{st} authenticating, the terminal proceeds to the step [A204] and may run the same operation as the step [A204]. When the user passes the 1st authenticating, the terminal may then perform “Action₁₁” examples of which are similar or identical to “Action₁₁” of FIGS. 9A and 9B.

The terminal of this exemplary embodiment of this eighth aspect carries a few features different from other terminals described heretofore and hereinafter. As to the first feature, such a terminal may execute a pair of sequences of operations in parallel or independently. Thus, the terminal may execute equivalent or parallel steps of such sequences (e.g., steps [A201] vs. [A211], steps [A202] vs. [A212], steps [A204] vs. [A213], at the same time or at different timings.

As to the second feature, such a terminal may execute at least one of such sequences completely or at least partially independent from the other sequence, from any result obtained by such a sequence, and the like. For example and as manifest in FIG. 9C, the terminal may execute the 1st sequence of operations (i.e. from the steps [A201] to [A205]) completely independent of the 2^{nd} sequence or any results therefrom. However, the terminal may not execute the 2^{nd} sequence of operations (i.e. from the steps [A211] to [A215]) completely independent of the 1^{st} sequence, because the 2^{nd} sequence includes the step [A214] where the terminal has to check whether the user passes the 1^{st} authenticating.

The terminal may use this arrangement when one authentication operation may be deemed more important than another authentication operation. In the above example, the terminal deems the 1st authenticating more important than the 2^{nd} authenticating so that, as manifest in the 1^{st} sequence of operations of FIG. 9C, the terminal may perform “Action_{1X}” [A] regardless of the results from the 2^{nd} authenticating or [B] even without running the 2^{nd} authenticating. In this respect, such an arrangement may be deemed to be a type of the “upgrading rationale” as defined above.

The terminal of FIG. 9C may also operate according to other arrangements or sequences which correspond to variations or modifications of the aforementioned arrangements.

Various terminals of this embodiment aim to provide seamless operations to a user with a reasonable speed such that the user does not have to wait for the terminal to spend too much time. Therefore, the terminal may finish the 1^{st} sequence, i.e., “running the 1^{st} authenticating” (step [A201]) and “executing the 1^{st} determining” (step [A202]) within a reasonable period, and may also optionally finish the 2^{nd} sequence, i.e., “running the 2^{nd} authenticating” (step [A211]) and “executing the 2^{nd} determining” (step [A212]) within a reasonable period, thereby preventing or minimizing a hold-up of operations of the terminal.

The terminal may be arranged to omit the step [A203] such that the terminal stops operation when the user fails the 1^{st} authenticating. Alternatively, the 2^{nd} operational sequence may include an additional step similar to the step [A203] between the steps [A212] and [214] such that the terminal may display a certain screen or run at least one (predetermined) operation.

Various operational sequences of this exemplary embodiment may correspond to cases where the screen displayed on a display unit does not require a user to react thereto. When the screen requires the user to react thereto, a user may have to provide UI_{AUX} and finish reacting to the screen in order to proceed to a next step of operation. When a user provides UI_{AUX} after providing UI_{THEN1} or UI_{THEN2} but before “executing 1^{st} or 2^{nd} determining,” however, the user may have to provide another UI_{THEN1} or UI_{THEN2} after the user is done with reacting to the screen. The terminal may store “Result₁” or “Result₂” as explained above and obviate such a problem, thereby providing the seamless features to the user.

The terminals of this exemplary embodiment may allow a user to reach multiple lock states or unlock states depending on the results from the 1^{st} or 2^{nd} authentication operation. Thus, the terminal performs “Action_{0X}” for a 1^{st}-failing user of the step [A203], “Actionₓₒ” for a 2nd-failing user of the step [A213], “Action_{1X},” for a 1^{st}-passing user of the step [A205] or “Action₁₁” for an all-passing user of the step [A215] while providing one of multiple lock states or unlock states as described in FIG. 9B.

It is appreciated that the terminal generally gives more favor to “Action₁₁” than “Action_{1X},” for the latter user is the one who passes both of the 1^{st} and 2^{nd} authenticating, while the former user passes the 1^{st} authenticating only. However, when the terminal adopts an operational sequence of the “upgrading rationale” based on the 1^{st} authenticating, such a terminal may give the same favor to both of “Action₁₁” and “Action_{1X}” or may give more favor to “Action₁₁” than “Action_{1X}.”

As appreciated above, the sequence of this figure may be deemed as the “upgrading rationale” based on the 1^{st} authentication operation. For example, when the step [A214] is removed from the 2^{nd} sequence of the figure, the 2^{nd} sequence may be deemed as the “upgrading rationale” based on the 2^{nd} authentication operation. Such a sequence may also be altered into the “downgrading rationale” based on the 1^{st} or 2^{nd} authentication operation.

Although now shown in the figure, the terminal may incorporate additional authentication operations in order to run the 3^{rd}, 4^{th} or 5^{th} authentication operation where the terminal may run such an operation concurrently with or after running the 1^{st} or 2^{nd} authentication operation as described above, where further details of such terminals have been described above.

Various terminals of this exemplary embodiment may include various software or hardware security means for guaranteeing seamless and secure operations to the user. The terminal may include various hardware or software features (e.g., one or more of the 1^{st}, 2^{nd}, 3^{rd} and 4^{th} applications described above) as have been described in FIG. 2A.

The terminal may give an option to a user to deactivate one of the authentication operations. Accordingly, a user may deactivate the 2^{nd} authenticating (step [A211]) and the 2^{nd} determining (step [A212]) such that the terminal is reduced to those terminals with a single authentication operation as exemplified from FIG. 2A to FIG. 8D. In the alternative, a user may deactivate the 1st authenticating (step [A201]) and the 1^{st} determining (steps [A202] and [A214]) so as to reduce the operational sequence similar to those of the terminals as exemplified from FIG. 2A to FIG. 8D.

Other configurational or operational variations (or modifications) of such terminals described in conjunction with FIG. 9C are similar to those illustrated in various exemplary aspects or embodiments of this disclosure. Therefore, each feature of the above examples of FIG. 9C of this eighth exemplary aspect of this disclosure may be applied to, may be incorporated into, may be replaced by, may replace, and/or may be combined with [A] corresponding features of FIG. 9C or [B] other embodiments and their examples which have been described heretofore and are to be disclosed hereinafter, including various aspects and embodiments of various objectives as described in the “Summary of the Invention.”

FIG. 9D is a block diagram illustrating another exemplary embodiment of this eighth aspect of this disclosure, where a terminal employs two authentication operations (steps [A251] and [A261]) and where the terminal performs certain actions such as “Action₀₀,” “Action₀₁,” “Action₁₀,” and “Action₁₁,” depending on the results of the 1^{st} or 2^{nd} authentication operations. It is appreciated in this embodiment of FIG. 9D that a terminal may turn ON a display unit [A] concurrently with one of the steps [A251] to [A254], steps [A261] to [A264], and the like or [B] prior to, concurrently with or after one of the steps [A252] to [A254], steps [A262] to [A264], and the like. Such a terminal may store “Result₁” obtained after the step [A251] or step [A252] or “Result₂” obtained after the step [A261] or step [A262]. For simplicity of illustration, various receiving steps, displaying steps or storing steps are omitted in FIG. 9D. However, an exemplary sequence of this figure includes such steps as will be explained in the following disclosure.

For example, a terminal may receive a single 1^{st} authentication sub-input (UI_{THEN1}) (step [A250] and referred to as the “1^{st} receiving”) and another single 2^{nd} authentication sub-input (UI_{THEN2}) (step [A260] and referred to as the “2^{nd} receiving”), where at least one of UI_{THEN1} and UI_{THEN2} includes at least one activation sub-input (UI_{ACT}). In response thereto, a terminal switches to its ACTIVE state, “runs the 1^{st} and 2^{nd} authenticating” (steps [A251] and [A261]), and then “executes the 1^{st} and 2^{nd} determining” (steps [A252], [A264], [A262], and [A254]), all in response to a pair of authentication sub-inputs UI_{THEN1} and UI_{THEN2}.

Similar to the terminal of FIG. 9C, the terminal of this figure performs the 1^{st} pair of the 1^{st} and 2^{nd} receiving in parallel, runs the 2^{nd} pair of the 1^{st} and 2^{nd} authenticating in parallel, executes the 3^{rd} pair of the 1^{st} and 2^{nd} determining in parallel, executes the 4th pair of the 1^{st} and 2^{nd} determining in parallel, and the like. Unlike the terminal of FIG. 9C, however, the terminal of FIG. 9D includes a 1^{st} branching of the steps [A252] and [A262] which merge into the step [A253], and a 2^{nd} branching of the steps [A254] and [A264] which merge into the step [A256]. Accordingly, the terminal generally executes the steps of the above 1^{st} pair, 2^{nd} pair, 3rd pair or 4th pair relatively at the similar time, i.e., the terminal may execute one step of a certain pair prior to another step of that pair, but not necessarily after the steps of the subsequent pairs.

Regarding the 1^{st} sequence of operations (i.e. from the steps [A251] to [A255]), when the user fails the 1^{st} authenticating, the terminal proceeds to the step [A253] and awaits results from the 2nd authenticating. When the user also fails the 2^{nd} authenticating, the terminal performs “Action₀₀” [A] which is similar or identical to “Action₀₀” of FIG. 9B or [B] which may be similar or identical to “Action_{0X}” of FIG. 9A or 9C. When the user passes the 1^{st} authenticating, the terminal proceeds to the step [A254]. When the user also passes the 2^{nd} authenticating, the terminal performs “Action₁₁” [A] which is similar or identical to “Action₁₁” of FIGS. 9A to 9C, [B] which may be similar or identical to “Action₁₀” or “Action₀₁” of FIG. 9B, or [C] which may be similar or identical to “Actionᵢₓ” of FIG. 9C. However, when the user who passes the 1^{st} authenticating fails the 2^{nd} authenticating, the terminal performs “Action₁₀” [A] which is identical to “Action₁₀” of FIGS. 9A and 9B or [B] which may be similar or identical to “Action₀₁” of FIG. 9B or “Actionᵢₓ” of FIG. 9C.

Regarding the 2^{nd} sequence of operations (i.e. from the steps [A261], [A262], [A264] and [A265]), when a user fails the 2^{nd} authenticating, a terminal proceeds to the step [A253] as explained above. When the user passes the 2^{nd} authenticating, the terminal checks whether or not a user passes the 1^{st} authenticating (step [A264]). When the user fails the 1^{st} authenticating, the terminal may proceed to the step [A265] and perform “Action₀₁” [A] which is similar or identical to “Action₀₁” of FIG. 9B or [B] which may be similar or identical to “Action_{0X}” of FIGS. 9A and 9C.

The terminal of FIG. 9D may also operate according to other arrangements or sequences which correspond to variations or modifications of the aforementioned arrangements.

Various terminals of this embodiment aim to provide seamless operations to a user with a reasonable speed such that the user does not have to wait for the terminal to spend too much time. Therefore, the terminal may finish the 1^{st} sequence, i.e., “running the 1^{st} authenticating” (step [A251]) and “executing the 1^{st} determining” (step [A252] and optionally step [A262]) within a reasonable period, and may also optionally finish the 2^{nd} sequence, i.e., “running the 2^{nd} authenticating” (step [A261]) and “executing the 2^{nd} determining” (step [A262]) within a reasonable period, thereby preventing or minimizing a hold-up of operations of the terminal.

Although now shown in the figure, the terminal may incorporate additional authentication operations in order to run the 3^{rd}, 4^{th} or 5^{th} authentication operation, where the terminal may run such an operation concurrently with or after running the 1^{st} or 2^{nd} authentication operation as described above, where further details of such terminals have been described above. Conversely, the terminal may give an option to a user to deactivate one of the authentication operations details of which have been described above.

Various terminals of this exemplary embodiment may include various software or hardware security means for guaranteeing seamless and secure operations to the user. The terminal may include various hardware or software features (e.g., one or more of the 1^{st}, 2^{nd}, 3^{rd} and 4^{th} applications described above) as have been described in FIG. 2A.

Other configurational or operational variations (or modifications of such terminals described in conjunction with FIG. 9D are similar to those illustrated in various exemplary aspects or embodiments of this disclosure. Therefore, each feature of the above examples of FIG. 9D of this eighth exemplary aspect of this disclosure may be applied to, may be incorporated into, may be replaced by, may replace, and/or may be combined with [A] corresponding features of FIG. 9D or [B] other embodiments and their examples which have been described heretofore and are to be disclosed hereinafter, including various aspects and embodiments of various objectives as described in the “Summary of the Invention.”

It is noted that a programmer of various terminals of this eighth exemplary aspect may enjoy a great freedom in designing operational sequences of such terminals, where a “sequence” refers to a series of consecutive steps when focusing on each authentication operation and where an exemplary “sequence” of a fingerprint authentication operation may include the steps of receiving a fingerprint as a single authentication (user) sub-input, running an authenticating based on the fingerprint, executing the determining based on the results from such authenticating, and the like. However, when a terminal includes multiple authentication operations while receiving as many authentication (user) sub-inputs and while optionally displaying various screens on its display unit, the programmer may need a strategy in order to efficiently run such authentication operations while guaranteeing both seamless and secure operations. A few examples of such strategies may include, but not limited to, a “series sequence,” a “parallel sequence,” a “hybrid sequence,” a “branching,” and the like.

In general, a “series sequence of operations” includes multiple authentication operations connected in series and, therefore, a terminal employing such a series sequence tends to run multiple authentication operations consecutively. Accordingly, each of multiple series authentication operations tends to depend on each other, for passing or failing a 1^{st} authentication operation may affect what kind of operations a terminal may run as the terminal passes or fails a next authentication operation.

To the contrary, a “parallel sequence of operations” may include multiple authentication operations which are connected “in parallel.” Thus, a terminal which employs a parallel sequence may run multiple authentication operations concurrently with each other. As a result, each authentication operation tends to be independent of other authentication operations, for passing or failing a 1^{st} authentication operation does not affect another authentication operation to be executed in a parallel branch.

An alternative to the above series sequence and parallel sequence is a “hybrid sequence” in which steps for the 1^{st} authentication operation may be mixed with steps for the 2^{nd} authentication operation, and the like. In one example, a 1^{st} sequence may include the 1^{st} receiving, 1^{st} authenticating, 2^{nd} determining, and the like, while a 2^{nd} sequence may include the 2^{nd} receiving, 2^{nd} authenticating, 1^{st} determining and the like. Although the hybrid sequence offers a great flexibility in structuring detailed operation, resulting (software) application may be complicated and sometimes difficult to figure out.

Accordingly, an alternative to the “hybrid sequence” is to employ at least one “branch” (i.e., cross-checking) which may directly or indirectly link at least one step of the 1^{st} sequence to another step of another sequence. Because such a “branch” may be added and removed relatively easily, utilizing such “branches” offers the benefits of providing flexibility to the operational sequences as well as maintaining an overall structure or a backbone of a source code.

For example, the terminal of FIG. 9A operates along a single main sequence which includes the steps [A101], [A102], [A104], and [A105]. Such a sequence is a typical series sequence of operations in which the terminal runs two authentication operations consecutively. Similarly, the terminal of FIG. 9B operates along another single main sequence which includes [A151], [A161], and [A152] and which is another series sequence of operations. Because each main sequence of such terminals of FIGS. 9A and 9B may deemed as a single line, there is no “branching” or “cross-checking” with another main branch.

In contrary, the terminal of FIG. 9C operates along a pair of main sequences of operations, where the 1^{st} sequence includes the steps [A201] to [A205]), while the 2^{nd} sequence includes the steps [A211] to [A215]). In addition, the 1^{st} and 2^{nd} sequences are independent of each other, except a single link between the steps [A214] and [A204]. Accordingly, the operational sequence of the terminal of FIG. 9C may be deemed as a parallel sequence with a minimum branching (i.e., cross-checking). The terminal of FIG. 9D also operates along a pair of main sequences of operations, where the 1^{st} sequence includes the steps [A251], [A252], [A254], and [A255], while the 2^{nd} sequence includes the steps [A261], [A262], [A264], and [A265]. In addition, the 1^{st} and 2^{nd} sequences are linked to each other at the steps [A253] and [A256]. Therefore, the operational sequence of the terminal of FIG. 9D may be deemed as a parallel sequence with a moderate branching.

Each of the “series sequence,” the “parallel sequence,” the “hybrid sequence,” and a sequence including at least one “branch” offers pros and cons to the user, whereas such a sequence with a heavy branching (i.e., a sequence with “multiple branches”), a moderate branching (i.e., a sequence with about “several branches”), a minimum branching (i.e., a sequence with “a few branches” at most) or no branching (i.e., a sequence with “no branch”) also offers pros and cons to the user. Therefore, when determining which sequence to use and how many branches to include, the programmer may consider several following factors.

As discussed above, a “series sequence” operates by running multiple operations consecutively, generally in a step-by-step mode. Accordingly, multiple authentication operations in the series sequence tend to depend on each other. Accordingly, a programmer may employ such a “series sequence” in general when he or she desires to give more favor gradually as the user passes more authentication operations, i.e., to give the user a favor extent of which is commensurate with the number of authentication operations he or she passes.

In addition, the above “series sequence” may be suitable when the terminal allows the user to access more data or to access the same number of (or more) data with greater “depths,” particularly when different sets of data or different “depths” of data provided to the user passing different number of authentication operations tend to overlap each other.

For example, as the user passes the 1^{st} authenticating, the terminal allows him or her to access a 1^{st} data set. As the user passes the 2^{nd} authenticating, the terminal then allows him or her to access a 2^{nd} data set which is larger than the 1^{st} data set and which tends to include the 1^{st} data set therein (e.g., the 1^{st} data set may be a small circle which is enclosed by a larger circle corresponding to the 2^{nd} data set). Because such a user already has an access to the 1^{st} data set, the terminal may not have to provide the user with an access to the entire 2^{nd} data set. Instead, the terminal may only have to provide the user with marginal data which belong to the 2^{nd} data set but do not belong to the 1^{st} data set. The terminal may also utilize the above arrangement when the terminal may allow the user to use a greater number of (software) applications or to use the same (or a greater) number of applications with more “options” as the user passes more authentication operations. Therefore, the terminal based on this arrangement may not have to prepare a great number of overlapping data sets, thereby obviating any inefficiency resulting therefrom and ensuring an efficient use of the memory of the terminal.

In contrary, a “parallel sequence” operates by running multiple operations concurrently, typically along multiple separate sequences. Accordingly, multiple authentication operations in the parallel sequence tend to not depend on each other, and a programmer may generally resort to such a “parallel sequence” when he or she desires to ensure an individual role of each (or at least two) authentication operations, while giving the user a favor extent of which is commensurate with the number of authentication operations he or she passes.

In addition, the above “parallel sequence” may be suitable when the terminal allows the user to access more data or to access the same number of (or more) data with greater “depths,” particularly when different sets of data or different “depths” of data provided to the user passing different number of authentication operations tend to not overlap each other, tend to be of different types, tend to be different in their nature, and the like.

For example, as the user passes the 1^{st} authenticating, the terminal allows him or her to access a 1^{st} data set. As the user passes the 2^{nd} authenticating, the terminal then allows him or her to access a 2^{nd} data set at least a portion of which is different from the 1^{st} data set (e.g., the 1^{st} and 2^{nd} data sets may be circles which have the same or different sizes and each of which includes a non-overlapping portion). Accordingly, even though the user already has an access to the 1^{st} data set, the terminal may provide the user with an access to the entire 2^{nd} data set, for an overlapping portion between the 1^{st} and 2^{nd} data sets may be only a small portion of the 1^{st} or 2^{nd} data set. In addition, the terminal may utilize such an arrangement when the terminal allows the user to use a greater number of applications or to instead use the same (or a greater) number of applications with more “options” as the user passes more authentication operations. Therefore, the terminal operating on the above arrangement may be arranged to prepare different sets of non-overlapping (or at most minimally overlapping data), thereby providing diverse sets of data while ensuring a structured and efficient use of the memory of the terminal.

In the ninth exemplary aspect of this disclosure, a terminal employs multiple authentication operations while guaranteeing a user with seamless as well as secure operations of advertising. To this end, a terminal may employ any of the above examples of the eighth exemplary embodiment while incorporating various detailed steps thereto. FIGS. 10A to 10D are block diagrams illustrating various embodiments of this ninth exemplary aspect of various terminals, methods, and operation sequences of this disclosure. It is appreciated that all terminals of exemplary embodiments of FIGS. 10A to 10D allow a user to get to an unlock state by providing only a pair of authentication (user) sub-inputs.

FIG. 10A is a block diagram illustrating an exemplary embodiment of this ninth aspect of this disclosure, where a terminal employs two authentication operations (steps [12] and [114]) and displays various screens such as, e.g., SC_{FAIL}, SC_{PASS1} or SC_{PASS2}, depending on the results of the 1^{st} or 2^{nd} authentication operations. It is appreciated that FIG. 10A may be deemed as a detailed example of FIG. 9A, where “Action_{0X},” “Action₁₀,” and “Action₁₁” of FIG. 9A roughly correspond to displaying SC_{FAIL}, SC_{PASS1}, and SC_{PASS2}, respectively, where such “Actions” and resulting screens are generally different from one another, although at least two of such “Actions” or screens may be similar or identical to each other. It is also appreciated that the sequence of FIG. 10A may be deemed as a “series sequence” with no branching (i.e., a sequence with “no branch”) as well.

For example, a terminal receives (i.e., acquires) a user input (UI₁) which accompanies a single authentication (user) sub-input (UI_{THEN1}) along with at least one activation (user) sub-input (UI_{ACT}) from a user (step [11]), while its display unit is in its OFF state. Upon (or after) receiving UI_{THEN1} and UI_{ACT}, the terminal may activate itself, “run the 1^{st} authenticating” (step [12]), and “execute the 1^{st} determining” (step [13]).

When the user fails the 1^{st} authentication operation, the terminal displays SC_{FAIL} (step [15]), where examples of SC_{FAIL} may include, e.g., a basic advertisement screen (SC_{ADB0}), a basic content screen (SC_{CTB0}), a warning, an instruction, a 1^{st} lock screen or other screens as described in other embodiments. Alternatively, instead of displaying SC_{FAIL}, the terminal may switch itself to its inactive state, keep the display unit in its OFF state, or run another operation, as described in other embodiments.

When the user passes the 1^{st} authentication operation, however, the terminal displays SC_{PASS1} (step [14]), where examples of SC_{PASS1} may include, e.g., a directed advertisement screen (SC_{AD0}), a directed content screen (SC_{CTD}), a basic advertisement screen (SC_{ADB1} or SC_{ADB2}) which is more directed than SC_{ADB0}, a basic content screen (SC_{CTB1} or SC_{CTB2}) which is more directed than SC_{CTB0}, a 2^{nd} lock screen, a 1^{st} home screen, an instruction or other screens which may be more directed, detailed or personal than SC_{FAIL}, as described above. Instead of displaying SC_{PASS1}, the terminal may keep the display unit in its OFF state, run yet another operation, and the like, as described in other embodiments.

Thereafter, the terminal receives a 2^{nd} user input (UI₂) which includes a single 2^{nd} authentication (user) sub-input (UI_{THEN2}) but which may not include any 2^{nd} activation (user) sub-input (step [111]), for the terminal is already activated. The terminal first performs a proximity check or its equivalent (step [112]) to determine whether or not the user input is an authorized or intended user input (step [113]). When the 2^{nd} user input is not an authorized or intended input, the terminal displays SC_{PASS2} (step [115]), where examples of SC_{PASS1} may be similar or identical to SC_{PASS1} or more directed, detailed or personal than SC_{PASS1}. Alternatively, instead of displaying SC_{PASS2}, the terminal may keep the display unit in its OFF state, run yet another operation, and the like, as described in other embodiments.

When the 2^{nd} user input is the authorized or intended input, the terminal receives UI_{THEN2} or extracts UI_{THEN2} from UI₂ (step [114]), “runs the 2^{nd} authenticating” (step [114]) and “execute the 2^{nd} determining” (step [116]). As the user fails the 2^{nd} authenticating, the terminal displays SC_{PASS3} (step [118]), while the terminal displays SC_{PASS4} (step [117]) when the user passes the 2^{nd} authenticating. As described above, SC_{PASS3} and SC_{PASS4} may be any of the above screens as long as SC_{PASS4} is more directed, detailed or personal than SC_{PASS3} and as long as SC_{PASS3} and SC_{PASS4} are more directed, detailed or personal than SC_{PASS1} and SC_{PASS2}. Of course SC_{PASS3} or SC_{PASS4} may be another screen which may be different in types and/or nature from SC_{PASS1} and SC_{PASS2} and, therefore, it is not practical to compare them in terms of directedness, details, personal secrecy, and the like.

The terminal of FIG. 10A may also operate according to other arrangements or sequences which correspond to variations or modifications of the aforementioned arrangements.

As explained above, the terminal may turn its display unit ON and display a certain screen thereon in any step along the sequence of FIG. 10A, other than the steps [14], [15], [115], [117], and [118].

For example, the pass screen SC_{PASS1} of step [14] may not require a user to react thereto, e.g., by providing at least one UI_{AUX} or by performing an active or passive task. In such a case, the terminal may proceed to the step [111] as described above. When SC_{PASS1} requires the user to react thereto, however, the user may have to provide UI_{AUX}, finish reacting to SC_{PASS1} for proceeding to a next step of operation, and then provide UI_{THEN2} to the terminal. Alternatively, the user may react to SC_{PASS1} by providing a single UI_{THEN2} to SC_{PASS1}, where the terminal stores UI_{THEN2} as “Result,” and SC_{PASS1} treats UI_{THEN2} as the auxiliary sub-input. When the user is done with SC_{PASS1}, the terminal may then retrieve UI_{THEN2} from “Result” and proceed to the step [111]. Therefore, the terminal may continue to provide the seamless features to the user.

In contrary to the user who provides UI_{THEN2} by his or her voluntary action, the terminal at the step [111] may proactively acquire UI_{THEN2} as well. For example, the terminal may acquire an image of an iris or retina of the user while the user is staring at the terminal or away therefrom (i.e., not necessarily a camera of the terminal) and extract UI_{THEN2} therefrom, may acquire a velocity or an acceleration of a body part of the user (or those of the terminal itself), may acquire a magnitude or a duration of force applied by the user to a certain part of the terminal, and the like.

The user at the step [111] may also provide UI_{THEN2} in various ways. For example, UI_{THEN1} and UI_{THEN2} may be of the same type (e.g., fingerprints of different fingers, fingerprints of different portions of the same finger, and the like), of different types (e.g., a fingerprint and an image of an iris, or a voice and a velocity of a finger of the user). In another example, the user may provide UI_{THEN1} and UI_{THEN2} by manipulating the same input unit with different forces, with different numbers of manipulation, with different duration, with different time gaps, and the like. In the alternative, the user may provide UI_{THEN1} and UI_{THEN2} by manipulating different input units positioned close to each other or disposed on different surfaces of the terminal, and the like.

As described above, the steps [112] and [113] determine whether the user input is the authorized or intended input or not. Therefore, the terminal may employ any exemplary embodiments of FIGS. 8A to 8D instead of such steps. Alternatively, such steps may be omitted and the terminal may proceed directly from the step [111] to the step [114]. Instead of displaying SC_{PASS1} when the 2^{nd} user input is not an authorized or intended input (step [115]), the terminal may run other operations. For example, the terminal may inactivate itself, may turn OFF its display unit, may keep displaying the previous screen such as SC_{PASS1}, may display an instruction or a warning, and the like.

When the user passes the 1^{st} authenticating but fails the 2^{nd} authenticating (step [118]), such a terminal may run other operations such as, e.g., inactivating itself, turning OFF its display unit, continuing to display the previous screen SC_{PASS1}, display a warning or an instruction, and the like. Thereafter, the terminal may keep displaying SC_{PASS3} for a certain period and then [A] inactivate itself, [B] turn OFF its display unit, [C] run a predetermined operation, and the like. Instead, the terminal may continue to display SC_{PASS3} until the user provides another user input.

The terminal may also incorporate optional steps of checking whether or not the user input is an authorized or intended input in the initial state of the sequence. For example, any steps exemplified in FIG. 7A or FIG. 7B may be incorporated into a location which is marked “A” inside a dotted circle, i.e., between the steps [10] and [11]. In addition, any steps exemplified in FIGS. 8A to 8D may be incorporated into a location which is marked “B” inside a dotted circle, i.e., between the steps [11] and [12].

When the user fails the 1^{st} authentication operation (step [15]), the terminal may run various operations. For example, such a terminal may [A] display SC_{FAIL} for a certain period and then inactivate itself or turn OFF its screen, [B] display SC_{FAIL} until the user provides an additional user input, [C] display SC_{FAIL} until SC_{FAIL} is replaced or overlaid by SC_{PASS1}, SC_{PASS3} or SC_{PASS4}, [D] display SC_{FAIL} for a certain period and then run a certain operation, [E] display SC_{FAIL} but, upon receiving another user input, run a certain operation, and the like.

As the user passes the 1^{st} authentication operation but fails the 2^{nd} authentication operation (step [115]), the terminal may run other operations. For example, the terminal may [A] display SC_{PASS2} for a certain period and then inactivate itself or turn OFF its screen, [B] display SC_{PASS2} until the user provides another user input, [C] display SC_{PASS2} until SC_{PASS2} is replaced or overlaid by SC_{PASS1}, SC_{PASS3} Or SC_{PASS4}, [D] display SC_{PASS2} for a certain period and run a certain operation, [E] display SC_{PASS2} and, upon receiving another user input, run a certain operation, and the like.

Similarly, when the user passes the 1^{st} and 2^{nd} authentication operations (step [117]), the terminal may run yet other operations. For example, such a terminal may [A] display SC_{PASS4} for a certain period and then inactivate itself or turn OFF its screen, [B] display SC_{PASS4} until the user provides another user input, [C] display SC_{PASS4} for a certain period and then run a certain operation, [D] display SC_{PASS4} but, upon (or after) receiving another user input, run a certain operation, and the like.

It is noted that those steps for checking whether the user input is an authorized or intended input (e.g., steps [112], [113], and [115]) are optional and, therefore, may be omitted from the exemplary sequence. In addition, such steps may be added to the earlier phase of the sequence, e.g., between the steps [11] and [12].

In addition, the steps for acquiring the second user input (UI₂) along with UI_{THEN2} may be performed at other steps of the sequence. For example, UI_{THEN2} may be received (i.e., acquired) [A] prior to, concurrently with or after receiving UI_{THEN1}, [B] prior to, concurrently with or after “running the 1^{st} authentication,” [C] prior to, concurrently or after “executing the 1^{st} determining,” and the like.

Although now shown in the figure, the terminal may incorporate additional authentication operations in order to run the 3^{rd}, 4^{th} or 5^{th} authentication operation, where the terminal may run such an operation concurrently with or after running the 1^{st} or 2^{nd} authentication operation as described above, where further details of such terminals have been described above.

In addition, various terminals of this exemplary embodiment may also include various software or hardware security means for guaranteeing seamless and secure operations to the user as described above. Therefore, such a terminal may include various hardware or software features (e.g., one or more of the 1^{st}, 2^{nd}, 3^{rd} and 4^{th} applications described above) as have been described in FIG. 2A.

Other configurational or operational variations (or modifications) of such terminals described in conjunction with FIG. 10A are similar to those illustrated in various exemplary aspects or embodiments of this disclosure. Therefore, each feature of the above examples of FIG. 10A of this eighth exemplary aspect of this disclosure may be applied to, may be incorporated into, may be replaced by, may replace, and/or may be combined with [A] corresponding features of FIG. 10A or [B] other embodiments and their examples which have been described heretofore and are to be disclosed hereinafter, including various aspects and embodiments of various objectives as described in the “Summary of the Invention” and those of various terminals of FIGS. 9A to 9D.

FIG. 10B is a block diagram illustrating another exemplary embodiment of this ninth aspect of this disclosure, where a terminal employs two authentication operations (steps [12] and [114]) and displays various screens such as, e.g., SC_{DEF}, SC_{PASS1} or SC_{PASS2}, depending on the results of the 1^{st} or 2^{nd} authentication operations. It is noted that FIG. 10B may be deemed as another detailed example of FIG. 9A, where “Action_{0X},” “Action₁₀,” and “Action₁₁” of FIG. 9A roughly correspond to inactivating itself or turn OFF its display unit, displaying SC_{PASS1}, and displaying SC_{PASS2}, respectively. In another perspective, however, FIG. 10B may be deemed as an altered detailed example of FIG. 9B in that a terminal “runs the 1^{st} and 2^{nd} authenticating” (steps [12] and [114]) and then “executes the 1^{st} and 2^{nd} determining” (steps [123] and [116]). It is also appreciated that the sequence of FIG. 10B may be deemed as a “series sequence” with no branching (i.e., a sequence with “no branch”) as well.

The exemplary sequence of a terminal of FIG. 10B includes at least few features which may be different from those sequences of FIGS. 9A and 10A.

The 1^{st} feature relates to the step [121] which the terminal executes concurrently with the step of receiving (i.e., acquiring) the 1^{st} user input (UI₁) (step [11]). In other words, such a terminal may turn ON its display unit upon receiving the 1^{st} user input (UI₁) and/or the 1^{st} authentication (user) sub-input (UI_{HEN1}), regardless of whether or not UI₁ or UI_{THEN2} may be the authorized or intended input, whether or not UI_{THEN2} may match a pre-stored value, and the like.

Once turned on, the display unit may display a variety of screens such as, e.g., a default screen (SC_{DEF}), a lock screen, a basic advertisement screen (SC_{ADB}), a basic content screen (SC_{CTB}), and the like, where examples of such SC_{DEF} may be similar or identical to SC_{DEF} of FIGS. 3A, 4A, 5A, 5B, 6, 7B, 8A to 8D, 10A, and the like, and where examples of such SC_{ADB} (e.g., SC_{ADB0}, SC_{ADB1} or SC_{ADB2}) and SC_{CTB} (e.g., C_{CTB0}, SC_{CTB1} or SC_{CTB200}) have been described above. Thereafter, the terminal may [A] turn OFF the display unit after a certain period with or without switching the terminal into its inactive state, [B] keep displaying such a screen until it is replaced or overlaid by another screen of the steps [115] or [117], [C] run at least one predetermined operation after a certain period of time, and the like. By turning on the display unit in the earliest possible phase of the sequence, the terminal of FIG. 10B may ensure the user that his or her input has been properly delivered to and received by the terminal.

Another feature relates to optional steps [122a] to [122c] for checking whether or not a 2^{nd} user input (UI₂) or a 2^{nd} authentication sub-input (UI_{THEN2}) is an authorized or intended input. Unlike those of FIGS. 9A and 10A, the steps [122a] to [122c] are incorporated into an earlier phase of the sequence. In addition, such steps may be incorporated into the sequence even before the terminal receives UI_{THEN2}, i.e., before the step [111]. Accordingly, such steps may correspond to, e.g., running a proximity checking, operation running another operation for checking a human input, or other equivalent operations for determining an identity or a format of the 2^{nd} user input. It is appreciated that, when the terminal incorporates the checking steps [122a] to [122c] into its sequence and receives UI_{THEN2} at the step [122a], an extra step [110] may then be omitted from the exemplary sequence of FIG. 10B.

The 3rd feature relates to optional steps [123a] to [123c] in which the terminal runs different operations based on the results from the 2^{nd} authentication operation. For example, when the terminal fails both of the 1^{st} and 2^{nd} authenticating, the terminal may proceed to the step [123b] and switch itself to its inactive state or turn OFF its display unit. When the user passes the 1^{st} authenticating but fails the 2^{nd} authenticating, the terminal may proceed to the step [123c] and display SC_{DEF} which have been defined hereinabove.

Once displaying SC_{DEF} (step [121]), the terminal may run various operations. For example, the terminal may [A] display SC_{DEF} and turn OFF its display unit when the user provides an additional user input or sub-input, [B] display SC_{DEF} until it may be replaced or overlaid by SC_{PASS1} or SC_{PASS2}, [C] display SC_{DEF} for a certain period and then run a certain operation, [D] continue to display SC_{DEF} and then run a certain operation upon receiving a user input, and the like. The same may also be applied to SC_{DEF} of the step [123c] as well.

The terminal of FIG. 10B may also operate according to other arrangements or sequences which correspond to variations or modifications of the aforementioned arrangements.

Similar to that of FIG. 10A, the terminal of FIG. 10B may receive UI₂ and UI_{THEN2} at the steps [122a] or [111] when the user provides the user input and sub-input through his or her voluntary action. In the alternative, the terminal at the steps [122a] or [111] may proactively acquire UI_{THEN2} as exemplified in FIG. 10A and other exemplary embodiments. In addition, when one of various screens of FIG. 10B may require the user to react thereto by providing UI_{ACT} (or UI_{THEN2}), the terminal may first store “Result” and allow the user to proceed to react to the screen, retrieve such “Result” once the user is done with reacting to the screen, and proceed to run the authentication operation. Details of such a sequence have been provided hereinabove.

Although now shown in the figure, the terminal may incorporate additional authentication operations in order to run the 3^{rd}, 4^{th} or 5^{th} authentication operation as described above. In addition, various terminals may also include various software or hardware security means for guaranteeing seamless and secure operations to the user as described above, particularly in conjunction with FIG. 2A.

Other configurational or operational variations (or modifications) of such terminals described in conjunction with FIG. 10B are similar to those illustrated in various exemplary aspects or embodiments of this disclosure. Therefore, each feature of the above examples of FIG. 10B of this eighth exemplary aspect of this disclosure may be applied to, may be incorporated into, may be replaced by, may replace, and/or may be combined with [A] corresponding features of FIG. 10B or [B] other embodiments and their examples which have been described heretofore and are to be disclosed hereinafter, including various aspects and embodiments of various objectives as described in the “Summary of the Invention” and those of various terminals of FIGS. 9A to 9D.

FIG. 100 is a block diagram illustrating another exemplary embodiment of this ninth aspect of this disclosure, where a terminal employs two authentication operations (steps [12] and [112]) and displays various screens such as, e.g., SC_{DEF1}, SC_{DEF2}, SC_{FAIL}, SC_{PASS1}, SC_{PASS2} or SC_{PASS}, depending on the results of the 1^{st} or 2^{nd} authentication operations. It is appreciated that FIG. 100 may be deemed as a detailed example of FIG. 9D, where “Action₀₀” of FIG. 9A may correspond to SC_{FAIL} of the step [139], “Action₀₁” may correspond to SC_{PASS2} of the step [138] or (optionally) SC_{DEF2} of the step [136], where “Action₁₀” may correspond to SC_{PASS1} of the step [135], and where “Action₁₁” may correspond to SC_{PASS} of the step [134]. It is also appreciated that the sequence of FIG. 100 may be deemed as a “parallel sequence” with a major branch from the steps [12] and [112] into the step [132], and a minor branch from the step [11] to the steps [12] and [131].

For example, a terminal receives (i.e., acquires) a 1^{st} user input (UI₁) which accompanies therewith a single 1^{st} authentication (user) sub-input (UI_{THEN1}) as well as at least one activation (user) sub-input (UI_{ACT}) from a user (step [11]), while its display unit was (or has been) in its OFF state. Upon (or after) receiving UI_{THEN1} and UI_{ACT}, the terminal activates itself, turns ON its display unit, and displays a 1^{st} default screen (SC_{DEF1}) (step [131]), where examples of such SC_{DEF1} may be similar or identical to SC_{DEF} as described above.

Thereafter, the user may provide a 2^{nd} user input (UI₂) accompanies a single 2^{nd} authentication (user) sub-input (UI_{THEN2}), where the 2^{nd} UI₂ may not necessarily include any activation (user) sub-input because such a terminal has already been activated by UI_{ACT} accompanied by UI₁. Alternatively, the terminal may proactively acquire UI_{THEN2} as exemplified in FIG. 10A and other exemplary embodiments.

Once acquiring UI_{THEN1} (step [11]) and UI_{THEN2} (step [111]), the terminal “runs the 1^{st} and 2^{nd} authenticating” (steps [12] and [112], respectively). It is appreciated that the terminal may “run the 1^{st} authenticating” prior to “running the 2^{nd} authenticating,” for the terminal receives UI_{THEN1} prior to acquiring UI_{THEN2}. However, such a terminal may run the 1^{st} authenticating and then the 2^{nd} authenticating, run the 1^{st} authenticating concurrently with each other, or sequentially run the 2^{nd} authenticating and then the 1^{st} authenticating.

The terminal then “executes the 1^{st} determining” (step [132]), and then proceeds to the step [133] when the result is a “pass” but proceeds to the step [137] when the result is a “fail,” and the terminal “executes the 2^{nd} determining” in each of the steps [133] and [137].

When the user fails both the 1^{st} and 2^{nd} authenticating, the terminal displays a fail screen, SC_{FAIL} (step [139]), where such a case generally corresponds to a case of performing “Action₀₀” and where examples of SC_{FAIL} have been described above. Alternatively, the terminal may switch to its inactive state, turn OFF the display unit, run at least one predetermined operation, and the like.

When the user passes the 1^{st} authenticating but fails the 2^{nd} authenticating, the terminal may display one of multiple pass screens such as, e.g., SC_{PASS1} (step [135]), where examples of SC_{PASS1} have already been explained above and where this case may correspond to a case of performing the aforementioned “Action₁₀” or “Actionᵢₓ.” Because SC_{PASS1} corresponds to a 1^{st}-passing user or a 2^{nd}-failing user, SC_{PASS1} may generally be more directed, detailed or personal than SC_{FAIL}. In the alternative, the terminal may switch to its inactive state, turn OFF the display unit, run at least one predetermined operation, and the like.

However, when the user fails the 1^{st} authenticating but passes the 2^{nd} authenticating, the terminal may still display another of multiple pass screens such as, e.g., SC_{PASS2} (step [138]), where examples of SC_{PASS2} have been explained above and where such a case corresponds to a case of performing the aforementioned “Action₀₁” or “Action_{X1}.” Because SC_{PASS1} corresponds to a 1^{st}-passing user or a 2^{nd}-failing user, SC_{PASS2} may be typically more directed, detailed or personal than SC_{FAIL}. However, directness, details or personal secrecy between SC_{PASS1} and SC_{PASS2} may be determined by a setting of the terminal, by a preference selected by the user, based on a relative importance between SC_{PASS1} and SC_{PASS2}, and the like. In the alternative, such a terminal may switch to its inactive state, turn OFF the display unit, run a predetermined operation, and the like.

When the user passes both of the 1^{st} and 2^{nd} authenticating, the terminal displays the most directed, detailed or personal pass screen, SC_{PASS} (step [139]), where examples of such SC_{PASS} have been described above as well. Accordingly, this case typically corresponds to the case of performing the aforementioned “Action₁₁.”

It is appreciated and as manifest in the step [136] that, when the user fails the 1^{st} authenticating, the terminal may not “execute the 2^{nd} determining” and instead display SC_{DEF2}. This example may be beneficial when the 1^{st} authenticating is much more important than the 2^{nd} authenticating and, therefore, that it may not be worth executing the 2^{nd} authenticating when the user fails the 1st authenticating. It is noted that SC_{DEF2} may be less directed, detailed or personal than the pass screens (e.g., SC_{PASS1}, SC_{PASS2}, or SC_{PASS}) but that directness, details or personal secrecy between SC_{DEF1} and SC_{DEF2} may be determined by a setting of the terminal, by a preference selected by the user, and the like.

The terminal of FIG. 100 may also operate according to other arrangements or sequences which correspond to variations or modifications of the aforementioned arrangements.

After displaying SC_{DEF1} (step [131]), the terminal may perform various functions. For example, the terminal may [A] display SC_{DEF} for a certain period and then switches to its inactive state or turn off its display unit, [B] display SC_{DEF1} until the user provides another user input and/or sub-input, [C] display SC_{DEF1} until it is replaced or overlaid by other screens (e.g., SC_{DEF2}, SC_{FAIL}, SC_{PASS1}, SC_{PASS2} or SC_{PASS}), and the like. In the alternative and contrary to the figure, the terminal at the step [131] may keep its display unit in its OFF state.

After displaying SC_{DEF2} (step [136]), the terminal may perform various functions. For example, the terminal may [A] display SC_{DEF2} for a certain period and then switches to its inactive state or turn off its display unit, [B] display SC_{DEF2} until the user provides another user input and/or sub-input, [C] display SC_{DEF2} until it is replaced or overlaid by other screens (e.g., SC_{FAIL}, SC_{PASS1}, SC_{PASS2} or SC_{PASS}), and the like. Alternatively and contrary to the figure, the terminal at the step [136] may keep its display unit in its OFF state.

After displaying each of the pass screens (i.e., SC_{PASS1}, SC_{PASS2} or SC_{PASS}), the terminal may also perform various functions. For example, the terminal may [A] display the pass screen for a certain period and then turns OFF the display unit, [B] keep displaying the pass screen until it receives another user input or sub-input, [C] display the pass screen for a certain period and then run at least one predetermined operation, and the like.

As discussed above, the sequence of FIG. 100 shows another example of a “parallel sequence” with a major branch from the steps [12] and [112] into the step [132], and a minor branch from the step [11] to the steps [12] and [131]. However, the operational sequence of the terminal may be altered so that, e.g., the terminal may [A] add an additional branch to its sequence by executing the step [11] concurrently with the step [111] or other two steps of the sequence, [B] delete an existing branch from such a sequence by un-branching the branched steps and by rendering them executed consecutively or independently, and the like.

Contrary to the figure, the terminal may first receive UI₂ and then receive UI₁ thereafter or, alternatively, may receive UI₁ and U₂ concurrently. In addition, the terminal may “execute the 2nd determining” first, followed by “executing the 1^{st} determining,” based on the relative importance, reliability or availability of such 1^{st} and 2^{nd} authentication operations or such 1^{st} and 2nd authentication (user) sub-inputs, UI_{THEN1} and UI_{THEN2}. In addition, the terminal may allow the user to determine the order of such multiple authentication operations and to also change such an order.

Similar to that of FIG. 10A, the terminal of FIG. 10C may receive UI₂ and UI_{THEN2} at the step [111] when the user provides the user input and sub-input through his or her voluntary action. Alternatively, the terminal at the step [111] may proactively acquire UI_{THEN2} as exemplified in FIG. 10A and other exemplary embodiments. In addition, when one of various screens of FIG. 10C may require the user to react thereto by providing UI_{ACT} (or UI_{THEN2}), the terminal may first store “Result” and allow the user to proceed to react to the screen, retrieve such “Result” once the user is done with reacting to the screen, and proceed to run the authentication operation. Details of such a sequence have been provided hereinabove.

Although now shown in the figure, the terminal may incorporate additional authentication operations in order to run the 3^{rd}, 4^{th} or 5^{th} authentication operation as described above. In addition, various terminals may also include various software or hardware security means for guaranteeing seamless and secure operations to the user as described above, particularly in conjunction with FIG. 2A.

Other configurational or operational variations (or modifications) of such terminals described in conjunction with FIG. 10C are similar to those illustrated in various exemplary aspects or embodiments of this disclosure. Therefore, each feature of the above examples of FIG. 10C of this eighth exemplary aspect of this disclosure may be applied to, may be incorporated into, may be replaced by, may replace, and/or may be combined with [A] corresponding features of FIG. 10C or [B] other embodiments and their examples which have been described heretofore and are to be disclosed hereinafter, including various aspects and embodiments of various objectives as described in the “Summary of the Invention” and those of various terminals of FIGS. 9A to 9D.

FIG. 10D is a block diagram illustrating another exemplary embodiment of this ninth aspect of this disclosure, where a terminal employs two authentication operations (steps [12] and [112]) and displays various screens (e.g., SC_{DEF1}, SC_{DEF2}, SC_{PASS1}, SC_{PASS2} or SC_{PASS}) according to the results from the 1^{st} or 2^{nd} authentication operations. It is appreciated that FIG. 10D may be deemed as a modification of FIG. 9D, where “Action₁₀” of FIG. 9A may correspond to SC_{PASS1} of the step [157] and where “Action₁₁” may correspond to SC_{PASS} of the step [156]. In contrary, SC_{PASS2} of the step [142] corresponds to “Action_{0X}” of FIGS. 9A and 9C, while SC_{DEF2} of the step [154] corresponds to “Action_{0X}” of FIG. 9C. It is also noted that the sequence of FIG. 10D may be deemed as another “series sequence” with no branching (i.e., a sequence with “no branch”), similar to those of FIGS. 10A and 10B.

For example, a terminal receives (i.e., acquires) a 1^{st} user input (UI₁) which accompanies therewith a single 1^{st} authentication (user) sub-input (UI_{THEN1}) (step [11]). Concurrently with, prior to or after such receiving, the terminal also receives a 2^{nd} user input (UI₂) which accompanies therewith a single 2^{nd} authentication (user) sub-input (UI_{THEN2}) (step [111]). In addition, at least one of such UI₁ and UI₂ includes at least one activation (user) sub-input (UI_{ACT}). Upon (or after) receiving UI_{ACT}, the terminal activates itself and may display a default screen (SC_{DEF1}) in response to UI_{THEN2} (step [151]), where examples of SC_{DEF1} may be similar or identical to other default screens (e.g., SC_{DEF1}, SC_{DEF2}, or SC_{DEF}) as described above.

Upon (or after) receiving UI_{THEN1} and UI_{THEN2}, the terminal “runs the 1^{st} and 2^{nd} authenticating” (steps [12] and [112]), followed by “executing the 1^{st} and 2^{nd} determining” (steps [152] and [155]). Although such 1^{st} and 2^{nd} authenticating and 1^{st} and 2^{nd} determining may look executed by the terminal concurrently with each other, the terminal may also “run the 1^{st} and 2^{nd} authenticating” consecutively, “execute the 1^{st} and 2^{nd} determining” one after another, and the like.

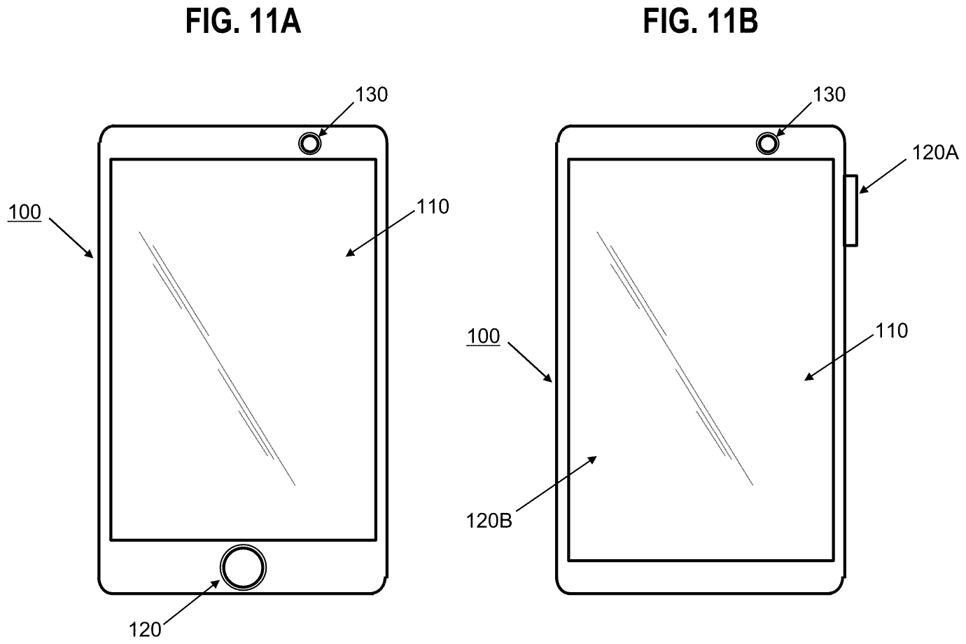

In the 10^{th} exemplary aspect of this disclosure, a mobile communication terminal includes various hardware elements, where the terminal may control such elements according to various algorithms or sequences. FIGS. 11A and 11B are schematic external appearances of an exemplary mobile communication terminal.

Referring to FIGS. 11A and 11B, an exemplary mobile communication terminal 100 includes a display unit 110, an input unit 120, and an optional camera 130. Although the display unit 110 is provided on the front side or surface of a frame of the terminal 100, the input unit 120 is provided on a lower part of the display unit 110, and the camera 130 is provided on an upper part of the display unit 110, where such display unit 110, input unit 120 or camera 130 may be provided in different positions of the terminal. For example, the display unit 110 need not necessarily be formed on the entire portion of the front surface of the terminal 100. That is, the display unit 110 may occupy at least a portion of the front or back surface of the terminal 100, while the input unit 120 may be positioned on a part different surface or side from that of the display unit 110. When the display unit 110 includes a touch film, a touch pad, a touch screen, a touch sheet or a touch surface, the input unit 120 may be provided in any desirable location of the display unit 110. The camera 130 can be incorporated into any portion of the terminal 100 as long as a desirable view angle is guaranteed thereto. In addition, the camera 130 can be provided on the other side on which the display unit 110 is not provided. When the terminal 100 includes multiple cameras, such cameras can be provided on the same side, surface or corner of the terminal 100, can be disposed on different sides, surfaces or corners of the terminal 100, and the like.

The display unit 110 displays various images or information regarding, e.g., operation states of the terminal 100, and also displays an interface (e.g., icons or their equivalent symbols) for the user when the terminal 100 drives a touch screen. In general, when the terminal 100 is in a state where the user does not provide any user input for a certain period, the terminal 100 may switch to its inactive state, where such user input may include those applied to the input unit 120 (including a touch screen type input unit), those applied to other parts of the terminal 100, those applied to such interfaces (or icons) on the display unit 110, those applied through a function key (e.g., a volume control key or other keys), and the like. It is appreciated that the above period for switching the terminal to its inactive state may be manipulated or adjusted by the user or, alternatively, the terminal may manipulate such a period based on various factors such as, e.g., a user preference, a user setting, a remaining battery power, and the like. The terminal 100 may be completely inactivated when a separate activation button is pressed longer than a preset period while the terminal 100 is in the active state. It is appreciated, however, that the terminal 100 in such an inactive state may remain in a communicable state in which a phone call can be received even when the activation button is pressed for a short time.

The input unit 120 serves to receive (i.e., acquire) various user inputs along with various (user) sub-inputs such as, e.g., authentication (user) sub-inputs, activation (user) sub-inputs, auxiliary (user) sub-inputs, and the like. Accordingly, in response to the activation sub-input, the terminal receives such activation sub-input from the input unit and then switches itself from its inactive state to its active state. In other words, when the user presses, touches or otherwise manipulates the input unit 120 when the terminal 100 is in the inactive state, the terminal 100 activates itself to the active state. FIGS. 11A and 11B illustrate a state in which the display unit 110 displays a lock screen thereon in response to the activation sub-input applied to the input unit 120 when the terminal 100 was (or has been) in its inactive state. However, the input unit 120 may also serve to run other operations (e.g., means for switching to a standby screen or a lock screen while a status of certain operations may be displayed on the display unit 110, means for displaying a list of programs currently being operated, and the like).

When the terminal 100 receives the user input accompanying a single authentication sub-input in its inactive state, the terminal 100 may optionally switch the display unit 110 from its OFF state to its ON state in response to the single authentication sub-input and may run a predetermined operation in response to the single authentication sub-input as well, while concurrently activating itself from its inactive state to its active state but not necessarily displaying the lock screen on the display unit 110. Alternatively, the terminal may activate itself in response to the single authentication sub-input but may not turn ON the display unit 110.

The mobile communication terminal 100 may run a predetermined operation by driving or executing various (software) applications. To this end, when the terminal 100 is in the inactive state, the application may be in an operation standby state. Thus, when the terminal 100 is inactivated from the active state to the inactive state, the applications may also be switched to the operation standby state. That is, a selected application to be run when the terminal 100 switches to the active state can be in the operation standby state when the terminal 100 is switched to the inactive state. Alternatively, such applications may be switched to a disabled state (instead of the standby state) when the terminal 100 is inactivated from its active state. Of course it may take more time to run such a disabled application when the terminal 100 is activated in response to the user input or sub-input. However, this delay may be generally not material to the terminal 100 as long as the terminal 100 may run an operation by driving the application within a reasonable period (or duration) after the terminal 100 is activated.

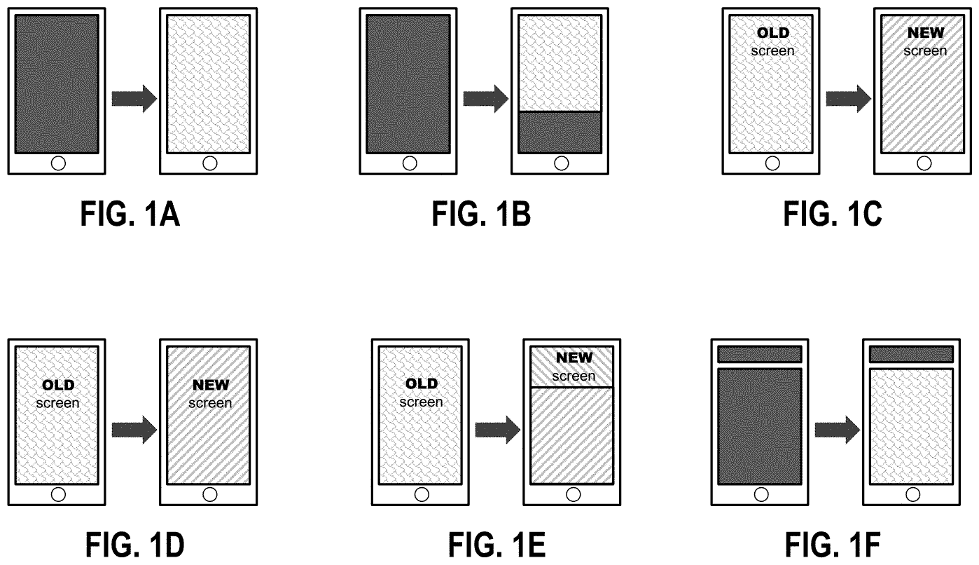

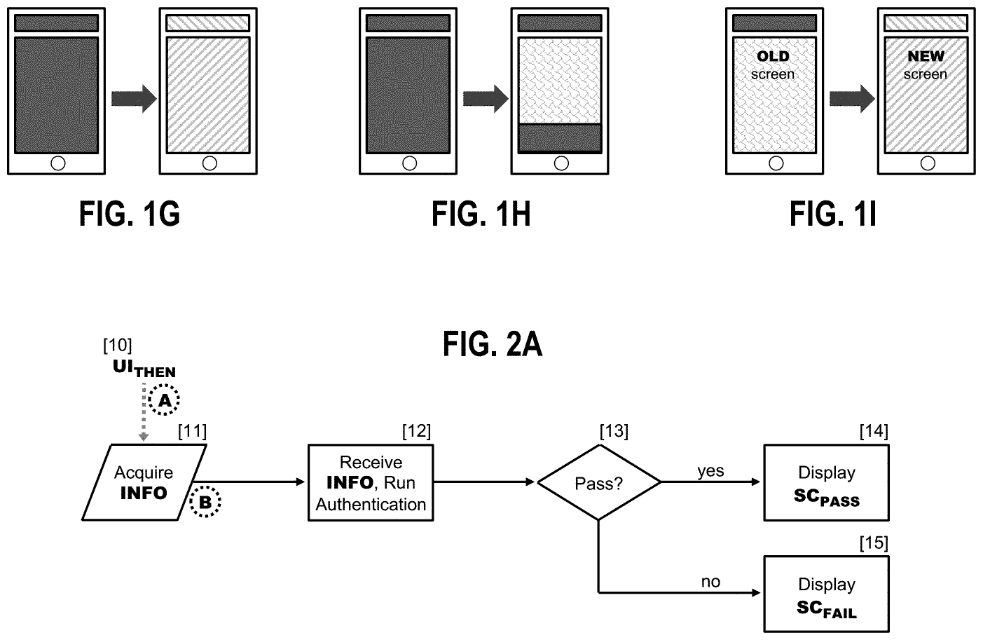

Further details of various mobile communications terminals of this disclosure, operational sequences of such terminals, and methods of using such terminals have also been described in numerous prior art documents. One example includes FIGS. 1A and 1B and accompanying description such as, e.g., [col. 10; line 11] to [col. 10; line 52], [col. 11; line 41] to [col. 15; line 20], [col. 15; line 41] to [col. 16; line 17], and [col. 17; line 12] to [col. 20; line 2] of U.S. Pat. No. 7,479,949, which is entitled “Touch screen device, method, and graphical user interface for determining commands by applying heuristics,” filed by Steve Jobs and 24 co-inventors, assigned to Apple, and also incorporated herein in its entirety by reference. Another example includes FIG. 1 and an accompanying description such as, e.g., [col. 3; line 28] to [col. 6; line 33], and [col. 8; line 1] to [col. 9; line 27] of U.S. Pat. No. 8,554,275, which is entitled “Mobile terminal having an image projector and controlling method therein,” filed by D. Y. Chung, assigned to LG Electronics, and also incorporated herein in its entirety by reference. Another example includes FIG. 1 and an accompanying description such as, e.g., [col. 3; line 21] to [col. 6; line 14] of U.S. Pat. No. 8,279,182, entitled “User input device and method using fingerprint recognition sensor,” filed by HS Kim et al., assigned to Samsung Electronics, and incorporated herein in its entirety by reference as well.

In the 11^{th} exemplary aspect of this disclosure, a mobile communication terminal may allow a user to access different data or to run a different (software) application depending on whether or not a user passes a certain authentication operation. In other words, when the user passes the authentication operation (i.e., a passing user), the terminal allows the passing user to access a certain amount of data with a certain “depth,” to run a certain number of (software) applications with a certain number (or type) of options, and the like. However, when the user fails the same authentication operation (i.e. a failing user), the terminal may then allow the failing user [A] to access only a less amount of data with the same or less “depths,” [B] to access the same amount of data only with less “depths,” [C] to run the same number of (software) applications with a fewer “options,” [D] to run a fewer applications with the same or less “options,” and the like. In other words, the terminal provides more authority to the passing user than the failing user such that the former can view and use more data, can choose and select the applications from a bigger pool, can run such applications with full options, and the like.

It is appreciated that the terminal may employ the same features when it incorporates multiple authentication operations. Therefore, the terminal may provide only a minimal or no “depths” or “options” to the failing user (“User₀₀” who is at the lowest level of authentication), while providing a wider or more “depths” or “options” to a 1^{st}-passing user (“User₁₀” who is at the medium level of authentication) who passes the 1^{st} authenticating but fails the 2^{nd} authenticating, while providing an even wider or more “depths” or “options” to a 2^{nd}-passing user (“User₀₁” who is also at the medium level of authentication) who fails the 1^{st} authenticating but passes the 2^{nd} authenticating, while providing the widest or most “depths” or “options” to the passing user (“User₁₁” who is at the highest level of authentication) who passes both of the 1^{st} and 2^{nd} authenticating. As explained hereinabove, the terminal or user may determine which one of the “User₀₁” and “User₁₀” would be given [A] more “depths” and more “options,” [B] more “depths” but less “options,” [C] less “depths” but more “options,” and the like.

It is also appreciated that the terminal may incorporate more than two authentication operations. In this case, the user ends up becoming one of a failing user (“User₀₀₀” who is at the lowest level of authentication), a 1^{st}-passing user (“User₁₀₀” who is at the low level of authentication), a 2^{nd}-passing user (“User₀₁₀” who is also at the low level of authentication), a 3^{rd}-passing user (“User₀₀₁” who is also at the low level of authentication), a 1^{st}-2^{nd}-passing user (“User₁₁₀” who is at the medium or moderate level of authentication), a 2^{nd}-3^{rd}-passing user (“User₀₁₁” who is also at the moderate level of authentication), a 3^{rd}-1^{st}-passing user (“User₁₀₁” who is also at the moderate level of authentication), and an all-passing user (“User₁₁₁” who is at the highest level of authentication), where 3^{rd}-1^{st}-passing user or “User₁₀₁” means that the user passes the 1^{st} and 3^{rd} authenticating but fails the 2^{nd} authenticating.

In this case, the terminal (or user) may have to determine in which order the users such as User₀₀₀, User₁₀₀, User₀₁₀, User₀₀₁, User₁₁₀, User₁₀₁, User₀₁₁, and User₁₁₁ may get more “depths” and/or “more” “options.” The terminal (or user) may choose such an order that a user who passes more authentication operations may get [A] more “depths” and “more” “options,” [B] more “depths” but less “options,” [C] less “depths” but more “options,” and the like. As have been described, the terminal (or user) may determine such an order in either the “upgrading rationale” or “downgrading rationale.” Alternatively, the terminal (or user) may determine the above order in a customized rationale into which the terminal (or user) may take account of many factors examples of which may include, but not limited to, various factors related to a user (e.g., a user preference, a setting selected by a user, a current or past location of the user, a habit of the user, a schedule or a plan of the user, and the like), various factors related to a provider of such advertisement or content (e.g., a provider preference, a schedule or plan for special sales of the provider, a shop location of the provider or parties interested by the provider, and the like), various factors related to a manufacturer of the terminal, and the like.

This 11^{th} exemplary aspect of this disclosure may be embodied in various arrangements, particularly in the perspective of various screens displayed on at least one display surface of at least one display unit of the terminal, where examples of such screens may include a (completely locked) lock screens, a (partially locked) semi-lock screens, a (partially unlocked) semi-unlock screens, a (completely unlocked) unlock screen, and the like. It is needless to say that each of the above screens of this paragraph may incorporate thereon at least a portion of at least one advertisement, at least one content, at least one data (even including the “routine data”), at least one image or screen, and the like.

In the 1^{st} exemplary embodiment of this 11^{th} exemplary aspect, the terminal prepares multiple screens which allow the user [A] to access different sets of data with a single, identical “depth,” [B] to access different (or the same) sets of data with different “depths,” [C] to run different (software) applications with an identical “option,” [D] to run different (or the same) applications with different “options,” and the like, where the user may select a certain set of data, choose a certain “depth” of such data, run a certain application, select a certain option to run a certain application, and the like, by manipulating at least a portion of at least one input unit of the terminal. As such a user passes more authentication operations, the terminal removes the screen with less “depths” and/or less “options” and provides the user with a new screen with more “depths,” another new screen displaying more “options,” yet another screen with more “depths” and more “options,” and the like. As a result, each of such screens is typically different from each other and, therefore, may not overlap each other. For example, when two of such screens are home screens at different levels of authentication, such screens may display an icon (or other equivalent symbols) for the same application in different corners, may display two icons (or symbols) in different arrangements, and the like.

However, the 1^{st} exemplary embodiment tends to allow the terminal to construct more filled-up screens. For example, when the terminal displays a lock screen or a home screen with the lowest level of authentication and when the screen includes only five icons (or other equivalent symbols) for five different applications, such a terminal may position four icons in each corner of the display surface and the last icon in the center thereof and may optionally adjust sizes of such icons to render the screen more aesthetic. Accordingly, such icons may fill up an entire display surface and, as a result, this exemplary embodiment makes it very difficult for a 3^{rd} party to guess whether or not the terminal would allow the user to run more applications or to utilize more “options” when the user passes the next authentication operation. However, the terminal may attain such a benefit at the cost of using its memory, storage or library for storing such multiple screens.

In the 2^{nd} exemplary embodiment of this 11^{th} exemplary aspect, the terminal may prepare a single (a few or several) screen which also allows the user to access different sets of data and/or to run different (software) applications as described in the preceding two paragraphs. Unlike the above 1^{st} embodiment, the screens of this exemplary embodiment may include thereon all available sets of data with the most or highest “depths” or may include thereon all available applications with the most “options.” In addition, the terminal allocates different levels of authentication to each set of data or each application displayed on such screens that the user may access only those sets of data allowed by the level of current authentication or that the user may run only those applications allowed by such a level. The terminal may embody this feature through various hardware or software configurations or operations.

In the 1^{st} example of the 2^{nd} exemplary embodiment, the terminal may manipulate each set of data and each (software) application such that the terminal may “block” a user from accessing the data set or from running the application. When the user passes a certain authentication operation, the terminal then clears the “block” from a certain set of data or from a certain application such that the user can access the unblocked data set or run the unblocked application. It is appreciated in this example that the user may be able to see icons (or other equivalent symbols) for all available sets of data or for all available applications but that the user may only access some icons based on his or her level of authentication.

In the 2^{nd} example of the 2^{nd} exemplary embodiment, the terminal may similarly manipulate each data set and application. Instead of “blocking” icons (or other equivalent symbols), however, the terminal may “blur” such icons that a user may not access the data set or may not run the application when such icons for a certain data set or a certain application is blurred. As the user passes a certain authentication operation, the terminal then clears the “blur” from a certain set of data or from a certain application such that the user can access the un-blurred data set or run the un-blurred application. Accordingly, this example may be deemed as a variation of the 1^{st} example of the 2^{nd} exemplary embodiment.

In the 3^{rd} example of the 2^{nd} exemplary embodiment, the terminal may similarly manipulate each data set and application. However, instead of “blocking” or “blurring” such icons (or other equivalent symbols), the terminal may “hide” such icons that a user may not see such icons for the data sets or applications and that the user may not access the data set or may not run the application when such icons for a certain data set or a certain application is not clearly displayed on the display unit. As the user passes a certain authentication operation, the terminal may then “clear the hide” from a certain set of data or from a certain application (i.e., “reveal” or “expose”) such that the user can see and access the revealed or exposed data set or can see and run the revealed or exposed application. Accordingly, this example may also be deemed as a variation of the 1^{st} or 2^{nd} example of this exemplary embodiment.

In the 4^{th} example of the 2^{nd} exemplary embodiment, the terminal may display a base screen with icons (or other equivalent symbols) for certain sets of data which the user may access in a current level of authentication or may display another base screen with icons for certain (software) applications which the user may run in a current level of authentication. As the user passes more authentication operations, the terminal may overlay a new icon (for a new data set or a new application) on an empty space of a display unit or over the existing icons. Alternatively, the terminal may make the new icons appear in the form as a pop-up screen as well.

It is appreciated that, in the perspective of the user, the terminal of this 4th example may seem to introduce or display new icons one after another on the display screen with pre-existing icons. As the screen is filled up with more icons, the screen may become too busy to view or some icons may overlap others. To obviate this problem, the terminal may adjust sizes and/or positions of the new icons as well as pre-existing icons in order to provide a better arranged view to the user.

Further details of this 2^{nd} exemplary embodiment of the 11^{th} exemplary aspect of this disclosure may be found in various prior art documents, where one example of such documents includes FIG. 2 and related description in columns 7 and 8 of U.S. Pat. Nos. 8,782,775 and 8,943,580, both of which are entitled “Embedded authentication systems in an electronic device” and assigned to “Apple, Inc.,” where entire portions of both of such patents are incorporated herein in their entirety by reference.

In the 12^{th} exemplary aspect of this disclosure, a mobile communication terminal may display various content screens or advertisement screens on its display unit. When such advertisement screens, content screens or other screens to be displayed are stored in an internal memory, storage or library of the terminal, the terminal may simply retrieve the screen therefrom, and then display such a screen on a display unit. However, when such screens are to be provided to the terminal from an external source, the terminal may need additional hardware or software element in order to receive such screens from the external server. Many conventional hardware and software elements may be employed for this purpose, and the following arrangement is the 12^{th} exemplary aspect of this disclosure which relates to exemplary hardware or software configurations and operations for receiving an advertisement or content screen from an external server and then displaying such on a display surface of the terminal.

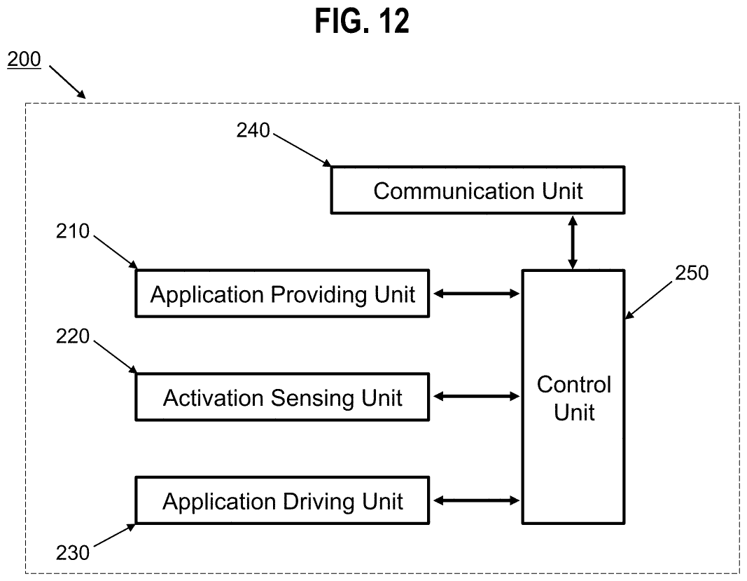

FIG. 12 is a block diagram illustrating an exemplary embodiment of the 12^{th} aspect of the disclosure, where an external source such as, e.g., a service providing server (or system) may enable a terminal to display a screen on a display unit of a terminal. For example, an exemplary service providing server 200 may include at least one application providing unit 210, at least one activation sensing unit 220, at least one application driving unit 230, at least one communication unit 240, at least one control unit 250, and the like. In one exemplary example, one or more of such units 201-250 of the server 200 may be constructed as program modules or hardware elements which may communicate with a mobile communication terminal 100. Such program modules or hardware elements may be included in the server 200 (or may instead be included in another apparatus communicable with the service providing server 200) in the form of an O/S, an application program module, and other program modules, where the program modules or hardware elements may be physically stored in various prior art storages. The program modules or hardware elements may include a routine, a subroutine, a program, an object, a component, and/or a data structure, each of which may run a certain application to be described later or may access specific data.

In operation, an application providing unit 210 may enable a (software) application to be transmitted to the terminal 100, where the application may include a control function for manipulating or controlling running of an operation when the terminal 100 may be activated to its active state and independently run the operation. The user may access the server 200 through the terminal 100, receive a desired (software) application therefrom, and install the application to his or her terminal 100. As described hereinabove, the application may correspond to a (software) application capable of enabling a certain advertisement or a content to be displayed on a display unit 110 when the terminal 100 is switched from the inactive state to the active state in response to at least one activation (user) sub-input (or a single authentication user sub-input) applied to the input unit (or activation input unit) 120, while switching the display unit 110 from its OFF state to its ON state in response thereto.

As described above, the user may provide the terminal with the activation sub-input, e.g., by manipulating at least a portion of at least one input unit of the terminal. The activation sensing unit 220 may then monitor reception of the activation sub-input, may monitor manipulation of the input unit by the user or may otherwise sense switching of the terminal 100 from the inactive state to the active state.

As the server 200 senses or monitors activation of the terminal 100, the application driving unit 230 may enable the terminal 100 to run the (software) application which has been pre-installed to the terminal 100 (by the user, terminal manufacturer, service provider, and the like). For example, the application driving unit 230 may run or otherwise control the application to display an intended screen on the display unit 110, e.g., by executing an advertisement-related application, by executing a content-related application, and the like.

The application driving unit 230 may run at least one additional operation related to driving the application which displays such a screen on the display unit. For example, when the terminal 100 or server 200 receives a current location information of the user, the advertisement-related application displays an advertisement screen which is related to such current location. In addition, the server (or application) may collect various user information (e.g., a sex, an age, a home (or work) address (or province), a personal interest or hobby, a business, or an occupation) and may customize the advertisement screen for the user. An advertiser server and/or an advertisement distribution server may transmit the information necessary for such advertising (e.g., information about advertisement to be transmitted to the terminal 100 based on a user location or other user-related information). The application driving unit 230 may run a (predetermined) application concurrently with activating the terminal 100 and may perform the additional function for optimally running the application.

The communication unit 240 may make communication of various information between the terminal 100, the service providing server 200, and other optional apparatus. That is, the communication unit 240 may transmit an application to the terminal 100, and receive an activation sub-input and information necessary for running the application by the terminal 100.

The control unit 250 may also perform a function of controlling data flow between the application providing unit 210, activation sensing unit 220, application driving unit 230, and communication unit 240. That is, such a control unit 250 may control the application providing unit 210, activation sensing unit 220, application driving unit 230, and communication unit 240, in order to perform at least one unique function.

Accordingly, the terminal and the service providing server (or system) offer the benefit of running such advertising operations and performing such advertising functions while authenticating the user, by allowing the user to provide the terminal with only a single authentication (user) sub-input.

In another exemplary embodiment of the 12^{th} aspect of the disclosure, various operations and their sequence may be provided as program instructions which may be executed by various computer components (or CPU) and which may be recorded in a computer-readable medium. It is appreciated that such computer-readable medium may record, e.g. program instructions, data files or data structures, either in combination or individually. The terminal may employ the program instructions [A] which may be specifically designed for running the above applications or for performing the above functions and then recorded on a medium or [B] which may be well known to one of ordinary skill in the art of software. It is also appreciated that examples of such computer-readable and recordable medium include, but not limited to, a magnetic medium (e.g., a hard disk, a floppy disk, a magnetic tape, and the like), an optical medium (e.g., a compact disc-read only memory (CD-ROM) or a digital versatile disc (DVD)), a magneto-optical medium (e.g., an optical disk), a hardware device (e.g., a ROM, a random access memory (RAM) or a flash memory) which may be specially designed to store and execute such program instructions. Examples of the program instructions may also include not only machine code generated by a compiler or the like, but also high-level language codes which may be executed by a computer using an interpreter, and the like. The hardware device described above may also be constructed to operate as one or more software modules for running the operations of various examples of the above embodiments and aspects of this disclosure, or vice versa.

Although various mobile communication terminals for providing seamless and secure operations throughout this disclosure have been described with reference to the above exemplary embodiments and aspects and to the details thereof, the above description of such terminals of this disclosure is provided only for illustration and better understanding of such terminals and their operations. Accordingly, various modifications as well as variations of such terminals and operations will be apparent to one of ordinary skill in the art according to the above description.

Unless otherwise specified, various features of one exemplary embodiment of a certain exemplary aspect of various terminals, their operational sequences, and methods of using such terminals of this disclosure may apply interchangeably to other embodiments of the same different aspect of such terminals, sequences or methods of this disclosure. Accordingly, determining logic and sequence of displaying three different screens such as SC_{DEF}, SC_{FAIL} or SC_{PASS} as explained in FIG. 3A may replace corresponding logic and sequence of displaying five different screens such as SC_{FAIL}, SC_{PASS1}, SC_{PASS2}, SC_{PASS3}, and SC_{PASS4} as illustrated in FIG. 10A, whereby the terminal of FIG. 10A may display SC_{DEF} of FIG. 3A as SC_{FAIL}, display SC_{FAIL} of FIG. 3A as SC_{PASS2} and SC_{PASS3}, and display SC_{PASS} of FIG. 3A as SC_{PASS4} and SC_{PASS1}. In addition, the step of storing at least one authentication information (step [57]) of FIG. 6 may be implemented between the steps [12] and [122a] of FIG. 10B such that the terminal of FIG. 10B may allow the user to react to an advertisement screen or content screen at the steps [111] and [114]. Thereafter, the terminal may retrieve the stored “Result” and then utilize such “Result” in order to “run the 1^{st} authenticating” (step [123]). Accordingly, without any express comment otherwise, various features of a certain exemplary embodiment or aspect of this disclosure is to be applied interchangeably to another exemplary embodiment or aspect of this disclosure.

Unless otherwise specified, various features of one exemplary embodiment (or example) of one exemplary aspect of this disclosure may apply interchangeably to other exemplary embodiments (or examples) of other exemplary aspects of this disclosure. For example, any of the mobile communication terminals, systems incorporating such terminals, operating sequences of such terminals, and methods of using such terminals in the context of authenticating and advertising while providing both seamless and secure operations may also be implemented or incorporated into other mobile communication devices, other systems incorporating such devices, other device sequences including such terminal operating sequences, and other methods of using such terminals.

Various mobile communication terminals, systems incorporating such terminals, operating sequences thereof, and methods of utilizing such terminals of this disclosure may also incorporate other electronic elements or digital parts which may run various operations for performing various functions similar to those described in this disclosure. As discussed above, however, such terminals may include any program, software, source code, binary code or other instructions as long as the terminals may run one or more operations when the terminals receive various user inputs or sub-inputs when such terminals are or have been in their inactive states and, optionally, when such terminals switch their display units from their OFF states to their ON state in response to a single authentication (user) sub-input or, alternatively, in response to multiple authentication sub-inputs when the terminal employs as many number of authentication operations.

It is to be understood that, while various embodiments of this invention have been described in conjunction with the detailed description thereof, the foregoing description is intended to illustrate and not to limit the scope of various terminals, systems incorporating such terminals, operating sequences of such terminals, and method of using such terminals, all of which are defined by the scope of the appended claims. Other embodiments, aspects, advantages, and modifications are within the scope of the following claims as well.

What is claimed is:

1. A mobile communication terminal comprising:
a display unit which is turned off in an off state and turned on in an on state; and
an input unit which receives a user input from a user;
wherein, when said input unit receives a first user input in said off state, said terminal turns on said display unit and displays a default screen on said display unit,
wherein said terminal also runs a first authentication operation in response to said first user input, without requiring any additional user input,
wherein, when said user fails said first authentication operation, said terminal switches to a lock state and displays on said display unit an advertisement screen which includes at least one advertisement thereon, and
wherein, when said user passes said first authentication operation, said terminal switches to an unlock state and displays a home screen on said display unit.

2. The terminal of claim 1,
wherein said terminal turns on said display unit and runs said first authentication operation simultaneously.

3. The terminal of claim 1,
wherein said default screen is one of a first screen which is identical to said advertisement screen and a second screen which is different from said advertisement screen.

4. The terminal of claim 1,
wherein said advertisement screen includes a tab, and
wherein, when said user provides a second user input to said tab, said terminal runs one of said first authentication operation and a second authentication operation which is different from said first authentication operation.

5. The terminal of claim 1,
wherein said advertisement screen includes a tab, and
wherein, when said user does not provide any user input to said tab within a certain period, said terminal performs at least one passive task.

6. The terminal of claim 1,
wherein said advertisement screen includes a tab, and
wherein, when said user provides a second user input to said tab within a certain period, said terminal performs at least one active task.

7. The terminal of claim 6,
wherein said terminal prevents said user from at least one of accessing an external link provided on said advertisement screen, downloading a file from said external link, and running an application available from said external link.

8. The terminal of claim 1,
wherein said terminal runs said first authentication operation using said first user input which includes information of at least one of a fingerprint, an iris, a retina, an ear, a face, a hand, a wrist, a sound, and a voice of said user.

9. A mobile communication terminal comprising:
a display unit which is turned off in an off state and turned on in an on state; and
an input unit to which receives a user input from a user;
wherein, when said input unit receives a first user input in said off state, said terminal runs a first authentication operation in response thereto,
wherein, when said user fails said first authentication operation, said terminal switches to a lock state and displays on said display unit an advertisement screen which includes at least one advertisement thereon, and
wherein, when said user passes said first authentication operation, said terminal switches to an unlock state and displays a home screen on said display unit.

10. The terminal of claim 9,
wherein said terminal turns on said display unit and displays a default screen on said display unit in response to said first user input, without requiring any additional user input, and
wherein said default screen is one of a first screen which is identical to said advertisement screen and a second screen which is different from said advertisement screen.

11. The terminal of claim 10,
wherein said terminal turns on said display unit and runs said first authentication operation simultaneously.

12. The terminal of claim 9,
wherein said terminal keeps said display unit turned off during running said first authentication operation.

13. The terminal of claim 9,
wherein said advertisement screen includes a tab, and
wherein, when said user provides a second user input to said tab, said terminal runs one of said first authentication operation and a second authentication operation which is different from said first authentication operation.

14. The terminal of claim 9,
wherein said advertisement screen includes a tab, and
wherein, when said user does not provide any user input to said tab within a certain period, said terminal performs at least one passive task.

15. The terminal of claim 9,
wherein said advertisement screen includes a tab, and
wherein, when said user provides a second user input to said tab within a certain period, said terminal performs at least one active task.

16. The terminal of claim 15,
wherein said terminal prevents said user from at least one of accessing an external link provided on said advertisement screen, downloading a file from said external link, and running an application available from said external link.

17. The terminal of claim 9,
wherein said terminal runs said first authentication operation using said first user input which includes information of at least one of a fingerprint, an iris, a retina, an ear, a face, a hand, a wrist, a sound, and a voice of said user.

18. A method of providing an advertisement to a user of a mobile communication terminal, wherein said terminal includes a display unit which is turned off in an off state but which is turned on in an on state, said method comprising the steps of:
receiving a first user input in said off state;
turning on said display unit and displaying a default screen on said display unit in response to said first user input, without requiring any additional user input;
running a first authentication operation in response to said first user input, without requiring said additional user input;
switching to a lock state and displaying an advertisement screen on said display unit when said user fails said first authentication operation; and
switching to an unlock state and displaying a home screen on said display unit when said user passes said first authentication operation.

19. The method of claim 18,
wherein said terminal performs said turning on and said running simultaneously.

20. The method of claim 18,
wherein said terminal performs said turning on after completing said running.
